(19) United States
(12) Patent Application Publication
(10) Pub. No.: US 2005/0213436 A1
(43) Pub. Date: Sep. 29, 2005

(54) Read/write device, storage medium, driving method of read/write device, semiconductor laser life estimation method, program, program storage medium, and semiconductor laser

(75) Inventors: Tomoki Ono, Pittsburgh, PA (US); Naoyasu Iketani, Nara-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/094,004

(22) Filed: Mar. 29, 2005

(30) Foreign Application Priority Data
Mar. 29, 2004 (JP) 2004-096614
Mar. 15, 2005 (JP) 2005-73988

(51) Int. Cl. G11B 11/00

(52) U.S. Cl. 369/13.02

(57) ABSTRACT

In a read/write device for writing and reading a storage medium by way of a heat assisted magnetic recording/reproduction scheme, the read/write device including an elevated slider provided with a semiconductor laser, provided is a heat dissipation mechanism for dissipating heat generated in the elevated slider to an outside of a housing of the read/write device. Further, the storage medium has a second heatsink layer formed of an Al film having a thickness of 50 μm, a backing layer, a heat barrier layer, a first heatsink layer, a magnetic recording layer, and a protection film on a glass substrate. With this arrangement, in a read/write device which performs a heat assisted magnetic recording and reproduction by a semiconductor laser provided on the elevated slider, the occurrence of malfunction due to temperature rises in the storage medium is prevented.

This Nonprovisional application claims priority under 35 U.S.C. § 119(a) on Patent Application No. 2004/096614 d in Japan on Mar. 29, 2004, and Patent Application No. 2005/73988 filed in Japan on Mar. 15, 2005, the entire contents of which are hereby incorporated by reference.

### FIELD OF THE INVENTION

The present invention relates to (i) a read/write device that writes and reads information by way of a heat assisted magnetic recording/reproduction scheme, using a semiconductor laser, (ii) a storage medium, (iii) a driving method of the read/write device, (iv) a semiconductor laser life estimation method, (v) a program for controlling the read/write device, and (vi) a program storage medium storing the program.

### BACKGROUND OF THE INVENTION

High-density recording has recently been realized through the development of optical technology and through the collaboration between optical technology and other technologies such as magnetic recording/reproduction technology. An example of the former is phase-conversion optical disks, while examples of the latter are magneto-optical recording and heat assisted magnetic recording/reproduction. For instance, Japanese Laid-Open Patent Application No. 4-176034/1992 (Tokukaihei 4-176034; published on Jun. 23, 1992) discloses (i) a magnetic storage medium made of a ferrimagnetic material whose compensation temperature is substantially equal to room temperatures, and (ii) a heat assisted magnetic recording/reproduction scheme using the magnetic storage medium and a laserbeam.

According to the heat assisted magnetic recording/reproduction scheme, information is written to a recording region of the magnetic storage medium by applying an external magnetic field by means of a recording magnetic head, after the magnetic storage medium is heated by a laserbeam so that the coercive force in the recording region is lowered. Meanwhile, information is read in such a manner that the magnetic storage medium is heated by a laserbeam so that residual magnetization in the recording region is increased, and magnetic flux from the residual magnetization is detected by a reproducing magnetic head.

In this heat assisted magnetic recording/reproduction scheme, the residual magnetization is close to zero in a region which is at substantially room temperatures because not heated by the laserbeam. On this account, even if the gap width of the reproducing magnetic head, the gap width being perpendicular to the tracks, is wider than the pitch of tracks to which information is written, crosstalk with neighboring tracks is sufficiently restrained. As a result, reading of information written by high-density recording is realized.

Meanwhile, in the field of magnetic recording, an MR (Magnet-Resistive) head that utilizes a magnetoresistive effect and has a high magnetic field sensitivity has typically been used as a read head, in consideration of the increase in density of recording. Furthermore, a GMR (Giant Magnet-Resistive) head having a higher magnetic field sensitivity has recently been in commercial use.

Such a GMR head generates a large quantity of heat. For instance, T. Imamura, M. Yamagishi, and S. Nishida, “In situ Measurements of Temperature Distribution of Air-Bearing Surface Using Thermography”, IEEE TRANSACTIONS ON MAGNETICS, VOL. 38, NO. 5, p. 2147-2149, SEPTEMBER 2002 reports on heat dissipation from an elevated slider including the GMR head. According to this document, heat dissipation from the elevated slider was observed when the elevated slider operated above a rotating sapphire disk.

Incidentally, in information recording/reproduction schemes primarily or secondarily using a laserbeam, the recording density can be increased by reducing the spot diameter of the laserbeam. Taking into account of this, the use of SIL (Solid Immersion Lens) or near-field light has been considered as a way of obtaining spatial resolution beyond the diffraction limit.

In regard to the heat assisted magnetic recording/reproduction scheme using a laserbeam, Japanese Laid-Open Patent Application No. 2001-319365 (Tokukai 2001-319365; published on Nov. 16, 2001) teaches that a semiconductor laser is provided directly on an elevated slider. This arrangement is considered to be superior to a conventional arrangement in which a laserbeam is routed by means of optical members, in terms of a fewer number of optical members and lower power consumption.

Incidentally, the heat assisted magnetic recording/reproduction scheme using a laserbeam is strongly vulnerable to influences of temperatures in and outside the recording region. That is to say, in the heat assisted magnetic recording/reproduction scheme, malfunctions such as increase of noise may occur during writing and reading operations, unless the temperature increase in the storage medium is restrained.

In this connection, the above-described Japanese Laid-Open Patent Application No. 2001-319365 merely discloses a structure in which the semiconductor laser is provided on the elevated slider, so as not to mention the heating from the semiconductor laser at all.

On this account, according to the technology disclosed by this document, in addition to precipitation of the deterioration of the semiconductor laser by heat from the semiconductor laser, a temperature of the elevated slider with the semiconductor laser increases, and this may increase a temperature of the storage medium. That is to say, in the heat assisted magnetic recording/reproduction scheme, since a quantity of heat from the semiconductor laser is large, influences of the heat radiation from the semiconductor laser must be taken into consideration. On this account, the heat on account of the heat radiation from the semiconductor laser must be appropriately dissipated.

One of the solutions for this problem is to provide a heatsink and the like on the elevated slider. However, in the heat assisted magnetic recording/reproduction scheme in which the semiconductor laser is provided on the elevated slider, such as the scheme disclosed in Japanese Laid-Open Patent Application No. 2001-319365, it is preferable that the elevation height of the elevated slider be 100 nm or less. This requires downsizing of the slider, so that it is difficult to provide the heatsink and the like on the elevated slider.

Meanwhile, although reporting on the heat dissipation from the elevated slider, the document by T. Imamura et al. only deals with heat dissipation from a magnetic head. In other words, this document does not take into account of the heat assisted magnetic recording/reproduction scheme, and hence does not mention the arrangement in which the semiconductor laser that generates a greater quantity of heat than the magnetic head is provided on the elevated slider.

Incidentally, the temperature rises in the elevated slider and the storage medium are influenced by a temperature change in the elevated slider on account of seeking, a change of ambient temperature, increase in a quantity of heat due to the deterioration of the semiconductor laser, and so on. For this reason, to realize stable heat assisted recording/reproduction, it is necessary to drive the storage medium in consideration of the aforementioned influences.

### SUMMARY OF THE INVENTION

The present invention has been attained in view of the above problem, and an object of the present invention is to provide (i) a read/write device performing heat assisted magnetic recording and reproduction through a semiconductor laser provided on the elevated slider, wherein stable heat assisted magnetic recording and reproduction is realized in the short term and long term, (ii) a storage medium, (iii) a driving method of the read/write device, (iv) a semiconductor laser life estimation method, (v) a program for controlling the read/write device, (vi) a series of data signals including the program, and (vii) a program storage medium storing the program.

A read/write device of the present invention, in order to solve the above problem, is a read/write device for writing and reading a storage medium by way of a heat assisted magnetic recording/reproduction scheme, the read/write device including an elevated slider provided with a semiconductor laser, the read/write device including: a heat dissipation mechanism for dissipating heat generated in the elevated slider to an outside of a housing of the read/write device.

According to the above arrangement, heat generated from the semiconductor laser provided to the elevated slider can be effectively dissipated to the outside of the housing of the read/write device. This arrangement limits temperature rises in the elevated slider and the storage medium. Thus, the occurrence of malfunction due to these temperature rises is prevented.

A read/write device of the present invention, in order to solve the above problem, is a read/write device for writing and reading a storage medium by way of a heat assisted magnetic recording/reproduction scheme, the read/write device including an elevated slider provided with a semiconductor laser, the read/write device comprising: an elevation mechanism which elevates the elevated slider above an elevated position the elevated slider takes during writing or reading operation, wherein: only when the elevated slider is in the elevated position the elevated slider takes during writing or reading operation, current is injected to the semiconductor laser.

According to the above arrangement, heat from the semiconductor laser can be reduced. This limits temperature rises in the elevated slider and the storage medium. Thus, the occurrence of malfunction due to these temperature rises is prevented.

A read/write device of the present invention, in order to solve the above problem, is a read/write device for writing and reading a storage medium by way of a heat assisted magnetic recording/reproduction scheme, the read/write device including an elevated slider provided with a semiconductor laser, the read/write device comprising: a control section for controlling an operational power for the semiconductor laser in accordance with a writing/reading position on the storage medium.

According to the above arrangement, the operational power for the semiconductor laser is controlled in accordance with a writing/reading position on the storage medium, which allows for reduction of the operational power for the semiconductor laser. This lowers temperature rises in the elevated slider and the storage medium. Thus, the elevated slider and the storage medium are prevented from malfunctioning due to temperature rises.

Further, according to the above arrangement, the operational power for the semiconductor laser is controlled in accordance with a writing/reading position on the storage medium, which allows for decrease of heat distribution in the storage medium. This enables writing and reading without falling of the S/N ratio.

A read/write device of the present invention, in order to the solve the above problem, is a read/write device for writing and reading a storage medium by way of a heat assisted magnetic recording/reproduction scheme, the read/write device including an elevated slider provided with a semiconductor laser, the read/write device comprising: a control section which obtains a temperature of the elevated slider; creates time-series data on temperature of the elevated slider from obtained temperature data; extracts, from the created time-series data on temperature of the elevated slider, temperature variation that occurs with a seek during operation of the elevated slider and temperature variation that occurs with change in ambient temperature so as to create time-series data on increased amount of heat due to deterioration of the semiconductor laser; and estimates life of the semiconductor laser in accordance with the time-series data on increased amount of heat.

According to the above arrangement, life of the semiconductor laser can be obtained properly, so that a stable drive is possible.

A read/write device of the present invention, in order to solve the problem, is a read/write device for writing and reading a storage medium by way of a heat assisted magnetic recording/reproduction scheme, the read/write device including an elevated slider provided with a semiconductor laser, the read/write device comprising: an elevation mechanism which elevates the elevated slider above an elevated position the elevated slider takes during writing or reading operation; and a control section which, in order to move the elevated slider to the elevated position, controls to pass a small amount of current in advance through an electronic device provided in the elevated slider so that the electronic device is preheated.

According to the above arrangement, in order to move the elevated slider to the elevated position, a small amount of current is passed in advance through an electronic device provided in the elevated slider so that the electronic device is preheated. This reduces access time to the electronic device and allows for a stable drive.

A storage medium of the present invention, in order to solve the above problem, is a storage medium which is written or read by way of a heat assisted magnetic recording/reproduction scheme, the storage medium comprising: a plurality of layers including a substrate, wherein: a sum of a thermal conductivity times thickness of each layer is 5×10⁻³ W/° C. or more.

According to the above arrangement, for example, the storage medium is in thermal connection with the read/write device for writing or reading, so that it is possible to encourage heat dissipation to the read/write device. This decreases temperature rise in the storage medium during writing or reading operation, and prevents the occurrence of malfunctions due to this temperature rise. Further, heat distribution in the storage medium can be decreased. This enables writing and reading without falling of the S/N ratio.

A driving method of a read/write device of the present invention, in order to solve the above problem, is a driving method of a read/write device for writing and reading a storage medium by way of a heat assisted magnetic recording/reproduction scheme, the read/write device including an elevated slider provided with a semiconductor laser, the method comprising the step of: obtaining a temperature of the elevated slider in a writing/reading position, wherein: an operational power for the semiconductor laser is controlled so that a temperature in a region, on the storage medium, which is irradiated with a laser beam of the semiconductor laser is held constant regardless of a position on the storage medium.

According to the above driving method, the operational power for the semiconductor laser can be reduced, which limits temperature rises in the elevated slider and the storage medium and hence prevents the occurrence of malfunction due to these temperature rises.

Moreover, a temperature in a region which is irradiated with a laser beam of the semiconductor laser is held constant regardless of a position on the storage medium, which allows for decrease of heat distribution in the storage medium. This enables writing and reading without falling of the S/N ratio.

A driving method of a read/write device according to the present invention, in order to solve the above problem, is a driving method of a read/write device for writing and reading a storage medium by way of a heat assisted magnetic recording/reproduction scheme, the read/write device including (i) an elevated slider provided with a semiconductor laser and (ii) an elevation mechanism which elevates the elevated slider above an elevated position the elevated slider takes during writing or reading of the storage medium, wherein: in order to move the elevated slider to the elevated position for writing or reading, a small amount of current is passed in advance through an electronic device provided in the elevated slider so that the electronic device is preheated.

According to the above driving method, in order to move the elevated slider to the elevated position, a small amount of current is passed in advance through an electronic device, such as a semiconductor laser, provided in the elevated slider so that the electronic device is preheated. This reduces access time to the electronic device and allows for a stable drive.

A life estimation method of a semiconductor laser according to the present invention, in order to solve the above problem, is a life estimation method of a semiconductor laser in a read/write device for writing and reading a storage medium by way of a heat assisted magnetic recording/reproduction scheme, the read/write device including an elevated slider provided with a semiconductor laser, the method comprising the steps of: obtaining a temperature of the elevated slider; generating time-series data on temperature of the elevated slider from the obtained temperature data; extracting, from the created time-series data on temperature of the elevated slider, temperature variation that occurs with a seek during operation of the elevated slider and temperature variation that occurs with change in ambient temperature so as to create time-series data on increased amount of heat due to deterioration of the semiconductor laser; and estimating life of the semiconductor laser in accordance with the time-series data on increased amount of heat. According to this method, life of the semiconductor laser can be obtained properly, and a stable drive based on a obtained result is possible.

Further, a program of the present invention is one for causing a computer provided in a read/write device to function as a control section of the read/write device. By causing such a computer to read the program, it is possible to realize processing of the control section in the read/write device of the present invention with the computer.

Moreover, storage of the program in a computer-readable storage medium facilitates storage and distribution of programs. By causing a computer provided in the read/write device to read the program stored in the above storage medium, it is possible to realize processing of the control section in the read/write device of the present invention with the computer.

A series of data signals according to the present invention is a series of data signals of the above program. For example, by receiving the series of data signals transmitted with embodied in a carrier wave, and causing a computer provided in a read/write device to execute the program, it is possible to cause this computer to execute processing of the control section in the read/write device of the present invention.

A semiconductor laser of the present invention is a combined structure of (i) a Fabry-Perot resonator structure which generates stimulated emission of radiation and (ii) a ring waveguide which generates a whispering gallery mode. Further, a semiconductor laser of the present invention is a combined structure of (i) a Fabry-Perot resonator structure which generates stimulated emission of radiation and (ii) a cylindrical waveguide which generates a whispering gallery mode.

According to the above arrangement, a stimulated emission of radiation generated by the Fabry-Perot resonator structure is partially guided to a ring waveguide or a cylindrical waveguide and then coupled with a whispering gallery mode in the ring waveguide or the cylindrical waveguide. Therefore, part of the ring waveguide or the cylindrical waveguide can be come close to the storage medium. This causes an optical tunneling effect from the ring waveguide or the cylindrical waveguide to the storage medium, which allows for a stable heat assisted magnetic recording and reproduction.

For a fuller understanding of the nature and advantages of the invention, reference should be made to the ensuing detailed description taken in conjunction with the accompanying drawings.

### BRIEF DESCRIPTION OF THE DRAWINGS

FIG. 1(a) is a cross-sectional view showing a structure of a read/write device of an embodiment of the present invention. FIG. 1(b) is a perspective view showing the structure of the read/write device of the embodiment of the present invention.

FIG. 2 is a bottom view of an elevated slider of the read/write device of the embodiment of the present invention.

FIG. 3 schematically illustrates the elevated slider of the read/write device of the embodiment of the present invention.

FIG. 4 is a plan view of a semiconductor laser of the read/write device of the embodiment of the present invention.

FIG. 5 schematically illustrates an example of an arrangement of a light receiving element in the read/write device of the embodiment of the present invention.

FIG. 6(a) is a plan view showing an arrangement of a ridge structure in the elevated slider of the read/write device of the embodiment of the present invention. FIG. 6(b) is a plan view showing another arrangement of the ridge structure in the elevated slider of the read/write device of the embodiment of the present invention.

FIG. 7 is a graphical representation showing I-L (current-optical output) characteristics in a case where the semiconductor laser of the read/write device of the embodiment of the present invention is driven with a pulse current.

FIG. 8 is a cross-sectional view of a structure of a storage medium of the read/write device of the embodiment of the present invention.

FIG. 9(a) is a graphical representation showing results of the thermal simulation of a storage medium 7, an Al substrate, and a glass substrate, of the read/write device of the embodiment of the present invention. FIG. 9(b) is a plan view showing measurement points in the simulation of FIG. 9(a). FIG. 9(c) is a graphical representation showing the relationship between the temperature of the semiconductor laser and the thermal conductivity of the storage medium.

FIG. 10 is a graphical representation showing temperature characteristics of the storage medium of the read/write device of the embodiment of the present invention.

FIG. 11 is a cross-sectional view illustrating a case (example of heat dissipation mechanism) where a heat dissipation mechanism is provided on a pivot in the read/write device of the embodiment of the present invention.

FIG. 12 is a cross-sectional view illustrating another case (example of heat dissipation mechanism) where the heat dissipation mechanism is provided on the pivot in the read/write device of the embodiment of the present invention.

FIG. 13 is a cross-sectional view illustrating a case (example of heat dissipation mechanism) where a heat dissipation mechanism is provided above and below the pivot in the read/write device of the embodiment of the present invention.

FIG. 14 is a cross-sectional view illustrating a case (example of heat dissipation mechanism) where a motor for driving the pivot is provided inside the pivot in the read/write device of the embodiment of the present invention.

FIG. 15 is a cross-sectional view illustrating a case (example of heat dissipation mechanism) where a motor for driving the pivot is provided outside the pivot in the read/write device of the embodiment of the present invention.

FIG. 16(a) is a cross-sectional view illustrating a case (example of heat dissipation mechanism) where, in the read/write device of the embodiment of the present invention, the pivot doubles as a casing of a motor that drives the pivot. FIG. 16(b) illustrating a case (example of heat dissipation mechanism) where, in the read/write device of the embodiment of the present invention, the pivot doubles as a motor axis of a motor that drives the pivot.

FIG. 17 is a cross-sectional view illustrating a case (example of heat dissipation mechanism) where, in the read/write device of the embodiment of the present invention, at least one of ends of the pivot protrudes outside a housing to come into contact with the external air.

FIG. 18 is a cross-sectional view illustrating a case (example of heat dissipation mechanism) where, in the read/write device of the embodiment of the present invention, an end of the pivot is supported by a fluid axis support.

FIG. 19 is a plan view of an elevated slider and a semiconductor laser in a read/write device of another embodiment of the present invention.

FIG. 20 is a schematic cross-sectional view illustrating an example of a heatsink (heat dissipation mechanism) part of the read/write device of a further embodiment of the present invention.

FIG. 21 is a schematic cross-sectional view illustrating another example of the heatsink (heat dissipation mechanism) part of the read/write device of said further embodiment of the present invention.

FIG. 22 is a graphical representation of results of a simulation regarding temperature rise in the read/write device of said further embodiment of the present invention, in a case where the heatsink (heat dissipation mechanism) is provided and in a case where the heatsink (heat dissipation mechanism) is not provided.

FIG. 23 is a plan view of a read/write device of yet another embodiment of the present invention, i.e. is a plan view showing a case where a convention mechanism (heat dissipation mechanism) is provided in a housing and the housing includes a cooling mechanism (heat dissipation mechanism).

FIG. 24 is a schematic block diagram of the read/write device of the embodiment of the present invention.

FIG. 25 is a graphical representation of an example of a drive current waveform of the semiconductor laser of the read/write devise of the embodiment of the present invention.

FIG. 26 is a graphical representation of another example of the drive current waveform of the semiconductor laser of the read/write devise of the embodiment of the present invention.

FIG. 27 is a graphical representation of a further example of the drive current waveform of the semiconductor laser of the read/write devise of the embodiment of the present invention.

FIG. 28 is a flowchart showing the operation of the read/write device of the embodiment of the present invention.

FIG. 29 is a schematic perspective view of the read/write device of the embodiment of the present invention.

FIG. 30 illustrates how information is read out from the storage medium in the read/write device of the embodiment of the present invention.

FIG. 31(a) is a cross-sectional view of a read/write device of still another embodiment of the present invention, i.e. is a cross-sectional view showing a case where an auxiliary heat source is provided. FIG. 31(b) is a plan view of the read/write device of FIG. 31(a).

FIG. 32(a) is a cross-sectional view of the read/write device of said still another embodiment of the present invention, i.e. is a cross-sectional view showing another case where the auxiliary heat source is provided. FIG. 32(b) is a plan view of the read/write device of FIG. 32(a).

FIG. 33 is a cross-sectional view of an example of the semiconductor laser of the read/write device of the present invention.

FIG. 34 is a cross-sectional view of another example of the semiconductor laser of the read/write device of the present invention.

FIG. 35 is a cross-sectional view of a further example of the semiconductor laser of the read/write device of the present invention.

FIG. 36 is a cross-sectional view of yet another example of the semiconductor laser of the read/write device of the present invention.

FIG. 37 is a schematic cross-sectional view showing a case where, in the semiconductor laser of FIG. 34, a micro disk has a cut-out portion.

FIG. 38 is a schematic cross-sectional view showing a case where, in the semiconductor laser of FIG. 34, metal particles are provided in a part of the micro disk.

FIG. 39 is a cross-sectional view of a major part of an elevating mechanism provided in the read/write device of the present invention.

FIG. 40 is a schematic block diagram of an example of the read/write device of the present invention.

FIG. 41 is a flowchart of an example of the operation of the read/write device of the present invention.

FIGS. 42(a) through 42(c) are flowcharts showing another example of the operation of the read/write device of the present invention.

### DESCRIPTION OF THE EMBODIMENTS

[Embodiment 1]

[Embodiment 1]

The following will describe an embodiment of the present invention in reference to figures. The information read/write device in accordance with the present embodiment (“the present read/write device”) is an information read/write device embodying a heat assisted magnetic recording/reproduction scheme using a semiconductor laser.

Here, the heat assisted magnetic recording/reproduction scheme facilitates reading/writing by changing magnetic properties of a magnetic storage medium, for example, increasing residual magnetization or reducing a coercive force, through control of the temperature of the magnetic storage medium.

In the present read/write device, a semiconductor laser is mounted to an elevated slider. The semiconductor laser and a magnetic head are major heat sources. The present read/write device effectively dissipates this heat to the outside of the housing of the present read/write device to prevent rises in the temperature of the elevated slider and storage medium.

The present read/write device also prevents rises in the temperature of the storage medium. This is achieved by reducing power consumption by the semiconductor laser, which in turn further prevents rises in the temperature of the elevated slider. The operating voltage and threshold current of a semiconductor laser are well known. Also, it is well known that the heat assisted magnetic recording/reproduction scheme reduces the threshold current by restraining scattering of light which is not involved in the heating of any recording regions to a minimum. The present read/write device contains a VSAL (very small aperture laser). The VSAL is an edge-emitting semiconductor laser with a tiny aperture in an edge. The use of the VSAL allows for the lowering of edge loss, that is, the loss other than radiation loss through the tiny aperture. This reduces the threshold current, hence power consumption by the semiconductor laser. The other edge have a high reflection film attached to it to lower its edge loss.

Generally, the oscillation threshold of the semiconductor laser is determined by a transparent current required until the active layer in the semiconductor laser comes to produce a gain; a gain produced by injecting a current more than or equal to that transparent current; and loss in the resonator between the two edges. The loss consists of internal loss which occurs throughout the resonator and the edge loss resulting from reflection by the edges. One of the edges of, for example, the VSAL for heat assisted magnetic recording/reproduction is covered with a dielectric and a metal film and shows high reflectance. The tiny aperture through the metal film is so small compared to the laser spot size that it does not disturb the high reflectance of the film. Meanwhile, the other edge, with the attached high reflection film, also contributes to the lowering of the net edge loss. The configuration enables the semiconductor laser to operate with low threshold values. This property is vastly different from the optical pickup found in DVDs in which the reflectance of one of the edges is reduced.

Lasing needs to confine light to the resonator. The most typical laser device contains two mirrors for this purpose. The mirrors are usually, for example, Al mirrors with a film of MgF or another dielectric attached to them for reflectance control or film protection purposes. In such a mirror, light reflects off the air/MgF interface and the MgF/Al interface. A reflection wave is produced by each interference. The semiconductor laser in the present read/write device has edges prepared by polishing or another process (detailed later). On one of these edges (bases) is provided a high reflection film of a dielectric. On the other are provided a dielectric and a metal film. This reflection mechanism may be regarded as constituting laser mirrors, and the edges as constituting a Fabry-Perot resonator.

(i) Structure of Present Read/Write Device

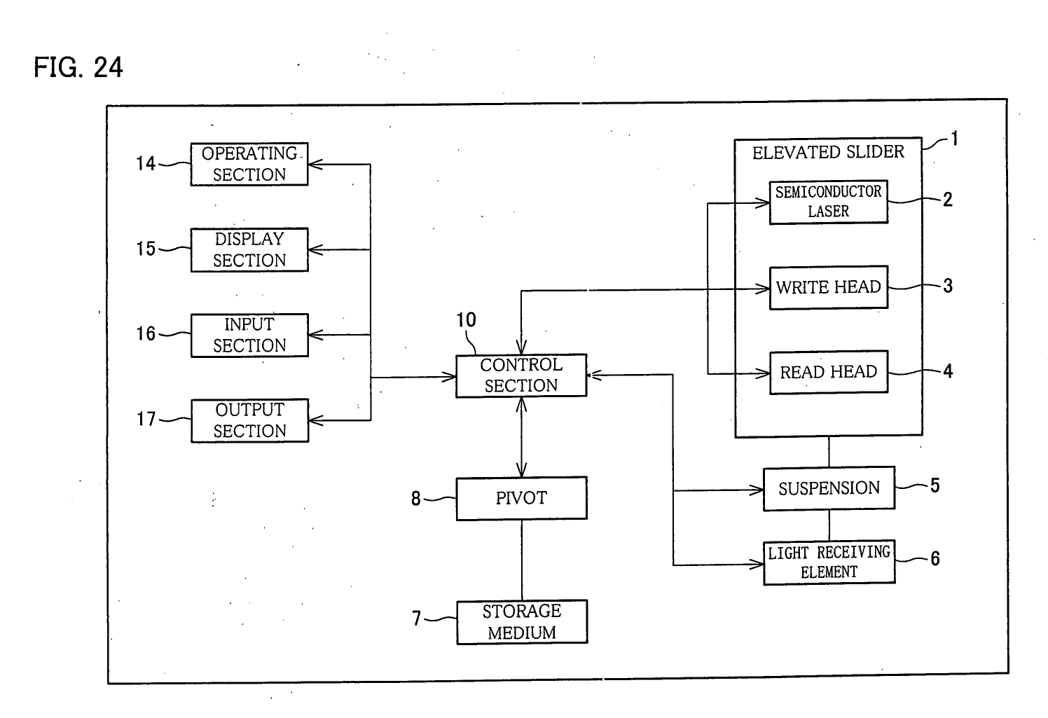

FIG. 24 is a schematic block diagram of the present read/write device. Referring to the figure, the present read/write device contains a control section 10, an elevated slider 1, a nitride semiconductor laser (semiconductor laser) 2, a write head (magnetic write head) 3, a read head (GMR magnetic read head) 4, a suspension 5, a light receiving element 6, a storage medium (magnetic read/write medium, magnetic storage medium) 7, a pivot 8, an operating section 14, a display section 15, an input section 16, and an output section 17.

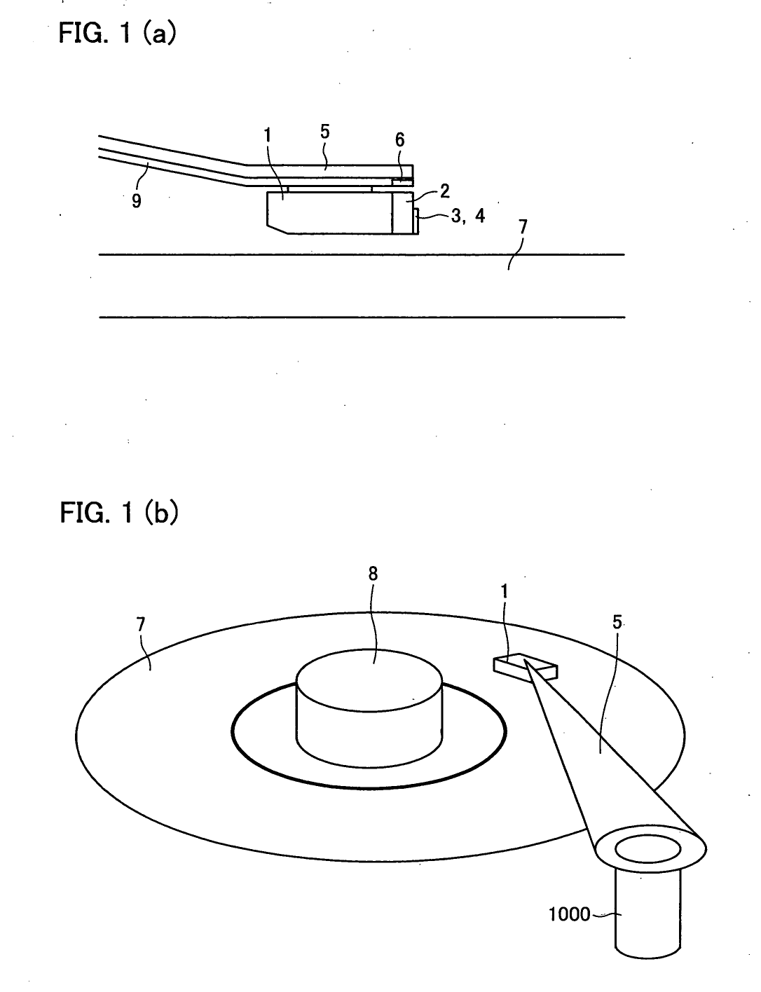

FIG. 1(a) is a schematic cross-sectional view of the write head 3 and the read head 4 and their proximity in the present read/write device. FIG. 1(b) is a schematic perspective view of a major part of the present read/write device.

Being the core of the present read/write device, the control section 10 controls all the operations by the present read/write device. Specifically, the control section 10 controls the operation of the components of the present read/write device in response to user instructions through the operating section 14. Under the control, for example, information is written to and read from the storage medium 7.

The operating section 14 receives user instructions to the present read/write device for transfer to the control section 10. The instructions include drive instructions (record, replay, etc.).

The display section 15 displays, for example, an operation status of the present read/write device for the user, including a notice that the device is standing by for user instructions (user instruction inputs).

The input section 16 provides an interface where the present read/write device receives from external devices information that is to be written on the storage medium 7.

The output section 17 provides an interface where the present read/write device transfers information read from the storage medium 7 to an external device.

The elevated slider 1, as shown in FIG. 1(a), is attached to a suspension 5 supported by a pillar 1000. The elevated slider 1 contains a semiconductor laser 2, a write head 3, and a read head 4. In the present read/write device, the control section 10 controls the operation of suspension drive means (not shown) so as to move the suspension 5 relative to the storage medium 7. The motions moves the semiconductor laser 2, the write head 3, and the read head 4 to a suitable position to read and write the storage medium 7. The elevated slider 1 is equipped with a mechanism which, when out of operation, elevates the slider 1 above an elevated position (elevation height) the slider 1 takes during operation. Current is injected to the semiconductor laser 2 only when the elevated slider 1 is in operating position. This is not however the only possible mechanism for the present read/write device. The elevated slider 1, although separated by a distance from the storage medium 7 in the present embodiment, may be partially in contact with the storage medium 7. The elevation height of the elevated slider 1 above the storage medium 7 is set to 0 nm to 100 nm during operation. At this height setting, heat is conducted from heat sources in the elevated slider 1 (e.g., the semiconductor laser 2 and the magnetic heads [write head 3 and read head 4]) to the storage medium 7, which caps rises in the temperature of the elevated slider 1. Thus, it is possible to prevent malfunction of the read/write device due to excessive heating of the semiconductor laser 2 and the magnetic heads during heat assisted magnetic recording/reproduction, and to drive in a stable manner.

The elevated slider 1, as will be detailed later, is fabricated integral with the semiconductor laser 2. Alternatively, the semiconductor laser 2 may be separately formed and attached onto the elevated slider 1.

The semiconductor laser 2 is provided to raise the temperature of the storage medium 7. To write information, the laser beam (emitted light) from the semiconductor laser 2 raises the temperature of the storage medium 7, thereby decreasing coercive force in a recording region of the storage medium 7. In this condition, the write head 3 applies an external magnetic field to the recording region to write the information. To read information, the laser beam from the semiconductor laser 2 raises the temperature of the storage medium 7, thereby increasing the intensity of residual magnetization in the recording region of the storage medium 7. The read head 4 detects magnetic flux from the residual magnetization to read the information.

The present embodiment assumes that the semiconductor laser 2 be a nitride semiconductor laser. Nevertheless, this is not the only possibility. Alternatively, the semiconductor laser 2 may be any one of many varieties of light-emitting elements which: have a light-emitting layer (not shown) filled with a semiconductor material; are provided with an optical resonator (not shown); and produce stimulated emission of radiation. The semiconductor material may be, for example, a III-V semiconductor or a II-VI semiconductor. The III-V semiconductor is a combination of a group III element, such as B, Al, Ga, and In, and a group V element, such as N, P, As, and Sb. The II-VI semiconductor is a combination of a group II element Zn and a group VI element, such as O, S, and Se. The optical resonator is built on existing technology and may be, for example, of an edge-emitting type or a microdisc structure. The resonator is by no means limiting the effects of the present embodiment.

Now, referring to figures, we will move on to describe the present read/write device equipped with an elevation mechanism which, when out of operation, elevates the slider 1 above the elevated position (elevation height) the slider 1 takes during operation. Members that are indicated by the same reference numerals as the aforementioned members have the same arrangement and function as those members, and the description thereof is omitted.

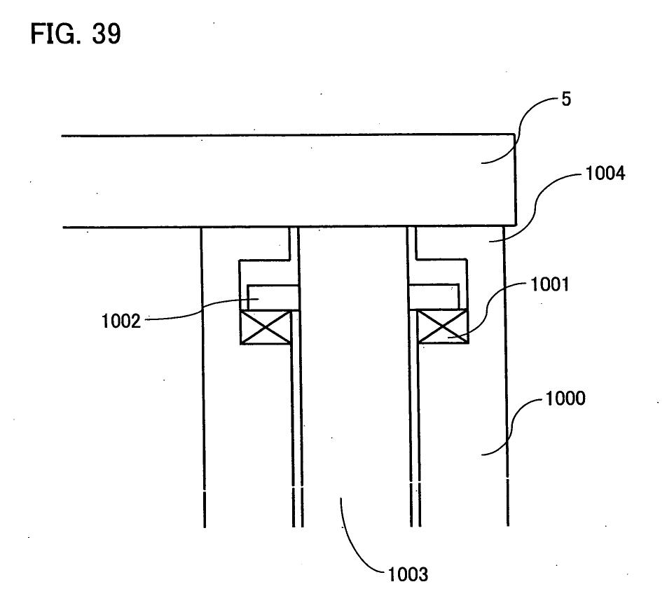

FIG. 39 is a major part a cross-sectional view of an elevation mechanism 1005 which, when out of operation, elevates the suspension 5 above an elevated position (elevation height) the suspension 5 takes during operation. The suspension 5 is mounted to the pillar 1000 and carries the attached slider 1.

As shown in FIG. 39, there is provided a drive axis 1003 in a hollow of the pillar 1000 which is formed like a cylinder. The axis 1003 drives the suspension 5. As the drive axis 1003 moves up and down, the suspension 5 moves accordingly, which in turn moves the elevated slider 1 to an operating elevation height and an non-operating elevation height.

The elevation mechanism 1005 includes a coil 1001, a pillar hook 1004, and a drive axis rib 1002. The coil 1001 is provided in an upper part of the pillar 1000. The pillar hook 1004 forms an end part of the pillar 1000. The drive axis rib 1002 is a permanent magnet attached onto the drive axis 1003.

Current is injected to the coil 1001 to produce a magnetic field, and in turn creates magnetic attraction or repulsion between the coil 1001 and the rib 1002. This magnetic force is utilized to adjust the height of the drive axis 1003. The magnetic force is switched between attractive and repulsive through the control of the direction of the current applied to the coil 1001.

For example, if current is passed in such a direction that the coil 1001 attracts the drive axis rib 1002 when current is passed through the coil 1001 in one direction, the bottom of the drive axis rib 1002 moves into contact with the top of the coil 1001. This particular height of the elevated slider 1 is specified as the height during operation. In this situation, the top of the drive axis rib 1002 is distanced by a gap from the pillar hook 1004. The height of the gap (gap height) is the distance by which the elevated slider 1 is elevated above the operating elevated position (elevation height) when the elevated slider 1 is out of operation (no writing or reading operation being done).

Conversely, if the coil 1001 conducts current in the opposite direction, the repulsion between the coil 1001 and the drive axis rib 1002 lifts up the drive axis rib 1002. In this situation, the drive axis 1003 moves upwards until the bottom of the pillar hook 1004 contacts the top of the drive rib 1002.

In this manner, the position of the elevated slider 1 when the coil 1001 is conducting such current that the top of the coil 1001 attracts the drive axis rib (permanent magnet) 1002 is designated the operating elevated position of the elevated slider 1 (writing or reading operation being done). The position of the elevated slider 1 when the coil 1001 is conducting such current that the top of the coil 1001 repulses the drive axis rib 1002 is designated the non-operating elevated position of the elevated slider 1 (no writing or reading operation being done).

The non-operating elevation height of the elevated slider 1 above the storage medium 7 in the present read/write device is preferably the operating elevation height plus about 1 μm to 10 μm. This preferable height prevents the storage medium 7 from crashing to the elevated slider 1 due to wobbling of the storage medium (disc) 7. Thus, the elevated slider 1 and the storage medium 7 are protected from damage.

The foregoing elevation mechanism 1005 is a mere example of possible elevation mechanisms which, when out of operation, can elevate the suspension 5, hence the elevated slider 1 attached to it, above the operating elevated position. A different mechanism may be used.

Another example of such a mechanism is a cam mechanism provided on top of the pillar 1000: The elevated slider 1 is mounted to an end of the suspension 5. The pillar 1000 supports the other end of the suspension 5 via the cam mechanism so that the suspension 5 is rotatable vertically around an axis in the mechanism. The vertical rotation lifts up the far end of the suspension 5 where the elevated slider 1 sits.

Another example uses an elevation mechanism disposed below the storage medium 7. The mechanism adjusts the elevated position of the elevated slider 1 through magnetic attraction and repulsion. The mechanism may have the same structure as the elevation mechanism 1005, albeit attached to the pivot 8 around which the storage medium 7 is rotated. In such a mechanism, however, the position of the elevated slider 1 when the coil 1001 is conducting such current that the top of the coil 1001 repulses the drive axis rib (permanent magnet) 1002 is designated the operating elevated position of the elevated slider 1 (writing or reading operation being done). Conversely, the position of the elevated slider 1 when the coil 1001 is conducting such current that the top of the coil 1001 attracts the drive axis rib 1002 is designated the non-operating elevated position of the elevated slider 1 (no writing or reading operation being done).

The elevation mechanism 1005 is capable of precise control (fixing) of the elevated position of the elevated slider 1 during operation, because magnetic attraction or repulsion, which is continuously acting, retains the slider 1 in the operating elevated position. So are like elevation mechanisms which adjust the elevated position of the elevated slider 1 through magnetic attraction and repulsion. Writing and reading of the storage medium 7 can therefore accurately done.

A sensor mechanism may be provided to determine whether the elevated slider 1 is in the operating elevated position or the non-operating elevated position. An example of such a sensor mechanism may include electrodes, one on the top of the pillar hook 1004 and another on the bottom of the suspension 5, so that they can come in contact with each other. The mechanism can determine that the elevated slider 1 is in the operating elevated position if current flows between the electrodes and in the non-operating elevated position if no current flows.

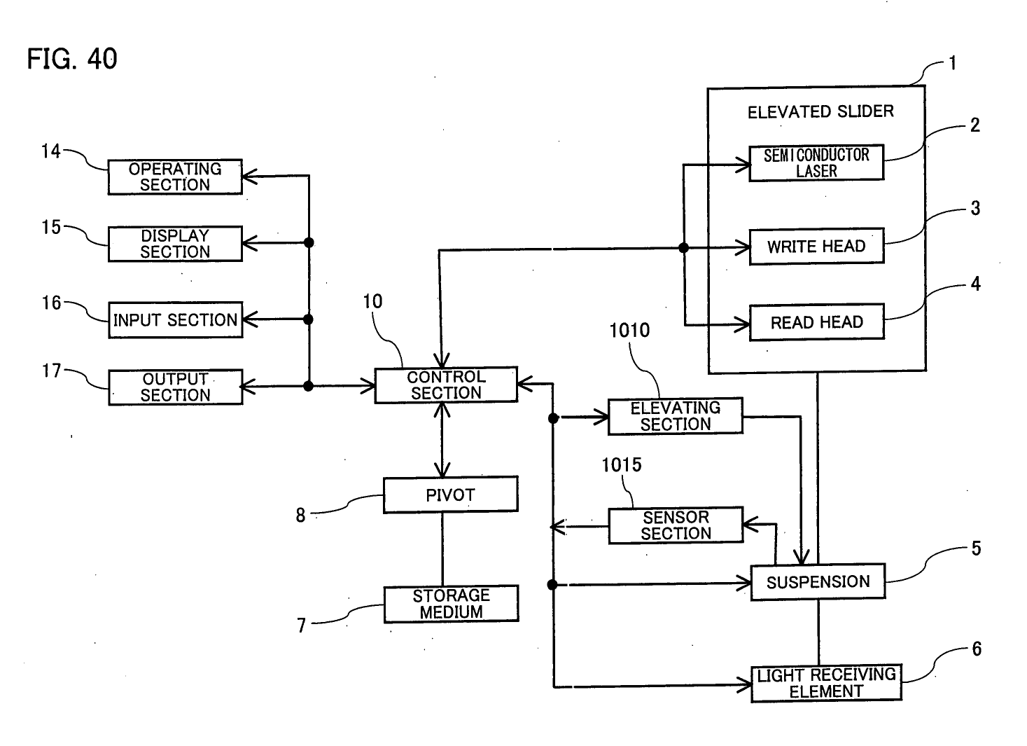

Next, operations related to the control of the elevation height in the present read/write device will be described. FIG. 40 is a block diagram of the present read/write device having the elevation mechanism 1005 in FIG. 39. As could be understood from the figure, the present read/write device includes an elevating section (elevation control section) 1010 controlling the elevation mechanism 1005, as well as the structure shown in FIG. 24.

As shown in FIG. 40, the elevating section 1010 moves the suspension 5, hence the elevated slider 1, to the non-operating elevated position or the operating elevated position in response to an instruction from the control section 10. A sensor section (sensor mechanism) 1015 is provided to detect the elevated position of the suspension 5. The sensor section 1015 is dispensable if the elevation mechanism 1005 shown in FIG. 39 is used. The sensor section 1015 may, for example, have the same structure as the sensor mechanism. That is, the sensor section 1015 may include electrodes, one on the top of the pillar hook 1004 and another on the bottom of the suspension 5, so that they can come in contact with each other. The section 1015 can detect the elevated position of the suspension 5 by the detection/failed detection of current flow between the electrodes.

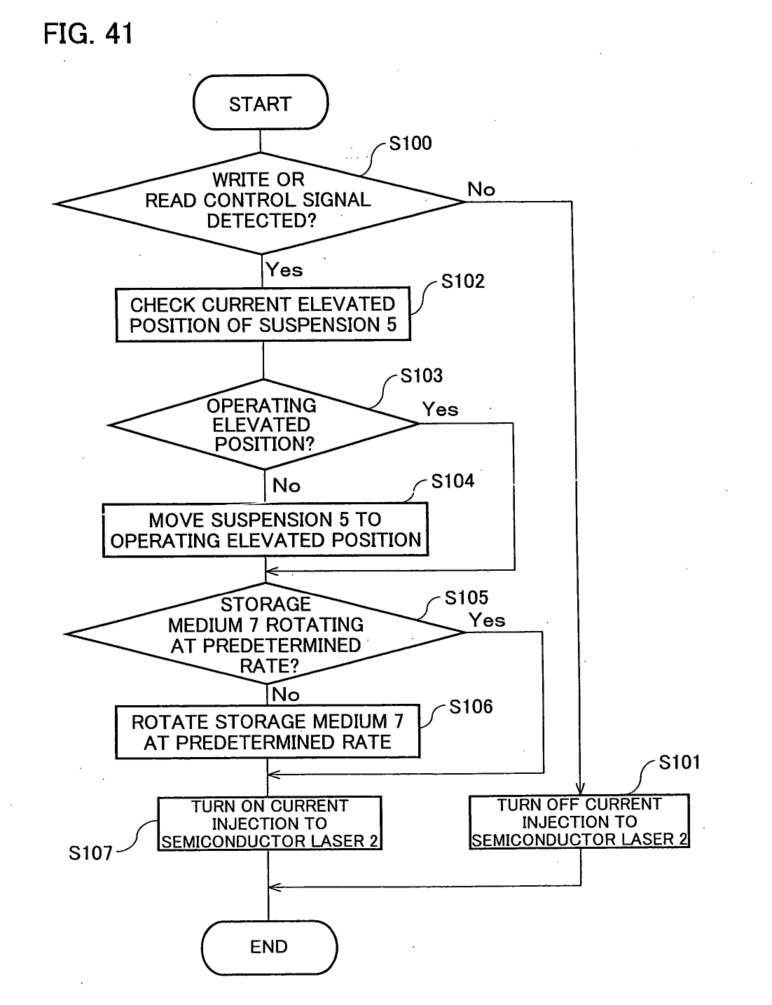

Now, referring to FIG. 41, the operation of the control section 10 will be described. FIG. 41 is a flow chart illustrating a process for controlling the elevated position of the elevated slider 1 and current injection to the semiconductor laser 2. Both controls are implemented by the control section 10.

First, the control section 10 checks for a detection of a write or read control signal (S100). If no write/read control signal has been detected, the section 10 turns off the current injection to the semiconductor laser 2 (S101), ending the process.

In contrast, if the section 10 determines in S100 that a write/read control signal has been detected, the control section 10 checks a current elevated position of the suspension 5 (S102), and then determines whether the checked position is the operating elevated position (S103). For example, the sensor section 1015 may determine whether current is flowing between the electrodes on the top of the pillar hook 1004 and on the bottom of the suspension 5. Alternatively, the current position of the suspension 5 may be determined based on the direction of the current being injected into the coil 1001 in the elevation mechanism 1005.

If it is determined in S102 that the suspension 5 is not at the operating elevation height, the control section 10 instructs the elevating section 1010 to move the suspension 5 to the operating elevation height (S104). Specifically, current is injected in the opposite direction to the coil 1001 to adjust the position of the elevated slider 1 to the operating elevated position.

After completing S104, or if the suspension 5 is determined in S103 to be at the operating elevation height, the control section 10 determines whether the storage medium 7 is rotating at a predetermined rate (predetermined linear velocity) (S105). If the storage medium 7 is not rotating at the predetermined rate, the storage medium 7 is made to rotate at the predetermined rate (S106).

After completing S104, or if the storage medium 7 is determined in S103 to be rotating at the predetermined rate, the control section 10 injects current to the semiconductor laser 2 (S107) to execute a write or read step before ending the process. After the write or read step, S100 and the succeeding steps may be repeated. To do this, a next write/read control signal is detected. Then, the elevated position of the semiconductor laser 2 and the suspension 5, as well as the rotation of the storage medium 7, are controlled through similar steps to those in the flow chart in FIG. 41.

If no more write/read control signal is detected, the current injection to the semiconductor laser 2 is suspended in S101. When this is actually the case, the section 10 may stand by for a detection of a next write/read control signal while retaining the suspension 5 in the operating elevated position and the storage medium 7 in rotation. Upon the detection of the signal, S100 and the succeeding steps will be repeated. When this is actually the case, the suspension 5 is in the operating elevated position, and the storage medium 7 is rotating; upon a next detection of a write/read control signal, current can be injected immediately to the semiconductor laser 2. Therefore, the write/read process can be instantly done.

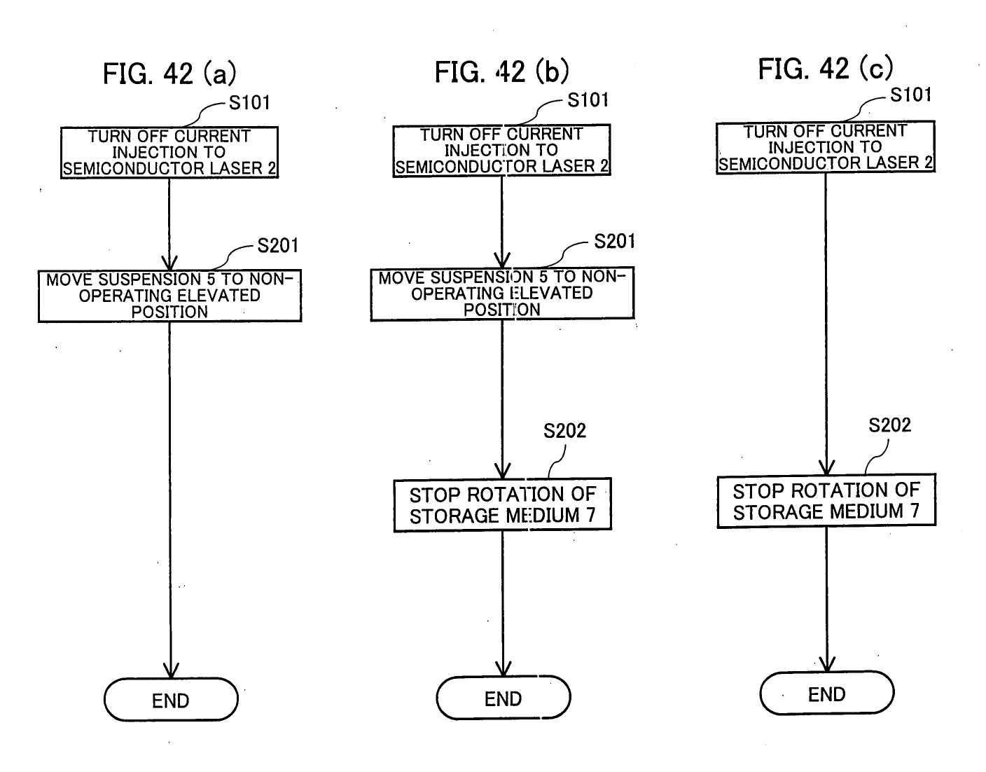

Referring to FIG. 42(a), after suspending the current injection to the semiconductor laser 2 in S101 (after turning off the current), the control section 10 may instruct the elevating section 1010 to move the suspension 5 to the non-operating elevated position (S201). This concludes the process by the control section 10.

When this is the case, the storage medium 7 keeps on rotating, and the suspension 5 moves away from the storage medium 7. Therefore, the elevated slider 1 including the semiconductor laser 2 is protected from crashing to the storage medium 7.

Further, an impact on the read/write device resulting from an external factor is prevented from forcing the elevated slider 1 to come in contact with the storage medium 7, because the suspension 5 has been moved away from the storage medium 7.

Thus, the elevated slider 1 and the storage medium 7 are protected from damage. Whether to implement S201 after S101 may be determined depending on, for example, the length of time elapsed after the completion of S101. For example, if no more write/read control signal is received (detected) for 10 minutes after suspending the current injection to the semiconductor laser 2 in S101, S201 may be implemented.

Alternatively, as shown in FIG. 42(b), after suspending the current injection to the semiconductor laser 2 in S101 and adjusting the position of the suspension 5 to the non-operating elevated position in S201, the control section 10 may stop the rotation of the storage medium 7 (S202). This concludes the process by the control section 10.

This process decreases the operational power for the read/write device, achieving power savings. Whether to implement S202 after S201 may be determined depending on, for example, the length of time elapsed after the completion of S201. For example, if no more write/read control signal is received (detected) for 10 minutes after adjusting the position of the suspension 5 to the non-operating elevation height in S201, S202 may be implemented.

Further, as shown in FIG. 42(c), after suspending the current injection to the semiconductor laser 2 in 101, the rotation of the storage medium 7 may be stopped (S202) while the control section 10 is still retaining the suspension 5 at the operating elevation height (S201 being skipped). This concludes the process.

The process is applicable if the elevated slider 1 is CSS (contact, start, stop) compatible. The process decreases the operational power for the read/write device, achieving power savings. Whether to implement S202 after S101 may be determined depending on, for example, the length of time elapsed after the completion of S101. For example, if no more write/read control signal is received for 10 minutes after suspending the current injection to the semiconductor laser 2 in S101, S202 may be implemented.

As illustrated in the flow charts, the semiconductor laser 2 can be turned on only during writing and reading by turning off the current injection to the semiconductor laser 2 if no write/read control signal is detected. This prevents the semiconductor laser 2 from being turned on when unnecessary. The ON duration is thus reduced. Heating from the semiconductor laser 2 is reduced.

The write head (magnetic write head) 3 applies an external magnetic field to write information in recording regions of the storage medium 7.

The read head (GMR magnetic read head) 4 reads information through detection of magnetic flux from the residual magnetization in the recording regions of the storage medium 7.

The suspension 5 moves the semiconductor laser 2, the write head 3, and the read head 4 to the writing/reading position over the storage medium 7. The suspension 5, as shown in FIG. 1(a), also contains printed wiring 9 connecting to the semiconductor laser 2, the write head 3, the read head 4, etc. The control section 10 drives the semiconductor laser 2, the write head 3, the read head 4, etc. through the printed wiring 9.

The light receiving element (Si light receiving element) 6 receives light escaping from the back of the semiconductor laser 2 (the side of the laser 2 opposite the storage medium 7). In the present read/write device, as shown in FIG. 1(a), the light receiving element 6, located at the tip of the suspension 5, is connected to the printed wiring 9. This connection enables the element 6 to receive the light escaping from the back of the semiconductor laser 2. The light receiving element 6 may be mounted directly to the suspension 5 or directly to the light exit face (not shown) on the back of the semiconductor laser 2.

The storage medium (magnetic read/write medium) 7 is a storage medium on which information can be written/read. The storage medium 7 may be a known magnetic storage medium compatible with the heat assisted magnetic recording/reproduction scheme. Examples include a TbFeCo-based ferrimagnetic and any material in which a minuscule region, when heated with a semiconductor laser in a reading, increases its residual magnetization and gives an improved S/N ratio. The magnetic recording scheme may be either in-plane or perpendicular.

FIG. 8 depicts the structure of the storage medium 7 in accordance with the present embodiment. As shown in the figure, the storage medium 7 contains a second heatsink layer 62, a backing layer 63, a heat barrier layer 64, a first heatsink layer 65, a magnetic recording layer 66, and a protection film 67. All these layers and film are formed in this order on a 2.5-in. glass substrate 61. The storage medium 7 is fixed (attached) to the present read/write device. The storage medium 7 may however separable from the present read/write device.

The second heatsink layer 62 is made of Al has a thickness of 50 μm. The second heatsink layer 62 may be made of any material, preferably one having thermal conductivity, such as Al or Ag. The second heatsink layer 62 is preferably made of, as an example, a material with a thermal conductivity of at least 100 W/m/° C. or more and has a thickness of 10 μm or more. Plating is a preferred method to form such a thick metal film, but other existing techniques are also applicable. The second heatsink film (second heatsink layer) 62 may be polished after being formed, for better planarity of the surface.

The backing layer 63 is made of a 100 nm permalloy. The backing layer 63 may be made of any material which is a soft magnetic, including permalloys. The heat barrier layer 64 is made of SiO₂. The heat barrier layer 64 may be made of any material which is preferably either a dielectric or a semiconductor, including SiO₂. The first heatsink layer 65 is made of 5 nm Al. The magnetic recording layer (recording layer) 66 is made of 50 nm TbCoFe. The protection film 67 is 5 nm DLC (diamond-like carbon) formed on the surface of the magnetic recording layer 66.

The storage medium 7 in accordance with the present embodiment has minuscule regions which, when heated with the semiconductor laser 2 in a reading, increase their residual magnetization and give an improved S/N ratio. The present embodiment assumes that the storage medium 7 is a TbFeCo-based ferrimagnetic. The medium 7 may be any storage medium commonly used with the heat assisted magnetic recording/reproduction scheme. The magnetic recording scheme may be either in-plane or perpendicular.

The storage medium 7 is not limited to the aforementioned structure. For example, the second heatsink layer 62 may be on the other side of the glass substrate 61 from the recording layer 66.

Alternatively, there may be a recording layers 66 on each side of the glass substrate 61. For example, the second heatsink layer 62 may be disposed between the glass substrate 61 and one of the recording layers 66, with the heat barrier layer 64 being disposed between the second heatsink layer 62 and the glass substrate 61, and the other recording layer 66 being disposed on the other side of the glass substrate 61 from the second heatsink layer 62 and one of the recording layers 66.

The pivot 8 drives the storage medium 7 so that it rotates. Specifically, the pivot 8 drives the storage medium 7 in response to instructions from the control section 10 so that the storage medium 7 can rotate.

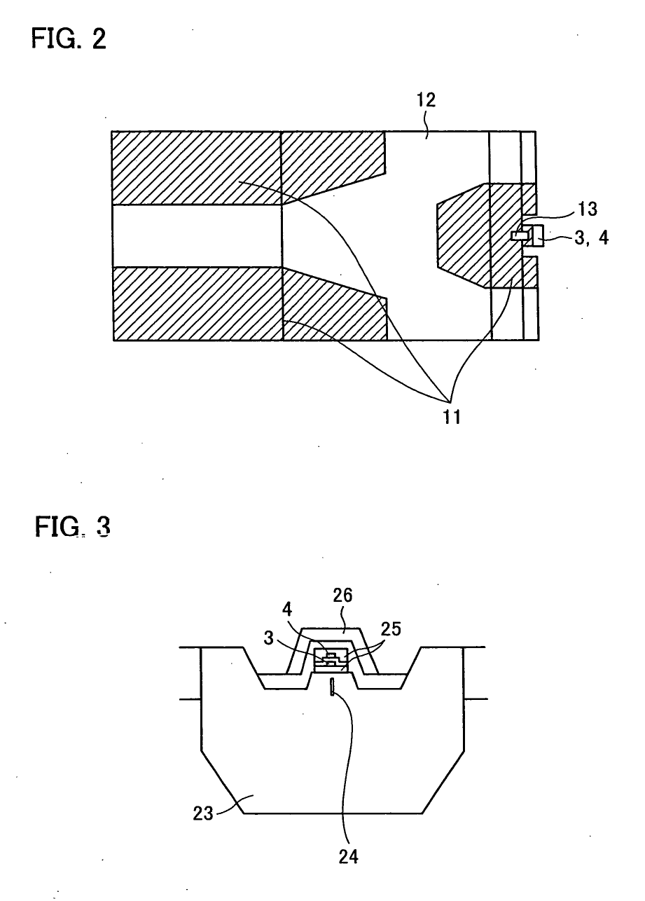

FIG. 2 is an enlarged bottom view (the side facing the storage medium 7) of the elevated slider. As shown in the figure, the elevated slider 1 contains flow restricting convex sections 11, a flow restricting concave section 12, a near-field light emitting mechanism 13, a write head 3, and a read head 4.

The flow restricting convex sections 11 and the flow restricting concave section 12 restrict air flow along the bottom (side facing the storage medium 7) of the elevated slider 1 to one direction. This air flow restriction along the bottom of the elevated slider 1 to one direction can appropriately cool down the elevated slider 1. The air flow is primarily caused by the rotation of the storage medium 7 and the convection induced by the heat dissipated by the elevated slider 1 and the storage medium 7.

FIG. 3 schematically illustrates the structure of members surrounding the near-field light emitting mechanism section (near-field light emitting mechanism 13) and the magnetic heads (write head 3 and read head 4). As shown in the figure, a tiny aperture 24 (near-field light emitting mechanism 13) is provided through an edge of the semiconductor laser 2 (not shown in FIG. 3) opposite the storage medium 7. The provision of the aperture 24 enables the generation of near-field. In other words, the present read/write device generates near-field by what is known as VSAL (very small aperture laser). A Pt thin film 23 is stacked on an Al thin film and a SiO₂ film (in terms of the normal to the paper on which the figure is drawn). Neither the Al nor the SiO₂ film is shown. The tiny aperture 24 is preferably smaller than a NFP (near-field pattern) produced by the semiconductor laser 2.

The near-field light emitting mechanism 13 produces near-field light, that is, an optical near field. Generally, near-field is electromagnetic waves having the frequency of light confined to space equal to or smaller than the diffraction limit. The near-field spot size d is less than the wavelength, λ, of light incident to the near-field generating mechanism (d<λ). This near-field can be represented by superposition of waves of different wavenumbers. Those with low wavenumbers, emitted from the near-field light emitting mechanism 13, can propagate in the air. Near-field light propagates in space equal to or smaller than the diffraction limit of light. The use of near-field light therefore delivers spatial resolutions beyond the diffraction limit. In contrast, waves with high wavenumbers are termed evanescent waves or evanescent light. The intensity of those waves or light exponentially decreases with increasing distance from the near-field generating mechanism, and becomes sufficiently low at about λ. The near-field light produced by the near-field light emitting mechanism 13 in the present specification takes all these electromagnetic fields into consideration.

The present embodiment uses a VSAL (very small aperture laser) in which one of edges has a metal film and a tiny aperture. The tiny aperture is equal to or smaller than the aforementioned wavelength of the laser. The near-field light is produced by the coupling of the distribution of the electric field in the tiny aperture with the transverse mode of the semiconductor laser.

The near-field generating mechanism is not limited to the VSAL. Currently proposed alternatives to the mechanism include metal fine particles and optical antennae called bowties. Whichever of the near-field generating mechanism is used, the mechanism hardly affects the effects of the present invention, allowing the present invention to achieve sufficient effects.

For the structure containing metal fine particles on an edge of the semiconductor laser, it is suggested to provide the metal fine particles in the VSAL tiny aperture. The electric field in the VSAL tiny aperture excites the localized plasmon caused by the metal fine particles. The localized plasmon is expected to produce a high intensity near-field. The metal fine particles preferably measure less than the wavelength. The tiny aperture may measure more than the wavelength.

A near-field generating mechanism based on a bowtie may be provided at an edge of the semiconductor laser. A bowtie here refers to a single triangle metal plate or a pair of triangle metal plates combined face to face. The structure is so called because of its bowtie-like shape. There is nothing that would correspond to the knot; the two metal plates are separate from each other. Each plate measures roughly the same or less than wavelength. In this structure, the transverse mode of the semiconductor laser is thought to cause surface plasmon with the metal plate(s). The surface plasmon in turn produces near-field close to the knot of the bowtie. This bowtie may be provided on one of the edges of the semiconductor laser.

The present read/write device assumes that the semiconductor laser 2 includes the near-field light emitting mechanism 13 as an additional mechanism. The near-field light emitting mechanism 13 however does not needed to be included. The semiconductor laser 2 may include another additional mechanism, such as a wavelength conversion element (not shown).

As shown in FIG. 3, the write head 3 and the read head 4 are included in the stacks of a magnetic shield 25/write head 3/magnetic shield 25/read head 4/magnetic shield 25 provided in this order at the tip of the elevated slider 1. These members are covered with a return layer 26.

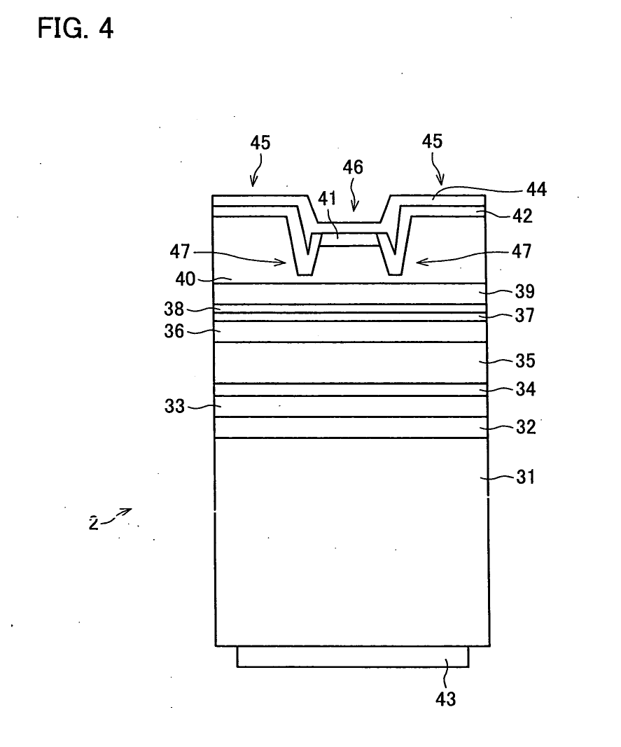

FIG. 4 is a detailed view of the elevated slider 1 and the semiconductor laser 2. As shown in the figure, the semiconductor laser 2 contains a n-GaN substrate 31, a n-GaN buffer layer 32, a n-GaN layer 33, a n-InGaN crack prevention layer 34, a n-AlGaN clad layer 35, a n-GaN guide layer 36, a n-InGaN active layer 37, a p-AlGaN carrier block layer 38, a p-GaN guide layer 39, a p-AlGaN clad layer 40, a p-GaN contact layer 41, an insulating film 42, a n-electrode 43, and a p-electrode 44. Still referring to the same figure, the semiconductor laser 2 includes a refractive index waveguide of a ridge structure.

The elevated slider 1 is fabricated out of the n-GaN substrate 31. Specifically, the elevated slider 1 is formed integral with the semiconductor laser 2 out of a single substrate containing Ga and N as chief components. The semiconductor laser 2 is fabricated on the substrate by epitaxial growth. A “chief” component in the present specification is defined as accounting for more than or equal to 99%; 1% impurities and other elements are tolerated.

The fabrication of the semiconductor laser 2 out of the substrate of GaN with a high thermal conductivity is preferred for resultant high thermal dissipation of the semiconductor laser 2. The substrate on which the semiconductor laser 2 is built is not limited to the foregoing material, and may be made of other materials. Exemplary alternatives include sapphire, ZrB2, and SiC.

(i) Manufacturing Method for Semiconductor Laser 2

The following will describe a manufacturing method for the semiconductor laser (semiconductor laser device) 2 of the present embodiment in reference to figures.

First, a gallium nitride semiconductor layer is formed on the GaN substrate 31 by epitaxial growth. Epitaxial growth is a method of growing a crystal film on a substrate. Specific viable examples include VPE (vapor phase epitaxy), CVD (chemical vapor deposition), MOVPE (metal-organic vapor phase epitaxy), MOCVD (metal-organic chemical vapor deposition), halide-VPE (halide vapor phase epitaxy), MBE (molecular beam epitaxy), MOMBE (metal-organic molecular beam epitaxy), GSMBE (gas source molecular beam epitaxy), and CBE (chemical beam epitaxy).

In the present embodiment, the GaN substrate 31, having a thickness of about 200 μm to 1 mm, is first loaded into an MOCVD device. The low temperature GaN buffer layer 32 is then grown to 25 nm at a growth temperature of 550° C. using NH₃ which is a group V material and TMGa which is a group III material.

Next, SiH₄ is added to these materials at a growth temperature of 1075° C. The n-GaN layer 33 is grown to 3 μm. The layer 33 includes 1×10¹⁸/cm³ Si as an impurity.

Subsequently, the growth temperature is lowered from about 700° C. to 800° C. TMIn, a group III material, is supplied to grow the n-In_{0.07}Ga_{0.93}N crack prevention layer 34 to 50 nm.

Next, the substrate temperature is elevated to 1075° C. The n-Al_{0.07}Ga_{0.93}N clad layer 35 is grown to a thickness of 2.0 μm using TMAl which is a group III material. The layer 35 includes 1×10¹⁸/cm³ Si as an impurity. Subsequently, the n-GaN guide layer 36 is grown to 0.1 μm.

The n-AlGaN clad layer 35 is not limited to the foregoing structure. For example, the layer 35 may be a crystal mixture in which the Al ratio to the mixture is uniform, changes discretely, or varies continuously in the range of about 0.03 to 0.20. Also, the thickness of the layer 35 may not be uniform. It is however preferable if the n-AlGaN clad layer 35 is at least 0.7 μm thick or thicker. The n-AlGaN clad layer 35 may be a SLS (superlattice structure) of AlGaN/GaN.

The n-GaN guide layer 36 is not limited to the foregoing structure either. The layer 36 may contain a small amount of In in the crystal mixture or be undoped to a Si concentration level of 1×10¹⁷/cm³ or less. Also, the thickness of the layer 36 may not be uniform. Alternatively, the n-GaN guide layer 36 may be a SLS of InGaN/GaN. If the guide layer 36 contains InGaN, it is preferred to grow the layer 36 at about 700° C. to 800° C. Especially, if InGaN is contained, crystallinity is expected to improve by a suspension of the growth.

Thereafter, the substrate temperature is lowered to 730° C., followed by growth of the active layer (multiplex quantum well structure) 37. The layer 37 contains a three repeated pairs of a barrier layer and a well layer, that is, a barrier layer/well layer/barrier layer/well layer/barrier layer/well layer/barrier layer, which are grown in this order. Each barrier layer is In_{0.007}Ga_{0.993}N and 8 nm thick. Each well layer is In_{0.08}Ga_{0.92}N and 4 nm thick. Upon the completion of formation of a barrier layer or a well layer, the growth may be suspended for not less than 1 second and not more than 180 seconds before starting formation of a next layer. The suspension improves the flatness of the layers and decreases half width of radiation. The present embodiment assumes that the active layer 37 is doped with an impurity, Si. Alternatively, the barrier layers and the well layers may all be undoped to a Si concentration level of 1×10¹⁷/cm³ or less, or either the barrier layers or the well layers may be undoped. Further, the active layer 37 may contain not the three repeated pairs, but from two to six repeated pairs instead.

The thickness of the last barrier layer in the active layer 37 may be altered between 8 nm and 100 nm. The n-type last barrier layer with an increased thickness allows for designs for a high mode refractive index, which result in limited radiation and scattering onto the GaN substrate.

Next, the substrate temperature is elevated again to 1050° C., followed by growth of the p-Al_{0.3}Ga_{0.7}N carrier block layer 38 to 18 nm. In the present embodiment, Cp₂Mg is used, and Mg is added as a p-type impurity to 5×10¹⁹/cm³ to 2×10²⁰/cm³. The p-Al_{0.3}Ga_{0.7}N carrier block layer 38 is preferably 5 nm to 40 nm thick. The p-Al_{0.3}Ga_{0.7}N carrier block layer 38, if thinner than 5 nm, would result in a higher threshold. The aluminum in the p-Al_{0.3}Ga_{0.7}N carrier block layer 38 may decrease in a p-layer direction (direction in which a p-type tendency increases). Also, the layer 38 may be made of sublayers each having different Al contents from the others.

Subsequently, the p-GaN guide layer 39, the p-Al_{0.1}Ga_{0.9}N clad layer 40, and the p-GaN contact layer 41 are grown to 0.10 μm, 0.5 μm, and 0.1 μm respectively. In the present embodiment, Mg is added in the growth process as a p-type impurity to the p-GaN guide layer 39, the p-Al_{0.1}Ga_{0.9}N clad layer 40, and the p-GaN contact layer 41 to a concentration level of 5×10¹⁹/cm³ to 2×10²⁰/cm³. The p-GaN guide layer 39 preferably has a thickness of from 0 μm to 0.15 μm; or no layer 39 may be formed at all. The p-AlGaN clad layer 40 is not limited to the foregoing composition; it is preferable if the Al accounts for 0.03 to 0.1. The p-AlGaN clad layer 40 may be not a single layer, but a SLS of AlGaN/GaN as an example.

As explained so far, the present embodiment uses TMGa, TMAl, TMIn, NH₃, Cp₂Mg, and SiH₄ as materials for the layers in the semiconductor laser 2.

After forming the p-GaN contact layer 41, a ridge structure is fabricated by dry etching. The periphery of the ridge has a W channel structure as shown in FIG. 4. To fabricate the semiconductor laser 2 with a ridge structure at the tip of the elevated slider 1 as shown in FIG. 1(a), it is preferable if ridge-flanking convex areas 45 are above a ridge top 46 in the W channel; this layout prevents the ridge part from being damaged by a contact with the storage medium 7.

Next, the insulating film 42 is formed of SiO₂ to cover the ridge-flanking convex areas 45 and ridge Concave areas 47. Thereafter, the p-electrode 44 is formed of Pd/Mo/Au on top of the insulating film 42. The p-electrode 44 is preferably flush with neither the edge facing the storage medium 7 nor the bottom of the elevated slider 1. In other words, the p-electrode 44 is preferably shorter than the resonator. This is because the flap of the p-electrode 44 could possibly disturb the air flow along the bottom of the elevated slider 1 and disrupt stable elevation. Note that the edge facing the storage medium 7, as will be described later, refers to the laser edge of the semiconductor laser 2 which is diced out of a wafer and polished. Even if the edges are formed by a different method, the p-electrode 44 is not preferably flush with the laser edge after formation. The insulating film 42 may be made of not SiO₂, but Ta₂O₅, SiO, TiO₂, ZrO₂, Al₂O₃, or a mixture or layered structure of these materials, to name a few examples. Also, the film 42 may have a loss guide structure of Si or another absorbing material. The ridge width in the ridge structure is preferably from about 0.5 μm to about 3.0 μm. Also applicable are the modulated ridge structure in which the ridge width may not be constant and the taper ridge structure.

Next, a thin metal film is vapor deposited on the back of the GaN substrate 31 to fabricate the n-electrode 43. In the present embodiment, the n-electrode 43 has a layered Hf/Al structure and is fabricated by vacuum vapor deposition. This deposition method is suited for the fabrication of a thin metal film like the electrode 43, because the method allows the film thickness to be kept under precise control during the fabrication. The electrode 43 may however be formed not by vacuum vapor deposition, but by ion plating, sputtering, or another like technique. In the present embodiment, an annealing step is carried out at 500° C. following the formation of the metal film. The step is intended to improve the properties of the p-, n-electrodes and make them good ohmic electrodes.

Next, the magnetic heads (write head 3 and read head 4) shown in FIG. 3 are fabricated by sputtering. The magnetic heads can be fabricated by an existing method, such as ion plating or vapor deposition. The magnetic heads does not necessarily have the structure shown in FIG. 3, but may be of any existing structure.

First, an insulating film (not shown) is formed on the p-electrode 44. Then, on the resultant film are stacked the magnetic shield (shield layer) 25, the write head (recording layer) 3, the magnetic shield 25, the read head (GMR reproduce layer) 4, the magnetic shield 25, and the return layer 26. These layers are formed by existing magnetic head manufacturing technology such as sputtering. The write head 3 and the read head 4 may have a different structure. For example, the read head 4 may be a TMR element. The write head 3 and read head 4 may be provided at different positions from the foregoing positions.

The wafer, thus fabricated, is diced perpendicular to the ridge or electrode stripe with a wire saw or a thin blade so that each diced piece measures about 100 μm to 650 μm in width. Thereafter, a polishing step is carried out in several stages to form the edges of the semiconductor laser 2. For example, a diamond slurry is used in the step to form mirror surfaces.

The edges may be formed not by this method, but by dry etching. In the latter case, the edges need be formed before dicing the wafer. Following the formation of the edges by dry etching, the wafer is diced, scribed, or otherwise divided into bars.

The edges may be formed by cleaving. When this is the case, first, a scribe line is created in the front face with a diamond point. An appropriate level of force is then applied to the wafer to divide the wafer along the scribe line. The scribe line may be created in the back face.

Alternative exemplary techniques that divide the wafer similarly include laser scribing and laser ablation. In the former, a crack is created by heating an appropriate part of the wafer with an excimer or other laser beam and then quickly cooling that part. In the latter, an appropriate part of the wafer is irradiated with a laser beam of high output power so that the part vaporizes, leaving a groove. The wafer is divided using the crack or groove as a scribe line.

Next, a high reflection film (not shown) is formed on the edge on the back of the semiconductor laser 2, that is, on a side of the semiconductor laser 2 opposite the storage medium 7. The high reflection film can be formed by existing technology. For example, a dielectric of a low refractive index and that of a high refractive index are alternately stacked. When this is the case, it is preferable to use, for example, SiO₂, SiN, or Al₂O₃ as the low refractive index material and TiO₂, Ta₂O₅, or ZrO₂ as the high refractive index material. It is preferable if at least three or more pairs of these materials are stacked in every optical length of λ/4. In the present embodiment, four pairs of SiO₂/TiO₂ are stacked, which results in a reflectance of 95%.

Next, a SiO₂ film (not shown), an Al coating film (not shown), and the 5 nm thick Pt coating film (Pt thin film) 23 are stacked on the front face of the semiconductor laser 2, that is, a side of the semiconductor laser 2 opposite the storage medium 7. The tiny aperture 24 is then made by FIB (focused ion beam). The Al could form stripes which would scatter laser beams. To avoid this from happening, the Al needs be stacked on Ni or a like material, provided beforehand, which has a high coating rate and is likely to form stripes. Further, since the Al coating film is easily oxidized, the Al coating film, after its formation, may be coated with a film of a metal or a dielectric which is hard to oxidize. The Pt coating film 23 may be replaced by a film of a metal, such as Au, or a dielectric, such as SiO₂. The Al coating film may be replaced by a film of Ag or a like metal. The SiO₂ film may be replaced with a different dielectric film, such as Al₂O₃, TiO₂, or Ta₂O₅ or a bismuth-based ferroelectric film.

Next, the flow restricting convexes/concave (flow restricting convex sections 11 and flow restricting concave section 12) shown in FIG. 2 are formed on the bottom of the elevated slider 1, that is, a side of the elevated slider 1 opposite the storage medium 7. These convexes/concave may be fabricated by, for example, forming the flow restricting concave section 12 by dry etching and the flow restricting convex sections 11 by vacuum vapor deposition. They may be fabricated by FIB. A combination of these methods may also be used. There are no particular limitations on the material of the flow restricting convex sections 11 and the flow restricting concave section 12.

The flow restricting convex sections 11 are preferably designed to at least either one of the following conditions. That is, it is preferable if the averaged elevation height satisfies the following equation:

$${\int }_{S} \frac{1}{L} ⅆ s \geq 0.4 [ m ]$$

where ds is the area of a small region of the bottom of the elevated slider 1, L(s) is the distance separating the small region on the bottom from the storage medium 7, and S is the sum area of the bottom of the elevated slider 1.

Air has a thermal conductivity of 2.80×10⁻² W/m° C. Multiplying this value by 0.4 m, the thermal resistivity between the elevated slider 1 and the storage medium 7 is (1.12×10⁻³)⁻¹=8.9×10²° C./w. Therefore, provided that the sum of the injection power to the elevated slider 1 is 100 mW, the temperature of the elevated slider 1 is 89° C. higher than the temperature of the storage medium 7 placed below the slider 1. The thermal resistivity of a typical semiconductor laser is 40 or less. However, the semiconductor laser 2 used in the present embodiment has a lower oscillation threshold than typical semiconductor lasers. Thus, although the semiconductor laser 2 does heat up, the heating does not lead to thermal runaway as with the typical semiconductor laser.

The sum area of the flow restricting convex sections 11 is preferably 3.5×10⁻⁸ m² or more. When this is the case, for example, if the maximum elevation height of the elevated slider 1 is 87.5 nm or less, heat escapes from the storage medium 7 in a suitable manner; thermal runaway does not occur with the storage medium 7.

The elevated slider 1 prepared in this manner is coupled on its top to the suspension 5. The top of the slider 1 refers to the side of the slider 1 opposite the storage medium 7. The printed wiring 9 is formed in advance on the suspension 5. The printed wiring 9 connects to the semiconductor laser 2, the write head 3, and the read head 4 to drive these members. As shown in FIG. 1(a), the suspension 5 has the Si light receiving element (light receiving element) 6 which is connected to the printed wiring 9 so that the element 6 can receive light emitted from the back of the semiconductor laser 2. In the present embodiment, the light receiving element 6 is directly coupled to the suspension 5. This is however not the only possibility. Alternatively, the element 6 may be directly coupled to the light exit face on the back of the semiconductor laser 2.

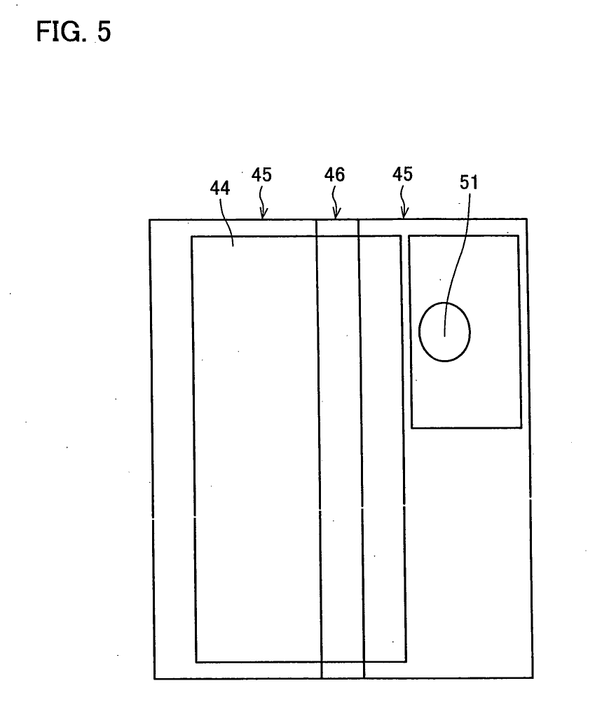

Part of the active layer (n-InGaN active layer 37) in the semiconductor laser 2 may be used as the light receiving element. Also, as shown in FIG. 5, a laser beam detecting region 51 may be provided on the ridge-flanking convex areas 45 a small distance off the ridge top 46. In the laser beam detecting region 51, the electric potential difference created between the p- and n-electrodes is detected by the active layer absorbing the radiation component of the light in the waveguide. The optical output of the semiconductor laser 2 is controlled based on the current generated by this potential difference or conducting between the electrodes. This is because no or reverse bias is placed on the laser beam detecting region 51, which depletes carriers in part of the active layer near the p-n junction. The lack of carriers enables light absorption in the internal electric field and allows produced electrons and holes to quickly spread. In other words, an electron in the valence band is excited to the conduction band by the absorption of a photon. The internal electric field generated by the layered structure forces the electron to move toward the p-layer and the hole toward the n-layer. The movement breaks the electrical neutrality of the semiconductor, creating a potential difference between the electrodes. In a macroscopic view, the p-n junction normally exists at the interface between a p-type semiconductor and a n-type semiconductor. Microscopically, the p-n junction is affected by the active electron concentration in its neighborhood, and its site is not determinate. Also, a strong internal electric field which is variable in a layer stacking direction exists at the p-n junction. In the present embodiment, the p-layer closest to the substrate is the carrier block layer 37, and the p-n junction exists in its proximity. Therefore, the active layer in the proximity refers to the active layer facing the p-layer or the active layer in its upper part. A part within the ridge may be used as the light receiving element 6.

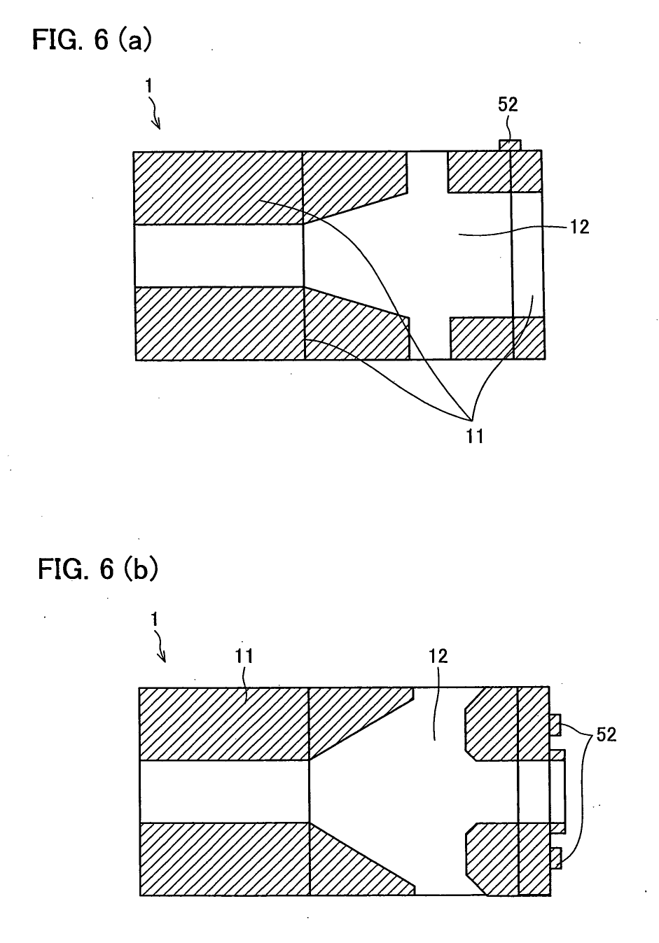

In the present read/write device, as shown in FIG. 1(a), the semiconductor laser 2 with a ridge section sits on top of the elevated slider 1. This is not the only possibility. For example, as shown in FIG. 6(a), the ridge 52 may be formed on a side of the elevated slider 1. Especially, to give the elevated slider 1 an extra length in the direction in which the disc (storage medium 7) rotates, the FIG. 1(a) structure is not suitable, because the length of the elevated slider 1 in that direction is restricted by the thickness of the substrate in epitaxial growth in the manufacture. In contrast, if the ridge 52 is formed on a side of the elevated slider 1 as shown in FIG. 6(a), the length in the disc rotation direction can be increased.

Referring to FIG. 6(b), two ridges 52 may be provided, one for heat assisted magnetic recording and the other for heat assisted magnetic reproduction.

When an edge-emitting semiconductor laser is used which has a near-field light emitting mechanism on an edge as in the present read/write device, loss other than radiation scattering by near-field emission is preferably lowered.

The present read/write device may have a microdisc structure. The microdisc structure has a high Q value, and suffers small loss other than radiation loss to the storage medium 7 due to optical tunneling effect. Further reductions in power consumption are expected.

(i) Experiment: Present Read/Write Device was Driven

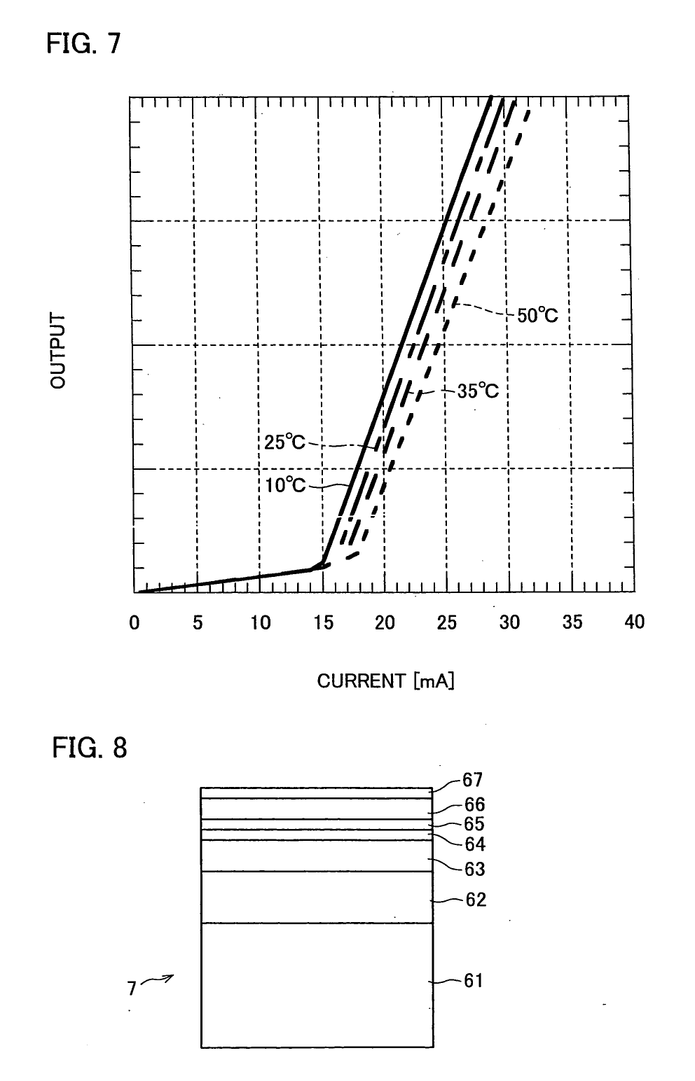

The semiconductor laser 2 fabricated as in the foregoing was driven with a pulse current. FIG. 7 shows the current-output (output power, optical output characteristics) relationship at various temperatures of the semiconductor laser 2. The semiconductor laser 2 in the present read/write device has high edge reflectance and has a low threshold value for laser oscillation. This is a feature of the laser 2. The threshold value is preferably 40 mA or less than at the highest, more preferably 30 mA or less. FIG. 7 is a graphical representation of results of experiment in which the present read/write device was driven. The resonator was 200 μm long, and the ridge was 1.5 μm wide. Referring to the figure, for example, the threshold value was about 15 mA in 25° C. air.

Next, the elevated slider 1 was elevated above the storage medium 7. Drive test was conducted at a duty ratio of 50%. The storage medium 7, as mentioned earlier, contained the 2.5-in. glass substrate 61, the second heatsink layer 62, the backing layer 63, the heat barrier layer 64, the first heatsink layer 65, the magnetic recording layer 66, and the protection film 67 (see FIG. 8). Referring to FIG. 1(b), the storage medium 7 was mounted to the pivot 8 so it rotated with the pivot 8. Results of drive test of the present read/write device thus structured show that no thermal runaway occurred and that stable operation was achieved.

Next, to examine the heat dissipation mechanism of the elevated slider 1, thermal simulation was done of the storage medium 7, the Al substrate, and the glass substrate.

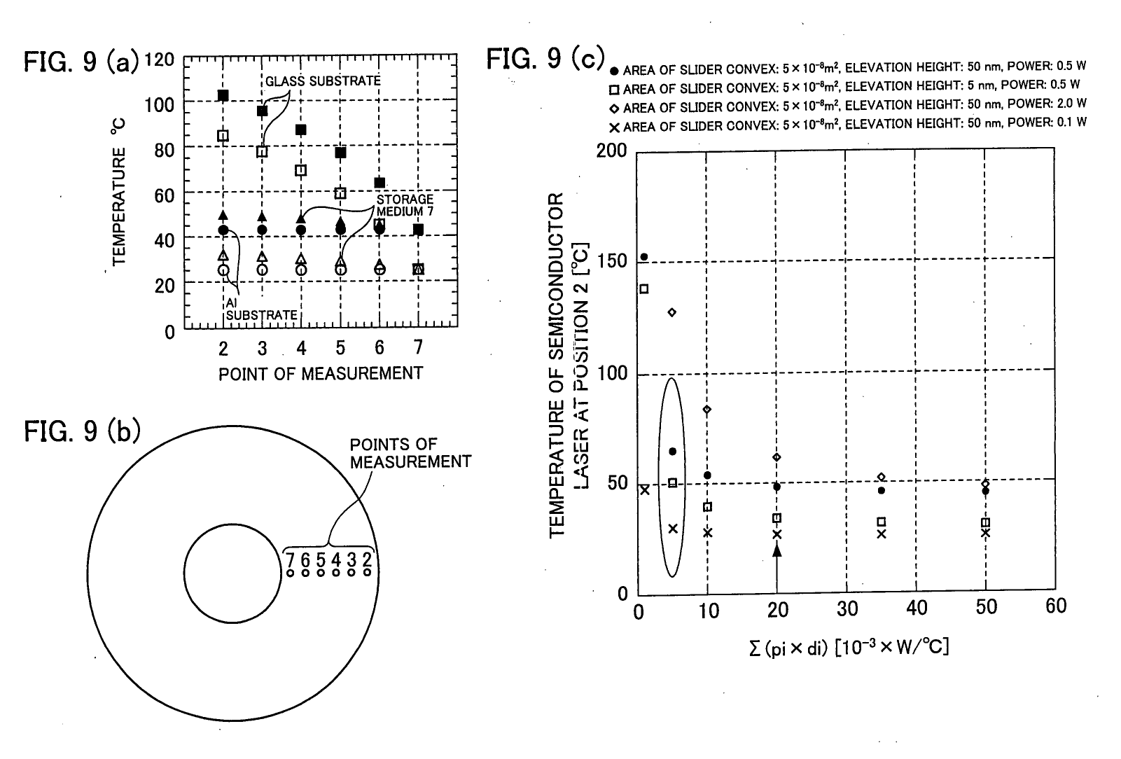

FIG. 9(a) shows results of the thermal simulation of the storage medium 7 of the present read/write device, a 2.5-in., 1-mm thick Al substrate, and a glass substrate of the same dimensions as the storage medium 7 of the present read/write device. A temperature of the pivot 8 is a fixed value. Measurement points 2 to 7 in FIG. 9(a) are shown in FIG. 9(b). The measurement points were designated with numbers in descending order, as moving from the closest point (7) to the pivot 8 away along the radius of the storage medium 7.

In FIG. 9(a), calculated results are indicated by triangles Δ, ▴ for the storage medium 7, squares □, ▪ for the glass substrate, and circles ∘, ● for the Al substrate. The shaded symbols ▴, ▪, ● indicate the temperature of the elevated slider 1 at the measurement points. The unshaded symbols Δ, □, ∘ indicate the temperature of the storage medium 7, the glass substrate, and the Al substrate at the measurement points.

Calculations for FIG. 9(a) were done for on the following conditions: The area of the flow restricting convex sections 11 of the elevated slider 1 was 5×10⁻⁸ m². The elevation height was 50 nm. The semiconductor laser 2 operated with a 0.5 W operational power. The ambient temperature was 25° C. The thermal conductivity of the storage medium 7 in a radial direction was about 20×10⁻³ W/m/° C., considering the structure of the layers.

As shown in FIG. 9(a), the simulation of the Al substrate gave a maximum temperature rise of the elevated slider 1 (semiconductor laser 2) at 18° C. and the temperature of the semiconductor laser 2 at about 43° C. The maximum temperature rise depends on the measurement points as shown in FIG. 9(a).

Therefore, it would be understood that sufficient cooling was done with the Al substrate, considering the temperature characteristics of an ordinary semiconductor laser. The ordinary semiconductor laser has a thermal resistivity of 50° C./W or less and an injection power of about 0.5 W or less; therefore, the maximum temperature rise was about 25° C.

As shown in FIG. 9(a), with the storage medium 7, the temperature of the semiconductor laser 2 at an ambient temperature of 25° C. was about 50° C. In contrast, the simulation of the glass substrate of the same dimensions as the storage medium 7 gave the temperature of the semiconductor laser 2 at about 102° C. (higher than the previous figure) and that of the glass substrate at about 85° C. Using the storage medium based on the storage medium 7 or the Al substrate in accordance with the present embodiment in this manner better limits temperature rises in the semiconductor laser 2 and the storage medium better than using an ordinary glass substrate.

FIG. 9(c) is a graphical representation of the relationship between the temperature of the semiconductor laser 2 measured at the measurement point 2 and the thermal conductivity of the storage medium 7. In FIG. 9(c), the horizontal axis is Σ(ρi×di) in 10⁻³ W/° C., or a sum of the thermal conductivity ρi times the thickness di of each layer. The storage medium 7 was supposed to be made up of multiple layers (i layers) inclusive of a substrate. The vertical axis is the temperature of the semiconductor laser 2 at the measurement point 2 on the storage medium 7. In FIG. 9(c), the shaded circle ● indicates a calculation based on the following conditions: The area of the flow restricting convex sections 11 on the bottom of the elevated slider 1 was 5×10⁻⁸ m². The elevation height was 50 nm. The injection power for the semiconductor laser 2 was 0.5 W. The shaded square (□) indicates a calculation based on the following conditions: The area of the flow restricting convex sections 11 was 5×10⁻⁸ m². The elevation height was 5 nm. The injection power for the semiconductor laser 2 was 0.5 W. The unshaded diamond ⋄ indicates a calculation based on the following conditions: The area of the flow restricting convex sections 11 was 5×10⁻⁸ m². The elevation height was 50 nm. The injection power for the semiconductor laser 2 was 2.0 W. The cross × indicates a calculation based on the following conditions: The area of the flow restricting convex sections 11 was 5×10⁻⁸ m². The elevation height was 50 nm. The injection power for the semiconductor laser 2 was 0.1 W.

As would be clear from the figure and the simulation conditions, roughly speaking, if the thermal conductivity falls about below Σ(ρi×di)=20×10⁻³ W/m/° C., the temperature of the semiconductor laser 2 rises. In other words, when the sum of the thermal conductivity times thickness of each layer in the vertical structure of the storage medium 7 becomes greater than 20×10⁻³ W/m/° C., heat readily escapes from a region of the storage medium 7 right below the elevated slider 1 to the outside of the region. This improves the thermal dissipation of the storage medium 7, which in turn reduces the temperature of the elevated slider 1 and the semiconductor laser 2. Therefore, the sum of the thermal conductivity times thickness of each layer in the storage medium 7 preferably exceeds 20×10⁻³ W/m/° C.

As indicated by crosses x in FIG. 9(c), when the injection power for the semiconductor laser 2 was 0.1 W, if the thermal conductivity fell about below Σ(ρi×di)=5×10⁻³ W/° C., the temperature of the semiconductor laser 2 rose. Therefore, it is preferable to increase the sum of the thermal conductivity times thickness of each layer in the storage medium 7 in excess of 5×10⁻³ W/° C. if the 0.1 W injection power for the semiconductor laser 2 is available. That injection power could be achieved, for example, by improvements in the drive method.

In contrast, as indicated by unshaded squares □, even at an injection power of 0.5 W, the temperature of the elevated slider 1 in the 25° C. air was about 50° C. at Σ(ρi×di)=5×10⁻³ W/° C. due to the lowered elevation height of the elevated slider 1 to 5 nm. As could be seen from this, either the injection power for the semiconductor laser 2 or the elevation height needs be low if the sum of the thermal conductivity times thickness of each layer is 5×10⁻³ W/° C. It is thus preferable to set the injection power for the semiconductor laser 2 to 0.5 W or less and the elevation height of the elevated slider 1 to 50 nm or less.

It is also preferable to set the thermal conductivity times thickness of the second heatsink layer 62 greater than the thermal conductivity times thickness of the substrate in the storage medium 7. For example, supposing that the thickness of the glass substrate 61 in the storage medium 7 is 0.6 mm, the thermal conductivity times thickness of the glass substrate 61 is 1.38 W/m/° C. ×0.6 mm=0.83×10⁻³ W/° C., which indicates a thermal runaway. To prevent the glass substrate 61 from developing thermal runaway, it is preferable to set the thermal conductivity times thickness of the second heatsink layer 62 greater than the thermal conductivity times thickness of the glass substrate 61. This setting enables the second heatsink layer 62 to help heat escape from the storage medium 7. Heat effectively dissipates from the storage medium 7.

When the second heatsink layer 62 is made of an Al film, the thermal conductivity times thickness of the second heatsink layer 62 is 237×10×10⁻⁹=2.4×10⁻⁶ W/° C. for a layer thickness of 10 nm and 2.4×10⁻³ W/° C. for a layer thickness of 10 μm. Note that the thermal conductivity of the Al is 237 W/m/° C. Therefore, when the thickness of the glass substrate 61 in the storage medium 7 is 0.6 mm, heat effectively dissipates from the storage medium 7 if the layer thickness of the second heatsink layer 62 made of an Al film is about 10 μm or more. To describe it in more detail, it is preferable to set the layer thickness of the second heatsink layer 62 to 3.5 μm or more based on 237×3.5×10⁻⁶≈0.83×10⁻³ W/° C.

When the second heatsink layer 62 is made of a Au film, it is preferable to set the layer thickness to 2.7 μm or more, because the thermal conductivity of Au is 315 W/m/° C. When the second heatsink layer 62 is made of a Ag film, it is preferable to set the layer thickness to 2.0 μm or more, because the thermal conductivity of Ag is 427 W/m/° C. When the second heatsink layer 62 is made of a Cu film, it is preferable to set the layer thickness to 2.1 μm or more, because the thermal conductivity of Cu is 398 W/m/° C. Further, for example, when the second heatsink layer 62 is made of a substance with a thermal conductivity of 100 W/m/° C., it is preferable if the layer thickness of the second heatsink layer 62 is 8.3 μm or more. Therefore, it is preferable to use a substance with a thermal conductivity of 100 W/m/° C. or more and a layer thickness of 10 μm or more as the second heatsink layer 62.

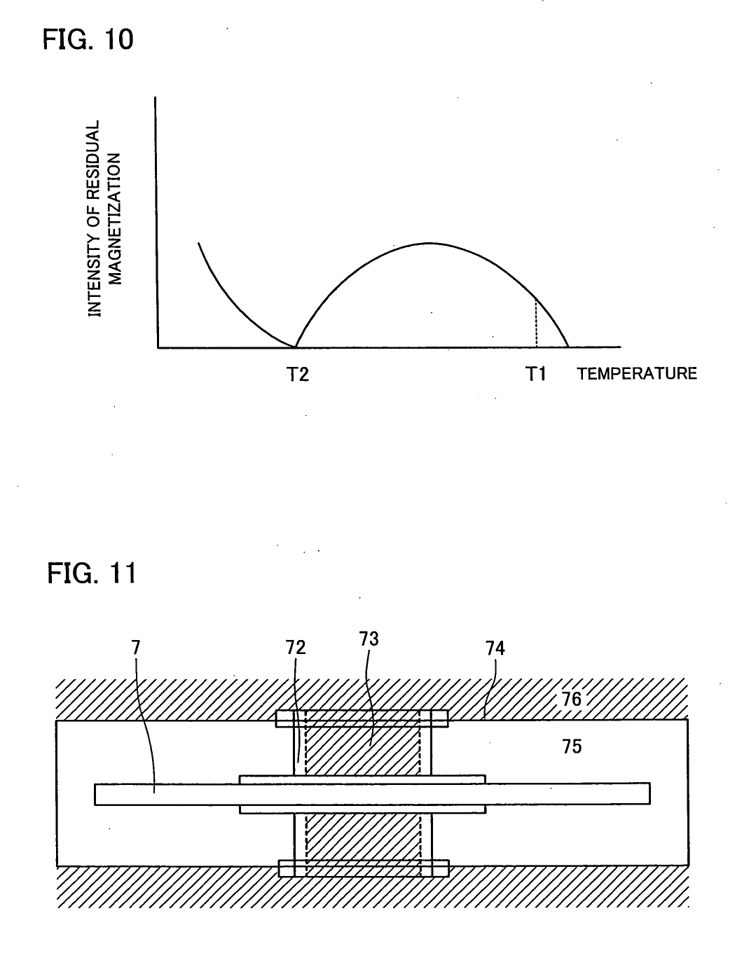

From FIG. 9(a), it would be understood that temperature of the storage medium 7 varies depending on the position in the radial direction of the storage medium 7. In other words, in some parts of the storage medium 7, there occurs a discrepancy of the temperature of the storage medium 7 in those parts from the magnetic compensation temperature. It would also be understood that great variations in temperature of the storage medium 7 in the radial direction of the storage medium 7 occurs in the glass substrate. The relationship between the temperature and residual magnetization of the storage medium 7 is illustrated in FIG. 10 where T2 is the magnetic compensation temperature, and T1 is either the magnetic recording temperature or the magnetic reading temperature.

As would be clear from the figure, it is desirable if the temperature outside the recording region needs be close to the magnetic compensation temperature T2, and the temperature of the magnetic recording region is equal to the magnetic recording temperature T1. However, when the optical output from the semiconductor laser 2 is constant, if a great heat distribution occurs as in the glass substrate, the temperature of the magnetic recording region differs greatly from the magnetic recording temperature T1. Therefore, especially when a low thermal conductivity substrate like glass is used, it is preferable to provide the high thermal conductivity second heatsink layer 62 as in the present embodiment. The provision alleviates the problem of large discrepancies of the temperature of the magnetic recording region from the magnetic recording temperature T1. In other words, in the storage medium 7, the second heatsink layer 62 reduces heat distribution in the storage medium 7 during a magnetic recording and reading, which prevents the S/N ratio from falling. The second heatsink layer 62 is preferably formed of a high thermal conductivity film (for example, 100 Wm/° C. or more). The second heatsink layer 62 preferably has an increased thickness for a larger heat conducting area (for example, 10 μm or more).

As described in the foregoing, the semiconductor laser 2 in the present read/write device is an edge-emitting semiconductor laser. On one of its edges opposite the storage medium 7 is there provided a tiny aperture 24 which produces near-field light. In the present read/write device, the other edge of the semiconductor laser 2 has a high reflection film attached to it to limit loss other than radiation loss through the tiny aperture 24, that is, edge loss. The structure limits scattering of light other than the heating of the recording region, thereby lowering the threshold current. This in turn reduces the power consumption of the semiconductor laser 2 and prevents rises in the temperature of the elevated slider 1.

The semiconductor laser 2 in the present read/write device is a so-called VSAL (very small aperture laser) which produces near-field light through a tiny aperture 24 on an edge. Near-field light may be produced by another method. When this is the case, the threshold current can be decreased by lowering loss other than radiation scattering by near-field light. This allows for reductions in the power consumption of the semiconductor laser 2, thereby preventing rises in the temperature of the elevated slider 1.

If the present read/write device has a microdisc structure, the loss other than radiation loss by the optical tunneling effect to the storage medium 7 is low, because the microdisc structure has a high Q. This further reduces the power consumption of the semiconductor laser 2 and prevents rises in the temperature of the elevated slider 1.

The elevation height of the elevated slider 1 in the present read/write device over the storage medium 7 during operation (a recording or a reading) is set to 0 nm to 100 nm. This elevation height setting causes effective conduction of heat generated by heat sources, such as the semiconductor laser 2 or the magnetic heads (write head 3 and read head 4), in the elevated slider 1 to the storage medium 7. This limits rises in the temperature of the elevated slider 1. In other words, Heat generated by the semiconductor laser 2 and the magnetic heads during heat assisted magnetic recording/reproduction can be effectively dissipated to the outside via the storage medium 7. Malfunction is limited. Stable drive becomes possible.

The elevated slider 1 in the present read/write device has the flow restricting convex sections 11 and the flow restricting concave section 12 on the bottom of the slider 1 opposite the storage medium 7. This optimization of the shape of the bottom of the elevated slider 1 encourages the heat generated by the semiconductor laser 2 and the magnetic heads to transfer from the elevated slider 1 to the storage medium 7. The heat then is effectively dissipated to the outside through the storage medium 7. Malfunction is limited. Stable drive becomes possible. When this is the case, the improved thermal conduction from the elevated slider 1 to the storage medium 7 allows the storage medium 7 to play the role as a heatsink. It becomes possible to increase the thermal dissipation property of the storage medium 7 as a heatsink and to drive the semiconductor laser 2 in a stable manner by limiting rises in the temperature of the storage medium 7.

For example, when the bottom of the elevated slider 1 has a concave convex section for elevating the elevated slider 1 in a stable manner, a sufficient thermal conduction cannot be in some cases obtained between the elevated slider 1 and the storage medium 7. Therefore, it is preferable if the area (shape) oft the bottom of the elevated slider 1 and the elevation height of the elevated slider 1, that is, the distance between the elevated slider 1 and the storage medium 7, satisfies the following relationship. This relationship stabilizes the slider elevation, hence the thermal conduction between the elevated slider 1 and the storage medium 7. In addition, a sufficient thermal conduction is achieved between the elevated slider 1 and the storage medium 7.

If the semiconductor laser 2 is formed integral with the elevated slider 1, it is preferable if the following relationship holds:

$${\int }_{S} \frac{1}{L} ⅆ s \geq 0.4 [ m ]$$

where ds is the area of a small region of the bottom of the elevated slider 1, L(s) is the distance separating the small region from the storage medium 7, and S is the sum area of the bottom of the elevated slider 1.

In addition, if the bottom of the elevated slider 1 has, for example, the flow restricting convex sections 11, the sum area of the flow restricting convex sections 11 is preferably more than or equal to 3.5×10⁻⁸ m².

In the present read/write device, the elevated slider 1 may be joined by solder, etc. in the semiconductor laser 2. When this is the case, the thermal resistivity of the solder between the elevated slider 1 and the semiconductor laser 2 is about 10° C./W. Therefore, it is preferable if the following relationship holds:

$${\int }_{S} \frac{1}{L} ⅆ s \geq 0.5 [ m ]$$

where ds is the area of a small region of the bottom of the elevated slider 1, L(s) is the distance separating that small bottom (small region) from the storage medium 7, and S is the sum area of the bottom of the elevated slider 1. This limits rises in the temperature of the semiconductor laser 2 in a suitable manner.

If the semiconductor laser 2 is joined to the elevated slider 1 with solder, etc., and the elevated slider 1 has on its bottom, for example, flow restricting convex sections 11, the sum area of the flow restricting convex sections 11 is preferably more than or equal to 3.5×10⁻⁸ m².

When the semiconductor laser 2 is joined to the elevated slider 1 with solder, etc. it is preferable to consider thermal conduction from the light-emitting layer to the elevated slider 1.

In other words, when the semiconductor laser 2 has been grown on the substrate to achieve “junction up” with respect to the elevated slider 1 (the junction face facing the substrate), it is preferable to form the substrate of the semiconductor laser 2 of a high conduction material. For example, when the light-emitting layer is a nitride semiconductor, it is preferable to use a GaN substrate, an AlGaN substrate, or an AlN substrate. When the substrate is formed of a low conduction material, such as sapphire, it is preferable to make the substrate as thin as possible. For example, polishing down to 50 μm to 100 μm is preferable. In the case of “junction down” (epi surface (epitaxial growth surface) is the junction face), the substrate in the semiconductor laser 2 may be formed of any material.

The storage medium 7 in the present read/write device has the second heatsink layer 62, the backing layer 63, the heat barrier layer 64, the first heatsink layer 65, the magnetic recording layer 66, and the protection film 67 on the glass substrate 61. This provision of the second heatsink layer 62 in the storage medium 7 allows for increases in the sum of the thermal conductivity times thickness of each layer in the vertical structure of the storage medium 7. The sum of the thermal conductivity times thickness is preferably in excess of 5×10⁻³ W/(m·° C.), and more preferably in excess of 20×10⁻³ W/(m·° C.) as mentioned earlier. These increases in the sum of the thermal conductivity times thickness of each layer in the vertical structure of the substrate allows for better thermal transfer out of the area of the storage medium 7 right below the elevated slider 1. The thermal dissipation property of the storage medium 7 is improved.

In the heat assisted magnetic recording/reproduction scheme, it is preferable if the rate of temperature changes (temperature change rate) is large in recording regions. To increase the temperature change rate, it is preferable to improve thermal dissipation from the recording layer to the adjacent layer; however, if the thermal dissipation from the recording layer to the adjacent layer is improved, the semiconductor laser 2 needs to produce high output to raise the temperature of the recording region. Therefore, to set the output of the semiconductor laser 2 to a suitable value, the thermal conductivity of the recording layer and the adjacent layer needs adjusted in a suitable manner.

The temperature raising process for the recording region is a transient response like a single pulse that accompanies the rotation of the storage medium 7. In other words, the rotation of the storage medium 7 moves the recording regions on the storage medium 7 relative to the elevated slider 1. When this is the case, the temperature of the region of the storage medium 7 under the laser spot of the semiconductor laser 2 raises it temperature like a pulse. Before heat flow in the storage medium 7 reaches a steady state, the region moves out of the laser spot and returns to its initial state prior to the irradiation with the laser beam. In contrast, heat flow from the elevated slider 1 to the storage medium 7 is a steady response. This steady response can be considered in terms of the sum of the thermal conductivity times thickness of each layer in the vertical structure of the storage medium 7.

In the storage medium 7 in the present read/write device, a cheap glass substrate is used to cut down the cost. In other words, the glass substrate is cheap, and allows for reductions in the cost of the information read/write device of the heat assisted magnetic recording/reproduction scheme. However, the glass substrate has a problem of low thermal conductivity.

In the heat assisted magnetic recording/reproduction scheme, as mentioned earlier, the rate of temperature changes (temperature change rate) in the recording region is preferably large. To achieve such temperature characteristics of the recording region, it is conventionally suggested to provide a high thermal conductivity thin film of Al, Ag, etc. as thin as a few nm to 1 μm as the first heatsink layer under the recording layer.

Nevertheless, if the first heatsink layer is too thick, the rises in the temperature of the recording region are insufficient, and the heat assisted magnetic recording/reproduction becomes difficult. Therefore, in the storage medium 7, to dissipate heat from the elevated slider 1 to the storage medium 7 in a steady manner, the temperature barrier layer (heat barrier layer 64) is provided of low thermal conductivity layer under the first heatsink layer 65. The second heatsink layer 62 is provided between this heat barrier layer 64 and the glass substrate 61. The second heatsink layer 62 is a high thermal conductivity film of Al, Ag, etc. and has a thickness of 10 μm or more. The second heatsink layer 62 may be in contact with the heat barrier layer 64 or the glass substrate 61. If the heat assisted magnetic recording/reproduction scheme uses only one side of the glass substrate 61, the layer 62 may be formed on the back of the glass substrate 61.

When the substrate in the storage medium 7 is formed of a high thermal conductivity material, such as sapphire and Al, a steady heat response can be sufficiently achieved with respect to a heat flow from the elevated slider 1 to the storage medium 7. Therefore, to achieve a transient response characteristic in the temperature raising process for the recording region, it is sufficient to provide the first heatsink layer 65 and the heat barrier layer 64.

When the storage medium 7 is of a perpendicular magnetic scheme and has the backing layer 63 which has a low thermal conductivity, the backing layer 63 can be rendered to function as part or the entirety of the heat barrier layer 64. When the backing layer 63 has a high thermal conductivity, the backing layer 63 can be rendered to function as part or the entirety of the second heatsink layer 62. The backing layer 63 may be provided separately from the two layers. In other words, the backing layer 63 may be formed where it is not next to the heat barrier layer 64 or the second heatsink layer 62. In addition, another layer (for example, a buffer material layer) may be provided, where necessary, in addition to the layers. When this is the case, the other layer may be provided at the position of any of the layers.

To improve the thermal dissipation property of the storage medium 7, it is preferable to encourage heat dissipation from the storage medium 7 to the outside of the housing containing the present read/write device. For example, it is preferable if a mechanism (heat dissipation mechanism) is included which encourages heat dissipation from the pivot 8 of the storage medium 7 which is in thermal contact with the storage medium 7 to the outside of the housing.

To encourage heat dissipation from the pivot 8 to the outside of the housing, for example, the structure of the pivot 8 of the storage medium 7 in the present read/write device may be altered to that of a pivot 72 shown in FIG. 11. FIG. 11 is a cross-sectional view illustrating a variation of the pivot 8 for inclusion in the present read/write device. As shown in the figure, the pivot 72 has a structure like a cylinder with a hollow site 73. The top and bottom of the pivot 72 are rotatably supported by the housing 74. The disc-like storage medium 7 is attached to the pivot 72. Using the pivot 72 structured in this manner enables heat generated by the semiconductor laser 2 to dissipate through air 75 inside the housing, the storage medium 7, the pivot 72, the hollow site (hollow structure) 73, and the housing 74 to external air 76. In other words, the pivot 72 can be rendered to function as a heat dissipation mechanism.

In the present read/write device of the heat assisted magnetic recording/reproduction scheme, normally, the storage medium is substantially hermetically enclosed in the housing, making it difficult to exchange air external to the housing and inside the housing. Therefore, the ambient temperature inside the housing rises with rises in the temperature of the storage medium. The heat transfer from the storage medium surface to the air inside the housing is relatively small when compared with the amount of heat generated by the semiconductor laser. The heat transferred from the semiconductor laser to the storage medium is therefore difficult to dissipate, leading to rises in the temperature of the storage medium.

In contrast, using the pivot 72 enables effective dissipation of the heat generated by the semiconductor laser 2 to the external air 76 through the storage medium 7, the pivot 72, the hollow site 73, and the housing 74. In other words, the pivot 72 can be rendered to function as a heat conduction mechanism to the outside of the housing 74. In the structure in FIG. 11, the hollow site 73 of the pivot 72 can contact the external air 76, allowing heat dissipation from the hollow site 73 to the external air 76.

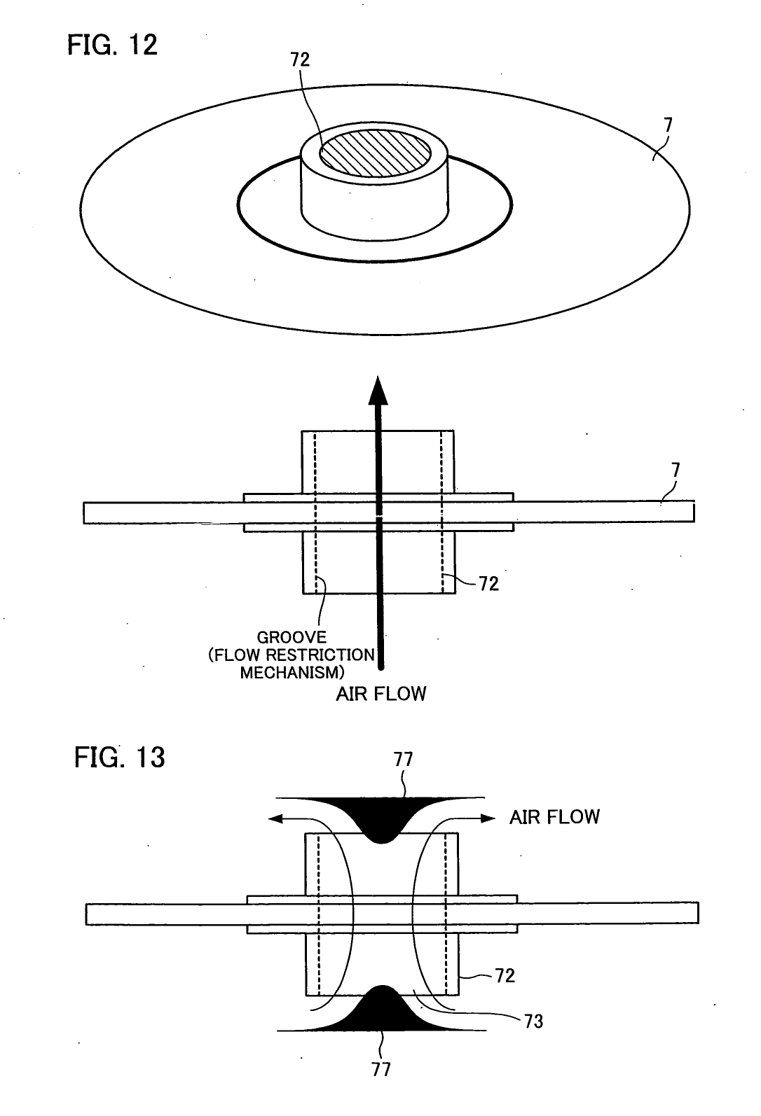

In place of the pivot 72, a rotational center site (pivot) 72 may be used as shown in FIG. 12. The site 72 includes a flow restriction mechanism, for example, a groove, which restricts air flow in the hollow site 73 on the internal surface of the pivot 72 (facing the hollow site 73). It is preferable to provide the flow restriction mechanism so that an air flow in one direction occurs with the rotation of the storage medium 7. This effectively dissipates heat generated by the semiconductor laser 2 to the external air. In addition, the pivot 72 has an increased heat conducting area on its internal surface. This further improves heat dissipation effects.

The flow restriction mechanism is not limited to the groove. For example, a fan may be provided. Other existing technology is also suitable for use.

In addition, as shown in FIG. 13, a flow restriction mechanism 77 with a smoothly protruding shape toward the hollow site 73 in the pivot 72 may be provided either or both above and below the pivot 72. In other words, a flow restriction mechanism 77 for restricting air flow in the hollow site 73 may be provided to the aperture for the external air of the hollow site 73. The provision of the flow restriction mechanism 77 forces part of the air flow to move along the housing 74. This encourages heat dissipation from the surface of the housing 74 to the external air 76. In addition, when this is the case, the housing 74 may be provided with a separate heatsink. This further encourages heat dissipation from the housing surface, which lowers overall temperature of the housing 74. In addition, with the provision of the flow restriction mechanism 77, air flow is hardly disrupted even if, for example, there is only a narrow gap separating from an adjacent component. Heat dissipation of the storage medium 7 is encouraged. The structure in FIG. 11 or the structure in FIG. 12 may be combined with the structure in FIG. 13 where suitable. In the structure in FIG. 13, the flow restriction mechanism 77 is provided to the aperture for the external air of the hollow site 73; alternatively, a flow restriction mechanism for restricting air flow in the hollow site 73 may be provided in the hollow site 73.

In the heat assisted magnetic recording/reproduction scheme using this pivot 72 with a hollow, the motor (pivot drive means) connected to the pivot 72 is such that the motor mechanism is either separate from or integral with the information record device (present read/write device) and the pivot 72.

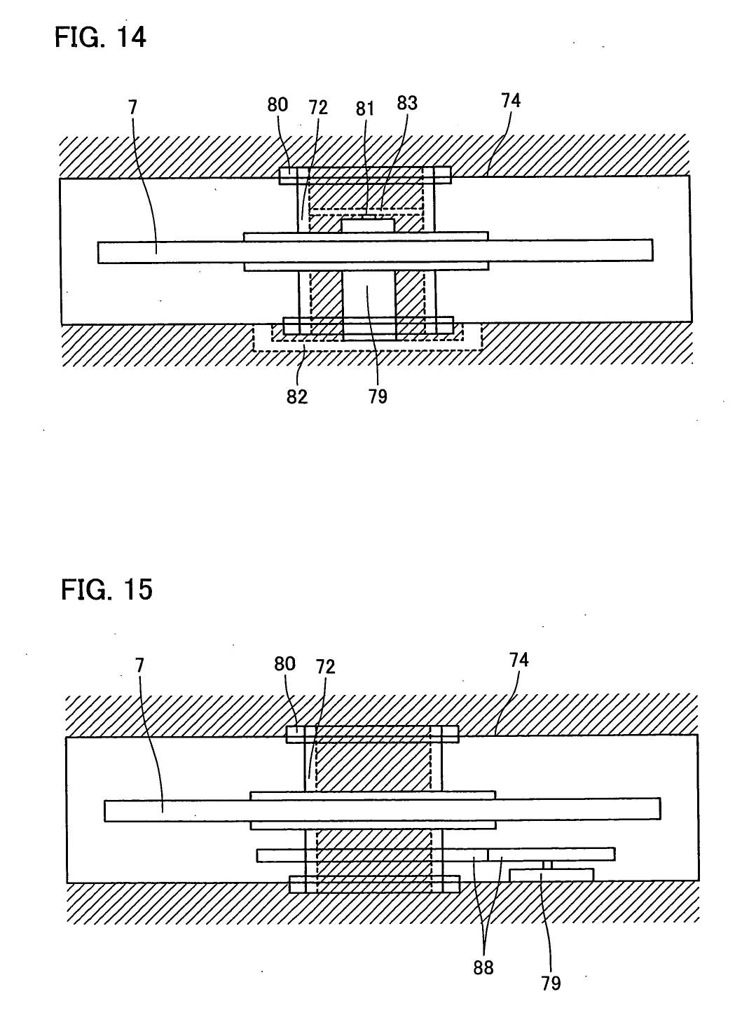

In the separate scheme, for example, as shown in FIG. 14, a compact motor 79 may be provided inside the pivot 72. As shown in the figure, in the case of the motor 79, a bar 82 connects to the present read/write device, and the motor axis 81 is connected by the bar 83 to the pivot 72. This enables the rotational action of the pivot 72 and the storage medium 7 by driving the motor 79. The motor axis 81 may be connected to the pivot 72 by, variable speed gears. The pivot 72 is rotatably supported by bearings 80.

As shown in FIG. 15, the motor 79 may be provided outside the pivot 72 and connected via power transfer means, such as gears 88 and a belt. The structure of the motor is not limited to those in FIG. 14 and FIG. 15. Existing technology which function as a motor may be used where suitable.

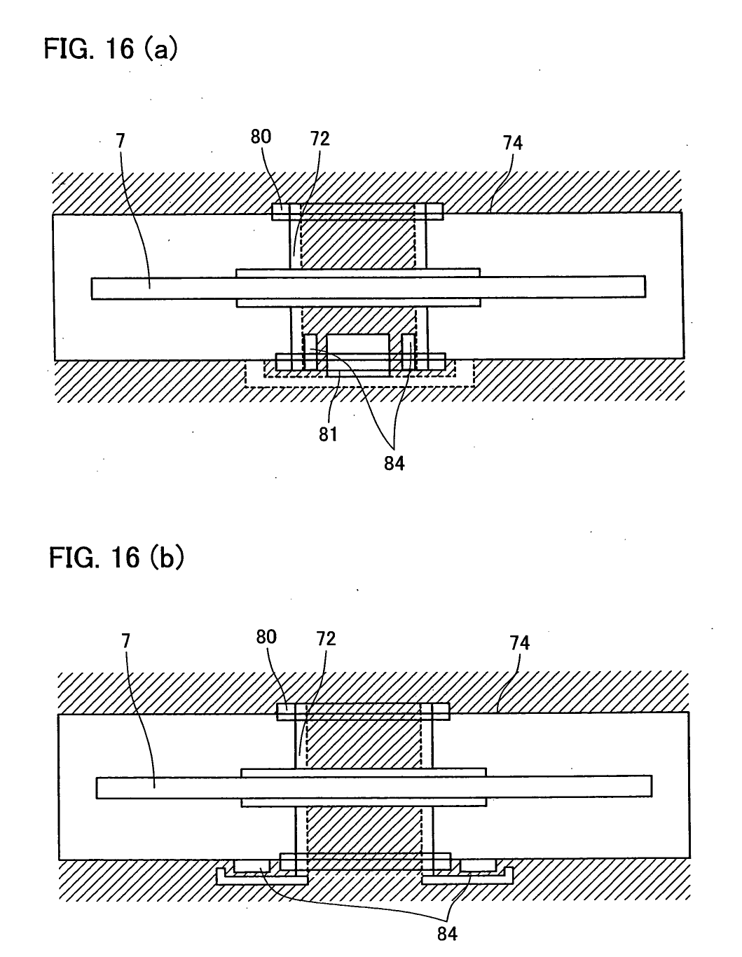

In an integral scheme where the motor mechanism is integral with the present read/write device and the pivot 72, for example, the structure shown in FIG. 16(a) may be adopted. In the structure in the figure, the pivot 72 doubles as a motor casing. Inside the pivot 72 is attached a permanent magnet 84, the motor axis 81 is connected to the housing 74. This enables the pivot 72 and the storage medium 7 to rotate. The structure of the motor is not limited to that in FIG. 16(a). Existing technology which function as a motor may be used where suitable. In other words, it is sufficient if part of the pivot is the site forming the motor casing.

For example, the structure shown in FIG. 16(b) may be adopted. In the structure in the figure, the motor axis 81, a part of the motor, doubles as the pivot 72. In the scheme where the motor axis 81 which is a part of the motor doubles as the pivot 72 in this manner, the hollow region 73 in the pivot 72 can be secured, which is very effective in cooling the pivot 72 in air. The sites forming the motor can be readily shielded. The motor can be protected from developing defects due to incoming external dust, etc.

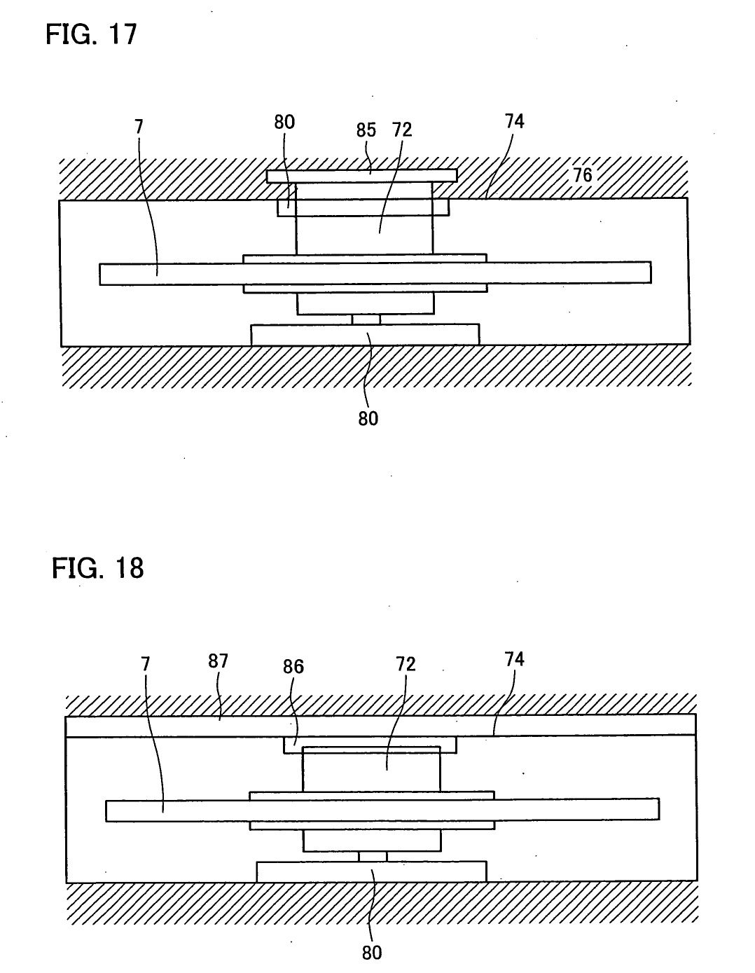

The structure of the present read/write device may be like the structure shown in FIG. 17, for example. In the structure shown in the figure, at least one of the ends of the pivot 72 protrudes outside the housing 74 to come in contact with the external air 76. This improves heat dissipation effect from the pivot 72 to the external air 76. In the structure shown in the figure, a disc-like heatsink site 85 is provided at an end of the pivot 72. This enables heat dissipation from the storage medium 7 to the heatsink site 85 through the pivot 72, encouraging heat dissipation. The heatsink site 85 may have a protrusion, etc. This adds to the heat conducting area, further improving heat dissipation heat effect.

Heat flows into the storage medium 7 right below the elevated slider 1 and leaves through the heat dissipation mechanism. In the flow, heat distribution is likely to occur primarily in radial directions of the storage medium 7, which is rotating at high speeds. In the mechanism where heat dissipates through the pivot 72, if the storage medium 7 has poor heat conductance, heat distribution in the radial directions increases. The increased heat distribution in the radial directions may result in, for example, a discrepancy in magnetic compensation temperature, which is not desirable. In other words, in the heat assisted magnetic reproduction scheme, the S/N ratio is improved by specifying the temperature in the region, outside the recording region, which can be magnetically detected to be a magnetic compensation temperature. The increased heat distribution in the radial directions may cause a discrepancy between the temperature outside the recording region and the magnetic compensate point (magnetic compensation temperature) in some parts and degrade the S/N ratio. Accordingly, the shape of the heatsink may be adapted so as to decrease the temperature distribution (heat distribution) in the radial directions of the storage medium 7. This gives stable S/N ratios regardless where position of the recording region.

The structure of the present read/write device may be like the structure shown in FIG. 18, for example. In the structure shown in FIG. 18, the pivot 72 is provided inside the housing 74. An end of the pivot 72 is supported by a fluid axis support 86. Using a high thermal conductivity material as the liquid inside the fluid axis support 86 in the structure enables effective heat dissipation from the pivot 72 to the housing 74 or the heatsink 87 provided to the housing 74.

[Embodiment 2] AlTiC Slider

Another embodiment of the present invention will be discussed with reference to figures. By the way, members of the read/write device and manufacturing method described in Embodiment 1 are given the same numbers, so that the descriptions are omitted for the sake of convenience.

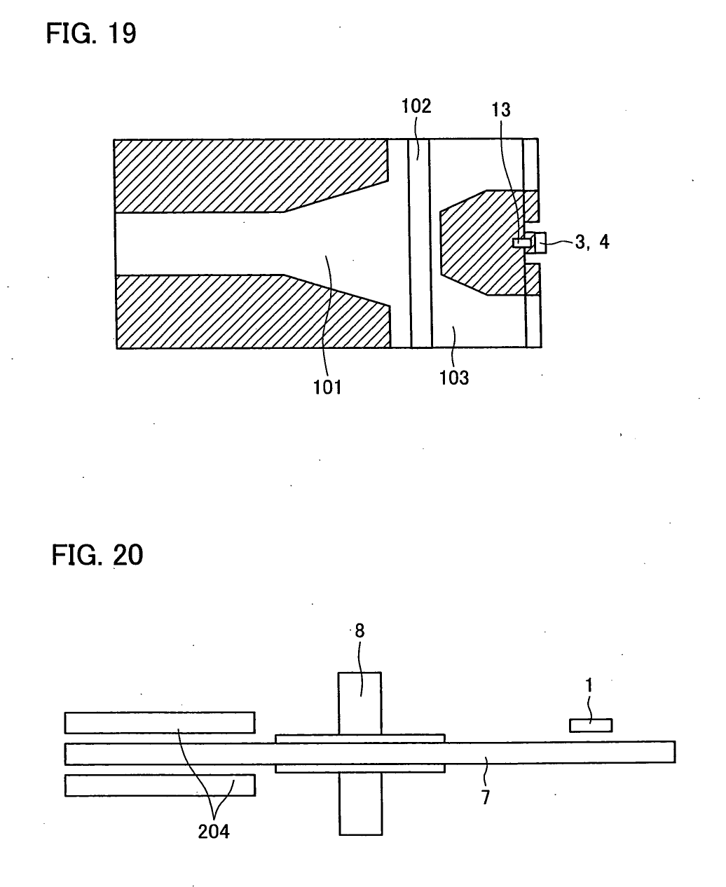

FIG. 19 is a plan view showing a side of an elevated slider 101 opposite to a storage medium 7 and a side of a semiconductor laser 103 opposite to the storage medium 7, the elevated slider 101 and the semiconductor laser 103 being provided in a read/write device of the present embodiment. As the figure shows, the read/write device of the present embodiment is arranged in such a manner that a nitride semiconductor laser (semiconductor laser) 103 is joined to an AlTiC slider (elevated slider) 101 made of AlTiC, with solder 102. It is noted that the read/write device of the present embodiment is identical with the read/write device in Embodiment 1, except that the material and shape of the elevated slider are altered and the semiconductor laser 103 is joined to the elevated slider. Furthermore, apart from the manufacture of the elevated slider 1 and the step of joining the elevated slider 1 with the semiconductor laser 2, the manufacturing method of the present embodiment is identical with that of Embodiment 1.

A method of manufacturing the elevated slider 101 is discussed. As described above, the elevated slider 101 and the elevated slider 101 of Embodiment 1 are manufactured in a similar manner, except the following alterations: first, Ti/Pt is metalized on an AlTiC substrate, then an Sn film 1 through 3 μm thick is formed on the Pt by plating.

Then Mo/Pt/Au is formed on an n-electrode (Hf/Al) of the semiconductor laser 103 formed in the same manner as the semiconductor laser 2 of Embodiment 1. The metalized surface of the AlTiC substrate is joined to the n-electrode surface of the semiconductor laser 103, at a temperature of about 280° C. With this, Sn and Au are combined and brought into a compound (solder 102), so that these wafers are firmly joined to each other.

Subsequently, a write head 3 and a read head 4 are formed in the same manner as Embodiment 1. These magnetic heads (write head 3 and read head 4) are then coated with wax, and joined to a dummy AlTiC substrate that is as thick as the aforesaid AlTiC substrate, while heating the dummy substrate. Note that a melting point of the wax is preferably below the temperature at which the magnetic heads are fabricated. The dummy AlTiC substrate is provided for effectively flattening the edge of the semiconductor laser in the next step.

Next, as in Embodiment 1, the wafer is divided into bars by dicing and polishing. The steps similar to those in Embodiment 1 are suitably carried out, and the elevated slider 101 being thus fabricated is heated so that the wax and the dummy AlTiC substrate are removed. As a result, the elevated slider 101 shown in FIG. 19, which is joined with the semiconductor laser 102, is manufactured.

The above-described read/write device, which is manufactured by joining the elevated slider 101 with the semiconductor laser 103 and adopts the heat assisted magnetic recording/reproduction scheme, can be driven in the same manner as Embodiment 1.

It is noted that, the flow restricting convexes/concave may be formed on the bottom of the elevated slider 101, as with Embodiment 1. The elevation height of the elevated slider 101 preferably falls within the range between 0 and 100 nm, as with Embodiment 1. It is also noted that the members of the read/write device of the present embodiment are compatible with the corresponding members described in Embodiment 1.

[Embodiment 3] Heatsink

A further embodiment of the present invention will be discussed in reference to figures. As with Embodiments 1 and 2, a read/write device of the present embodiment uses a semiconductor laser and adopts the heat assisted magnetic recording/reproduction scheme. This read/write device of the present embodiment is identical with those described in Embodiments 1 and 2, except that a heatsink for uniforming the heat distribution of the storage medium is further provided. On this account, members of the read/write device and manufacturing methods described in Embodiments 1 and 2 are given the same numbers, so that the descriptions are omitted for the sake of convenience.

FIG. 20 is a schematic cross section of a major part of the read/write device of the present embodiment. As shown in this figure, the read/write device of the present embodiment is provided with a heatsink 204 that sandwiches a storage medium 7, is in parallel to the storage medium 7, and is not in contact with the storage medium 7. This heatsink 204 is either connected to a housing (not illustrated) or in contact with the external air beyond the housing, thereby dissipating, to the outside of the housing, heat conducted from the storage medium 7.

In Embodiments 1 and 2, the heat distribution of the storage medium 7 is uniformed by adopting a suitable storage medium, i.e., a storage medium in which the sum of the thermal conductivity times thickness is large. However, even if such a storage medium is adopted, the irregularity of the heat distribution still exists. In the present embodiment, the irregularity of the heat distribution of the storage medium 7 is further uniformed by the heatsink 204 that is in parallel to and not in contact with the storage medium 7. In other words, the heatsink 204 facilitates heat dissipation from the storage medium 7 and reduces the heat distribution of the storage medium 7.

With this, it is possible to moderate such a problem that the temperature of the magnetic recording region differs greatly from the magnetic recording temperature T1. In other words heat distribution in the storage medium 7 during a magnetic recording and reading is reduced, so that the S/N ratio is prevented from falling.

The distance between the heatsink 204 and the storage medium 7 is preferably narrow, e.g. not more than 5 mm. When the distance falls within this range, the storage medium 7 can directly precipitate heat to the heatsink 204, and hence heat dissipation is effectively carried out. In particular, when the sum of the thermal conductivity times thickness is poor (small), the heatsink 204 being thus described effectively facilitates the heat dissipation from the storage medium 7.

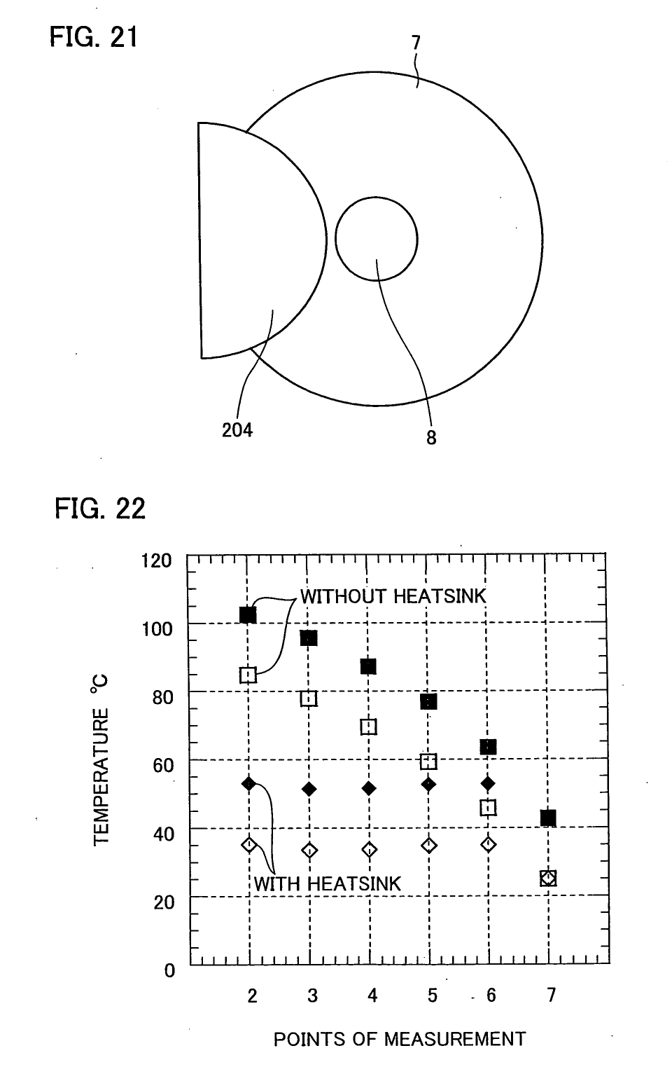

In FIG. 20, the heatsink 204 sandwiches the storage medium 7. There are, however, no limitations on the structure of the heatsink 204. The heatsink 204 may be provided so as to face only one side of the storage medium 7, as a plan view in FIG. 21 when viewed from the top surface of the storage medium 7 shows. In this manner, the heat distribution of the storage medium 7 is reduced also when the flat heatsink (heatsink) 204 is provided so as to face only one side of the storage medium (disk) 7.

In the arrangement of FIG. 21, the heatsink 204 covers several tens of percent of one surface of the storage medium 7. The larger that area on the storage medium 7 which is covered with the heatsink 204, the more the heat dissipation from the storage medium 7 to the heatsink 204 is facilitated.

FIG. 22 is a graphical representation of results of the simulation performed on condition that a heatsink 204 is provided on both sides of a glass substrate (storage medium) which is sized identical with the storage medium 7, the heatsink 204 covers 50 percent of one side of the glass substrate, and the distance between the heatsink 204 and the glass substrate is 2 mm. The graphical representation in this figure shows a CHANGE of the heat distribution of the glass substrate, and the conditions of the simulation other than the above are identical with that of the simulation illustrated in FIG. 9(a). In other words, FIG. 22 is results of the thermal simulation in a case where a temperature of the pivot 8 is a fixed value. Measurement points 2 to 7 correspond to those in FIG. 9(b). Calculations for FIG. 22 were done on the following conditions: The area of the flow restricting convex sections 11 of the elevated slider 1 was 5×10⁻⁸ m². The elevation height was 50 nm. The semiconductor laser 2 operated with a 0.5 W operational power. The ambient temperature was 25° C.

In FIG. 22, squares □ and ▪ indicate a case where the heatsink is not provided, while ⋄ and ♦ indicate a case where the heatsink is provided. The shaded symbols ▪ and ♦ indicate the temperature of the elevated slider 1 at the measurement points. The unshaded symbols □ and ⋄ indicate the temperature of the glass substrate at the measurement points. Note that the results (□, ▪) of the simulation without the heatsink in FIG. 22 are identical with the results of the simulation of the glass substrate in FIG. 9(a).

As shown in FIG. 22, in the calculation results in the case where the heatsink is provided, the temperature distribution of the storage medium (glass substrate) is reduced at the lower part of the elevated slider 1, as compared to the calculation results in the case where the heatsink is not provided. Furthermore, in the calculation results in the case where the heatsink is provided, a temperature of the semiconductor laser 2 is reduced at the measurement point 2 on the outermost part of the storage medium.

As the simulation results clearly illustrate, the temperature rises in the storage medium 7 and the elevated slider 1 are sufficiently limited when the distance between the heatsink 204 and the storage medium 7 is 2 mm. Furthermore, when the distance between the heatsink 204 and the storage medium 7 is 2 mm, the heatsink 204 and the storage medium 7 rarely damage on account of the contact with each other, and these members are easily manufactured. In summary, in the read/write device of the present embodiment, the temperature rises in the storage medium 7 and the elevated slider 1 are limited with a structure that also allows easy manufacture and reduces a possibility of damage at the time of driving. It is noted that the distance between the heatsink 204 and the storage medium 7 is preferably closer to the above, on condition that practicality is not hindered.

Since the shape of the heatsink 204 is not limited to those shown in FIGS. 20 and 21, the shape can be suitably altered. The alteration of the shape of the heatsink 204 induces a change in the temperature distribution of the storage medium 7 being driven. For example, the heat distribution of the storage medium 7 can be uniformed by altering the shape of the heatsink 204 in such a manner as to cause the heatsink 204 to cover a smaller area around the inner diameter of the storage medium 7. In this manner, the S/N ratio is stabilized at any point on the storage medium 7, by designing the shape of the heatsink 204 in consideration of the reduction of the temperature distribution, of the storage medium 7, in the radial direction.

[Embodiment 4] Air-Cooling Mechanism

Yet another embodiment of the present invention will be discussed with reference to figures.

A read/write device of the present embodiment air-cools the storage medium, by means of an air circulation structure formed in the housing. The air-circulation structure allows the air heated by the storage medium to be cooled inside the housing. By the way, members of the read/write device and manufacturing methods described in Embodiments 1 through 3 are given the same numbers, so that the descriptions are omitted for the sake of convenience.

In general, in order to stabilize the elevation height of the elevated slider, a read/write device including the elevated slider and adopting the heat assisted magnetic recording/reproduction scheme is arranged in such a manner as to stabilize the internal air pressure of the housing and reduce the disruption of air flow. On this account, the housing has no air holes except a tiny hole for air pressure control. This hole for air pressure control is typically 3 mm in diameter or less, and a filter for preventing dust from entering is attached to the hole.

When the read/write device is shaped in this manner, a temperature of the air (internal air) inside the housing increases as a temperature of the storage medium increases on account of heat from the storage medium. However, since the storage medium cannot be easily cooled by air, the above-described arrangement of the read/write device results in the temperature rise in the storage medium.

Taking into account of this, in the read/write device of the present embodiment, the temperature rise inside the housing is prevented by circulating air inside the housing and cooling the circulated air.

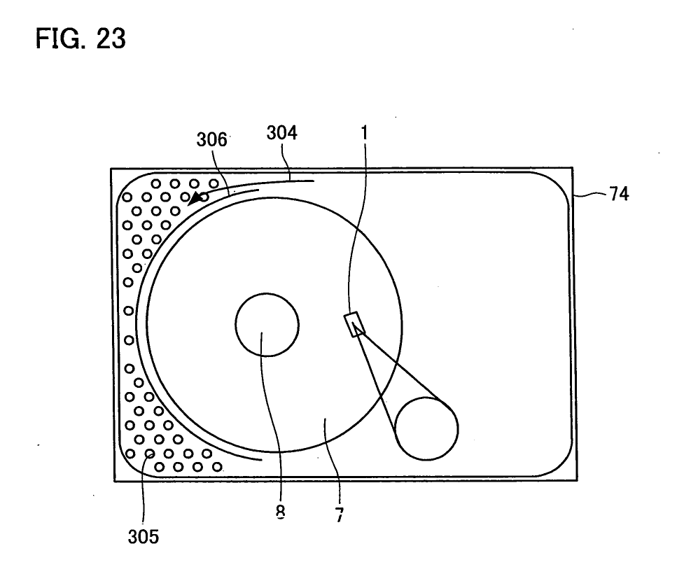

FIG. 23 is a plan view schematically illustrating the read/write device of the present embodiment. As shown in the figure, the read/write device of they present embodiment has a housing 74 in which an elevated slider 1 having auxiliary devices (electronic devices) such as a semiconductor laser and magnetic heads, a storage medium 7, a pivot 8, a flow restriction mechanism (convection mechanism) 306, and a cooling mechanism 305 are provided.

According to this arrangement, air flow generated by the rotation of the pivot 8 and the storage medium 7 prevents the disruption of air flow thanks to the flow restriction mechanism 306, and is circulated through a circulation path 304.

The heat of the circulated (convected) air (gas) is dissipated to the outside of the housing 74 through a lot of pins that are formed, as the cooling mechanism 305, in the housing 74. With this, the air inside the housing is cooled and the heat dissipation capacity of the storage medium 7 is improved. By the way, the circulation path 304 for air circulation is not necessarily routed as shown in FIG. 23. For instance, the circulation path 304 is routed in a configurational manner so as to overpass and/or underpass the storage medium 7. In this regard, it is preferable that the convection as a result of the arrangement of the circulation path 304 does not impede the stability of elevation of the elevated slider 1.

The flow restriction mechanism 306 is not limited to the aforementioned structure. Also, although the cooling mechanism 305 of the present embodiment is a large number of pins in the housing 74, the cooling mechanism 305 is not limited to this, as long as the air inside the housing 74 is suitably cooled. For instance, the cooling mechanism 305 may be gaps and fins that increase a heat transfer area between the housing 74 and the external air. In this case, the heat inside the housing 74 is transferred to the housing 74 with the help of the convection mechanism 306, and then dissipated to the external air via the housing 74 and the cooling mechanism 305 provided in the housing 74.

The convection mechanism 306 is not limited to the aforesaid flow restriction mechanism. One of the alternatives is such a mechanism that forcibly generates convection by means of a fan or the like.

[Embodiment 5] Thermal Distribution Canceling Method

The following will explain still another embodiment of the present invention with reference to Figures. For ease of explanation, members having the equivalent functions as those shown in the drawings pertaining to the read/write devices according to Embodiments 1 through 4 above will be given the same reference numerals, and explanation thereof will be omitted here.

In the read/write device according to the present embodiment, the control section 10 carries out a specific driving manner of the read/write device in consideration of the thermal distribution in the storage medium 7. It should be noted that, the driving method of read/write device according to the present embodiment may be applied to any of the read/write devices according to Embodiments 1 through 4. More specifically, in contrast to the read/write devices according to Embodiments 1 through 4 in which the thermal distribution in the storage medium 7 is reduced by modification in device structure, the read/write device of the present embodiment reduces the thermal distribution in the storage medium 7 with a specific driving manner of the semiconductor laser 2 provided to the elevated slider 1, performed by the control section 10. The following explains the driving method according to the present embodiment when executed in the read/write device of Embodiment 1.

As explained in Embodiment 1 above, there are two stages of temperature for the storage medium 7 used in the heat assisted magnetic recording/reproduction scheme: the magnetic compensation temperature T2 and the magnetic recording temperature or magnetic reproducing temperature T1. The magnetic compensation temperature T2 is generally set to a value substantially the same as room temperature. Note that, this temperature substantially the same as room temperature refers to an ambient temperature range at which the operation of read/write device of the present embodiment is ensured.

When using only one type of the storage medium 7, it is necessary to set the magnetic compensation temperature T2 in consideration of the temperature Tmax, which is the maximum temperature of the storage medium 7 at the highest drive current for the semiconductor laser 2 provided to the elevated slider 1. That is, the magnetic compensation temperature T2 is preferably set higher than Tmax.

Meanwhile, when the temperature of the storage medium 7 in a portion under the elevated slider 1 is denoted by T(r) (where r expresses a parameter in radial direction), the resulting value from T1 (the magnetic recording temperature) −T(r) varies. Therefore, when the operational power for the semiconductor laser 2 is constant in the radial direction, the writing/reading temperature may vary depending on the portion in the radial direction of the storage medium 7. More specifically, the temperature of the medium may become excessively high in some portion in the radial direction.

On the other hand, in the read/write device of the present embodiment, the control section 10 adjusts the operational power for the semiconductor laser 2 in consideration of the position in the radial direction. More specifically, the read/write device of the present embodiment includes a mechanism for allowing adequate adjustment of operational power for the semiconductor laser 2. Having such a mechanism allows control of the amount of heating from the semiconductor laser 2 to the minimum required regardless the position in the radial direction, thereby preventing excessive heating. With this arrangement, the temperature in the recording region during writing becomes constant, allowing stable writing and reading.

Such an adjustment of operational power for the semiconductor laser 2 in consideration of the portion in the radial direction requires information of temperature distribution of the storage medium 7 in the portion under the elevated slider 1. FIG. 7 shows changes in current-output relation (optical output characteristic) with changes in temperature of semiconductor laser 2 on pulse driving.

As shown in the figure, it is a generally-known fact that the lasing threshold of the semiconductor laser 2 increases with an increase in temperature. In the read/write device according to Embodiment 1, i.e., in the read/write device adopting the heat assisted magnetic recording/reproduction scheme shown in FIG. 1(a), the light receiving element 6 detects a current dependency of optical output emitted from the back edge of the semiconductor laser 2. Therefore, the read/write device of the present embodiment, the temperature characteristic of the elevated slider 1 can be found based on the current dependency of the optical output detected by the light receiving element 6.

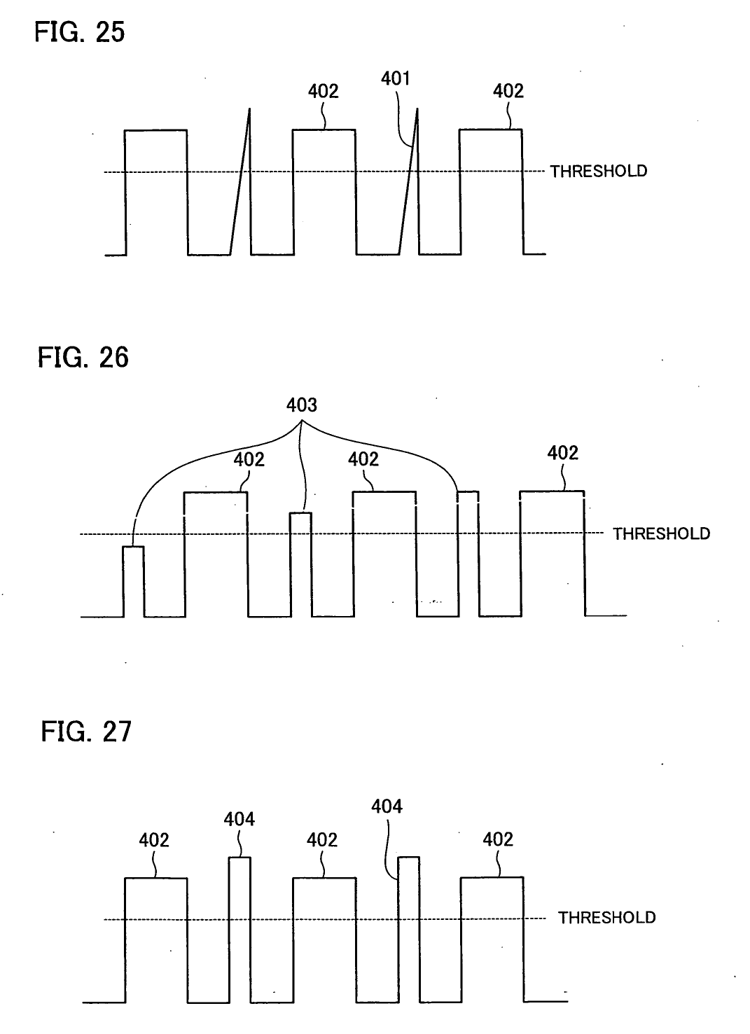

For example, the temperature of the storage medium 7 in the portion under the elevated slider 1 can be found based on a change in lasing threshold (threshold) of the semiconductor laser 2. In this case of finding the temperature of storage medium 7 in the portion under the elevated slider 1 based on the change in lasing threshold (threshold) of the semiconductor laser 2, as shown in FIG. 25, the threshold can also be found using the signal of optical output, which is obtained from the light receiving element 6 by simultaneously applying the pulse current (sub-pulse) 401, which is a triangle pulse, to the semiconductor laser 2, while applying the writing pulses 402 to the semiconductor laser 2.

Alternately, as shown in FIG. 26, the threshold can also be found using optical output obtained from the light receiving element 6 by applying the pulse currents (sub-pulses) 403 each having a different output peak to the semiconductor laser 2, while applying the writing pulse 402 to the semiconductor laser 2.

Otherwise, as shown in FIG. 27, the temperature of the semiconductor laser 2 can also be found from reference to FIG. 7 or the like using a change in optical output obtained from the light receiving element 6 by applying the pulse currents (sub-pulse) 404 constant in output power to the semiconductor laser 2, while applying the writing pulse 402 to the semiconductor laser 2.

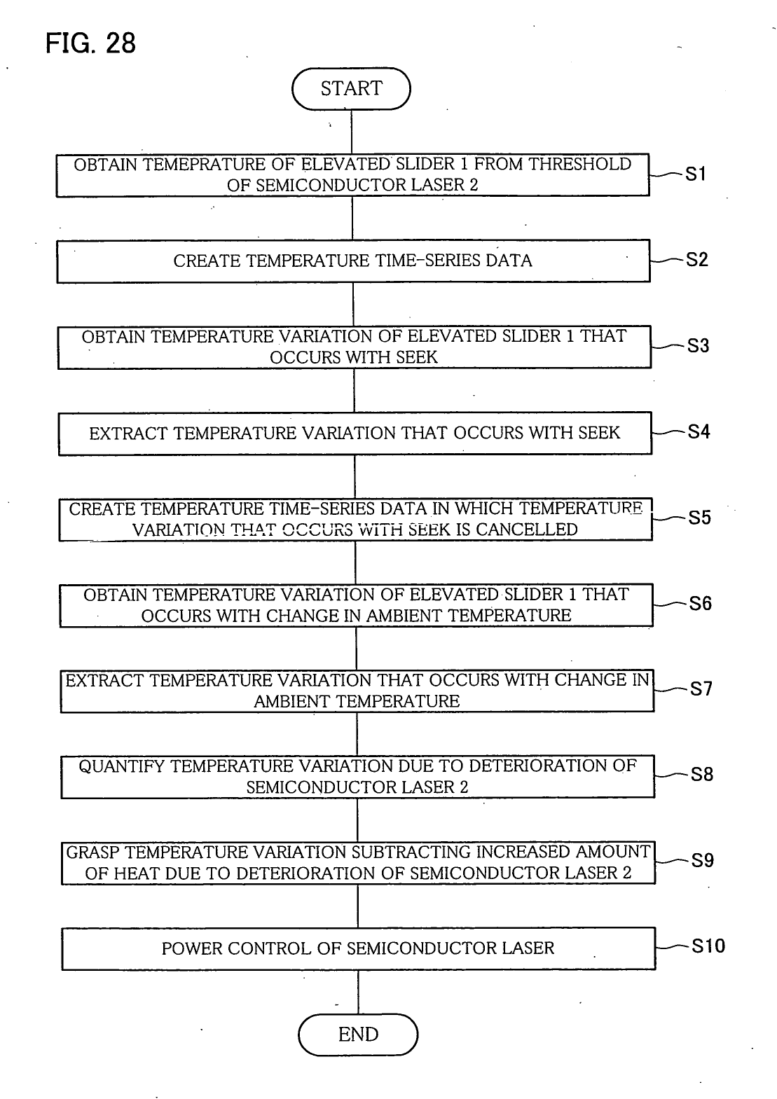

An increase in threshold of the semiconductor laser 2 with the repeated usage is generally known. For this characteristic, the read/write device of the present embodiment follows after each factor affecting the operation of the semiconductor laser 2, so as to accurately set the magnetic recording temperature T1 in the recording region of the storage medium 7. FIG. 28 is a flow chart showing a flow of operation in the read/write device according to the present embodiment. Note that, FIG. 28 can also be expressed a figure showing a measurement method of the time-series data of temperature change and a list of factors affecting the change in temperature of the storage medium 7 in the portion under the elevated slider 1 and the writing manner of the semiconductor laser 2. In this example, the major factors (causes of temperature change) affecting the change in temperature of the storage medium 7 in the portion under the elevated slider 1 and the writing manner of the semiconductor laser 2 are: temperature variation of the elevated slider 1 that occurs with a seek, temperature variation of the elevated slider 1 with change in ambient temperature, and temperature variation of the elevated slider 1 with an increase in heat generation caused by deterioration of the semiconductor laser 2.

First, the control section 10 obtains the temperature of the elevated slider 1 based on the threshold of semiconductor laser 2 with one of the foregoing methods (S1). Then, time-series data on temperature of the elevated slider 1 is created using the obtained temperature data (S2).

Next, the control section 10 finds positional change of elevated slider 1, that is, temperature variation of elevated slider 1 with a seek (S3). To find the temperature variation of elevated slider 1 with a seek, it is necessary to find the temperature T (r) at the position r in the radial direction. Further, it is also necessary to separately measure the variation in ambient temperature ΔTa, and the temperature variation ΔT1 caused by deterioration of the semiconductor laser 2.

Next, the control section 10 extracts the data of temperature variation that occurs with a seek from the time-series data created in S2 (S4). Then, the control section 10 cancels the temperature variation that occurs with a seek from the time-series data created in S2, so as to create temperature time-series data (S5).

Among the foregoing three causes of temperature variation, the temperature variation due to deterioration of the semiconductor laser 2 has a large time constant. Therefore, deterioration of the semiconductor laser 2 proceeds nearly monotonously with time. Meanwhile, the variation in ambient temperature is random but not as rapid as a change per several seconds. Further, the temperature variation that occurs with a seek, which is detectable by being associated with seeking movement, is more rapid.

Accordingly, by separating the temperature distribution T (r), which depends on the radial direction parameter r corresponding to the seek, from the temperature time-series, it is at least possible to find as data the change in ambient temperature which occurs at or before several tens of hours, and the temperature change, which occurs at or after several tens of hours, due to deterioration of the semiconductor laser 2.

Next, the control section 10 finds the temperature variation of the elevated slider 1 with the change in ambient temperature (S6). Then, the control section 10 extracts the temperature variation of the elevated slider 1 with the variation in ambient temperature created in S6 from the time-series data created in S5 (S7). Further, based on the result of S7, the control section 10 quantifies the increased amount of heat due to deterioration of the semiconductor laser 2 (S8).

Next, referring to the temperature of the elevated slider 1 obtained in S1, the control section 10 calculates a temperature variation value by subtracting the temperature rise found in S8 corresponding to the increased amount of heat due to deterioration of the semiconductor laser 2, from the temperature of the elevated slider 1 found in S1 (S9).

Then, with the temperature variation found in S9, the control section 10 carries out adjustment of power of the semiconductor laser 2 (S10). Note that, when the elevated slider 1 is shifted in the radial direction of the storage medium 7 to continue the writing/reading operation, the power of semiconductor laser 2 may be adjusted only based on the temperature variation of elevated slider 1 occurring with a seek at the portion where the elevated slider 1 is shifted. In other words, the power of the semiconductor laser 2 may be adjusted (S10) according to the results of steps S1 through S4. Similarly to the case above, the temperature variation with change in ambient temperature, and the temperature variation of the elevated slider 1 caused by deterioration of the semiconductor laser 2 have large time constants also in this case, therefore, driving is adequately performed even with the measurement result upon start-up of the read/write device.

In the read/write device according to the present embodiment, an accurate temperature distribution of the storage medium 7 in the portion under the elevated slider 1 can be found by extracting the temperature variation T(r) occurring with a seek from the temperature time-series data created in S2. In this manner, the driving can be performed in consideration of temperature characteristic of the semiconductor laser 2, thereby appropriately setting the temperature of the storage medium 7 to the magnetic recording temperature T1. More specifically, by controlling the driving of the semiconductor laser 2 so as to output with heat only by the amount corresponding to the magnetic recording temperature T1−T(r) according to the radial direction parameter r of the storage medium 7, it is possible to carry out writing/reading without falling of the S/N ratio. This method ensures stable writing/reading.

Further, with the driving method of the read/write device according to the present embodiment, the life of the semiconductor laser 2 can be accurately estimated. Specifically, referring to. the time-series data of increased amount of heat generation due to deterioration of the semiconductor laser 2 allows estimation of the life of the read/write device (information read/write device) of the present embodiment including the semiconductor laser 2. Therefore, it is possible to cause the control section 10 to, before the semiconductor laser 2 unable to read due to deterioration of the semiconductor laser 2, automatically write (back up) the data (information) stored in the storage medium 7 into another storage medium (information storage medium). Further, a deterioration condition may be alerted (presented) via the display section 15 to the user. For example, the read/write device of the present embodiment may include a display section (not shown) such as a liquid crystal panel, and the deterioration condition may be displayed on this display section. Alternatively, the deterioration condition of the semiconductor laser 2 may be informed by voice. By thus accurately estimating the life of the semiconductor laser 2, it is possible to prevent data loss of the read/write device.

Further, the influence of heat generation from the magnetic head and other components to the elevated slider 1 may also be estimated with the same method.

Further, in the case shown in FIGS. 25, 26 and 27, it is preferable to use sub pulses 401, 403, 404 with a short pulse width, for example, at about 5ns or less. On this account, the temperature of the semiconductor laser 2 can be heated by a sub pulse with little heating of the semiconductor laser 2. However, the effect of the present invention can be obtained with a sub pulse whose pulse width is at 5 ns or greater.

Further, the sub-pulses may be made for each recording region, or may be sampled to ease the operation of a processing circuit. Further, the sub pulses may also be used to detect the error due to variation in threshold and variation in optical output upon pulse driving of the semiconductor laser 2 so as to correct the time-series data. In this case, the semiconductor laser 2 is driven based on the thermal distribution of the storage medium 7 and the optical output of the semiconductor laser 2, which are estimated from the time-series data.

Further, in the read/write device according to the present embodiment, the drive current for the semiconductor laser 2 is controlled based on the temperature of the elevated slider 1. However, the drive current for the semiconductor laser 2 may be controlled according to the obtained temperature of storage medium 7.

When the magnetic recording temperature (writing temperature) or the magnetic reproducing temperature (reading temperature) required for writing/reading of the storage medium 7 is expressed as T1, and the magnetic compensation temperature, which is a desirable temperature of storage medium 7 for the portion other than the recording region, is expressed as T2, the read/write device according to the present embodiment adopting the heat assisted magnetic recording/reproduction scheme is preferably arranged so that, under the maximum operational power upon writing/reading of the semiconductor laser 2, the magnetic compensation temperature T2 is higher than the maximum temperature of the storage medium 7 raised by heat upon driving of the semiconductor laser 2 and heat generated from all heat sources provided in the elevated slider 1. In other expression, it is preferable that the magnetic compensation temperature T2 of storage medium 7 is higher than the maximum temperature in the region on the storage medium which overlaps a magnetic head when viewed from a perpendicular direction with respect to a recording surface of the storage medium 7, and which is not a region heated by a laser beam emitted from the semiconductor laser 2. Further, it is preferable to use a storage medium 7 whose magnetic compensation temperature T2 satisfies the foregoing condition under the ambient temperature where the operation of read/write device is ensured.

As described above, the temperature substantially the same as room temperature refers to an ambient temperature range at which the operation of read/write device of the present embodiment is ensured. For example, when the thermal conductivity of the substrate of the storage medium 7 is high, the magnetic compensation temperature T2 needs to be several degrees higher than the temperature substantially the same as room temperature. Further, when a substrate with a low thermal conductivity, such as an inexpensive glass substrate, is used for the storage medium 7, the magnetic compensation temperature T2 needs to be set to 100° C. or lower, for example. The magnetic film can be formed of an alloy of, for example, Tb, Fe, and Co. It is generally known that the magnetic compensation temperature T2 of the magnetic film made of the alloy changes depending on the content of Tb etc.

Further, the driving method of read/write device according to the present embodiment controls operational power for the semiconductor laser 2 using a variable according to the position in the radial direction of the storage medium 7. Further, the temperature of storage medium 7 during writing/reading operation becomes uniform in the circumference of a certain diameter. Accordingly, the major temperature distribution in the storage medium 7 occurs in the radial direction. Further, in the driving method of read/write device according to the present embodiment, the operational power for the semiconductor laser 2 is controlled so that the temperature of the recording region raised by the semiconductor laser 2 during writing or reading becomes constant regardless the position on the storage medium 7. On this account, stable saturation magnetization and coercive force are ensured in the read/write device adopting the heat assisted magnetic recording/reproduction scheme, thereby performing excellent writing/reading.

Further, the read/write device according to the present embodiment is arranged so that the control section (temperature measurement section) 10 applies a sub pulse to the semiconductor laser 2, obtain a threshold from the resulting optical output from the light receiving element 6, and find the temperature of the storage medium 7 in the portion under the elevated slider 1 (temperature of a writing or reading position) in accordance with variation of this threshold. However, an arrangement of the means for measuring the temperature (temperature measurement section) with a variable according to the position in the radial direction of the storage medium 7 may instead be any other means capable of accurately obtaining the temperature in the radial direction of the storage medium 7. Further, the means for measuring the temperature is not always required to be provided in the elevated slider 1 like the foregoing structure of the present embodiment. For example, the measurement may be performed by the semiconductor laser 2, and the temperature of the storage medium 7 in the portion under the elevated slider 1 may be found according to variation of optical output at the constant current of the semiconductor laser 2.

As described, obtaining the temperature of the storage medium 7 using a variable according to the position in the radial direction allows feed back of temperature distribution in the radial direction of storage medium 7 to the operational power for the semiconductor laser 2, thereby reducing variation of the S/N ratio depending on the position of the recording region. Note that, the relation between the lasing threshold of the semiconductor laser 2 and the temperature can be expressed with a parameter T0 (temperature characteristic index). By finding the characteristic of T0 in advance, TO can be converted into a temperature.

Further, the driving method of read/write device according to the present embodiment controls the operational power for the semiconductor laser 2 by compensating an increased amount of heat due to deterioration of semiconductor laser 2 caused by repeated driving. In spite of significantly long life of a semiconductor laser in these days with reduction in defect density or power consumption, the threshold still increases with repeated usage. Further, deterioration of semiconductor laser further increases heat generation thereof, causing a temperature rise in a storage medium.

In contrast, with the foregoing method which controls the operational power for the semiconductor laser 2 by compensating for an increased amount of heat due to deterioration of the semiconductor laser 2 with repeated driving, the temperature in the recording region during writing/reading operation becomes constant. More specifically, by reducing optical output of semiconductor laser 2 in consideration of the increased amount of heat from the semiconductor laser 2, the amount of heat from the semiconductor laser 2 is limited, thereby suppressing the temperature rises in the elevated slider 1 and the storage medium 7.

To perform driving control of the semiconductor laser 2 in consideration of the increase in heat generation due to deterioration of the semiconductor laser 2, it is necessary to separately detect the temperature distribution of storage medium 7 and the increase in heat generation due to deterioration of the semiconductor laser 2. Therefore, the driving method of read/write device according to the present embodiment performs separate control of (i) the temperature information with a seek upon operation of the elevated slider 1, which information is measured as a variable according to the position in the radial direction of storage medium 7, and (ii) the temperature variation of storage medium 7 with the increase in heat generation due to deterioration of electronic device in the elevated slider 1.

Further, the driving control with the temperature distribution of storage medium 7 is performed based on the time constant depending on the seek, and therefore greatly differs from the time constant denoting deterioration of semiconductor laser 2. Specifically, the deterioration of semiconductor laser 2 can be found by saving plural data (accumulation data) according to the seek on the heat assisted magnetic recording/reproduction scheme, and measuring change of the data with time. On the other hand, the variation of ambient temperature, which exists between the two time constants, can be found with reference to variation of the accumulation data. Further, a thermoscope capable of detecting atmosphere may be provided in a housing or certain portion inside the housing so as to allow compensation of the ambient temperature estimated based on the accumulation data. Note that, using a plurality of evaluation points of storage medium 7 or a plurality of evaluation diameters allows more appropriate feed back of the evaluation results. In this way, the present invention provides a heat assisted magnetic recording/reproduction scheme in which the S/N ratio is reduced.

[Embodiment 6]

Uniformalization of Temperature Distribution of Storage Medium with Auxiliary Semiconductor Laser

The following will explain another embodiment of the present invention with reference to Figures. For ease of explanation, members having the equivalent functions as those shown in the drawings pertaining to the read/write devices according to Embodiments 1 through 5 above will be given the same reference numerals, and explanation thereof will be omitted here.

The present embodiment uses a read/write device including another mechanism (auxiliary heat source) for heating the storage medium 7, in addition to the semiconductor laser 2 for heating the recording region.

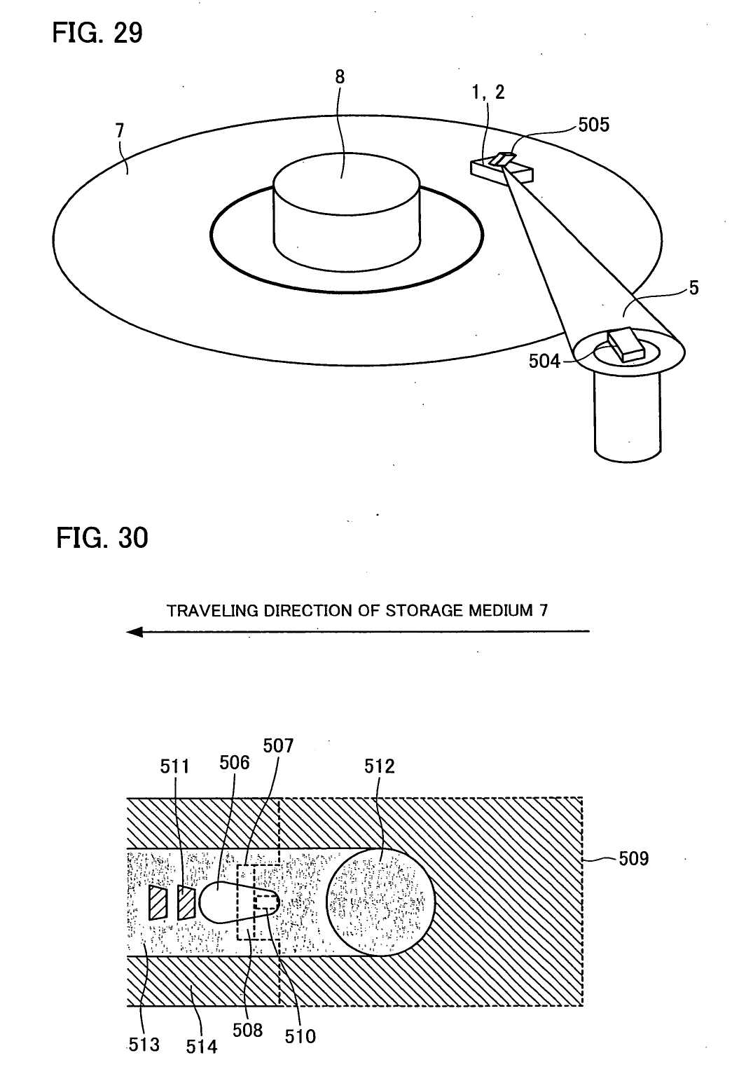

FIG. 29 is a perspective view illustrating a schematic structure of read/write device according to the present embodiment. As shown therein, the read/write device of the present embodiment includes an auxiliary semiconductor laser 504 on a suspension 5, and an auxiliary semiconductor laser guiding optical system 505 on the elevated slider 1. Aside from these additional components, the read/write device of the present embodiment has substantially the same structure as that of Embodiment 1 with the semiconductor laser 2 and the magnetic head (not shown) provided in the elevated slider 1.

In the storage medium 7 of the present embodiment, the magnetic compensation temperature T2 is constant in the whole area. Further, the magnetic compensation temperature T2 is set higher than the temperature Tmax, which is the maximum temperature of the storage medium 7 at the highest drive current for the semiconductor laser 2 in the elevated slider 1. Further, the temperature T(r) of the storage medium 7 in the portion under the elevated slider 1, which depends on thermal conductivity from the elevated slider 1, is adjusted so that ΔT is close to zero when ΔT=T2−T(r), by adjusting the heat generated by the auxiliary semiconductor laser 504. Here, r is a parameter denoting the position in the radial direction of the storage medium 7.

FIG. 30 is an explanatory view illustrating a state on the storage medium 7 when information is read out from the storage medium 7 in the read/write device according to the present embodiment. In this figure, the storage medium 7 rotates in the clockwise direction, and the spot on the storage medium 7 moves from right to left.

The emission light from the semiconductor laser 2 is incident on the semiconductor laser spot section (laser spot) 510 on the storage medium 7. As a result, a thermal distribution 506 is formed on the storage medium 7. Further, residual magnetization increases in the portion where the thermal distribution 506 and the reproduction magnetic head region (reproduction head region) 507 for GMR etc. are overlapped, thus reading information from the storage medium 7.

However, in the region 508 which exists under the reproduction head region 507 and not overlapping with the thermal distribution 506, the S/N ratio decreases when residual magnetization generates. To prevent such a decrease in S/N ratio in the region 508, it is preferable to set the temperature of the region 508 to the magnetic compensation temperature T2, by which the residual magnetization is reduced.

In view of this condition, the read/write device of the present embodiment adjusts the emission light from the auxiliary semiconductor laser 504 so that the spot pattern 512 of the incident light onto the storage medium 7 is greater than the reproduction head region 507. The emission light from the auxiliary semiconductor laser 504 is incident on the storage medium 7 via the auxiliary semiconductor laser guiding optical system 505. With this incident light from the auxiliary semiconductor laser 504, the region 513 on the storage medium 7 is heated.

As described, the output from the auxiliary semiconductor laser 504 is adjusted by the control section 10 to satisfy ΔT=T2−T(r)=0. By thus irradiating the storage medium 7 with an appropriate optical output from the auxiliary semiconductor laser 504, the temperature of the region 508 in the storage medium 7 is set to the magnetic compensation temperature T2.

On this account, the S/N ratio is increased in the read/write device, which is driven by the heat assisted magnetic recording/reproduction scheme using the semiconductor laser 2, regardless the position in the radial direction of the storage medium 7. As shown in FIG. 30, the irradiation spot (spot pattern 512) by the auxiliary semiconductor laser 504 needs to exist upstream of the recording spot on the storage medium 7, and it is preferable that the semiconductor laser spot section 510 is closer to the irradiation spot than the uppermost stream section 509 of the elevated slider 1. Note that, the region 514 in FIG. 30 is that portion on the storage medium 7 which is heated by thermal conduction from the elevated slider 1. Also, the portion with the reference numeral 511 is a mark pattern of the storage medium 7.

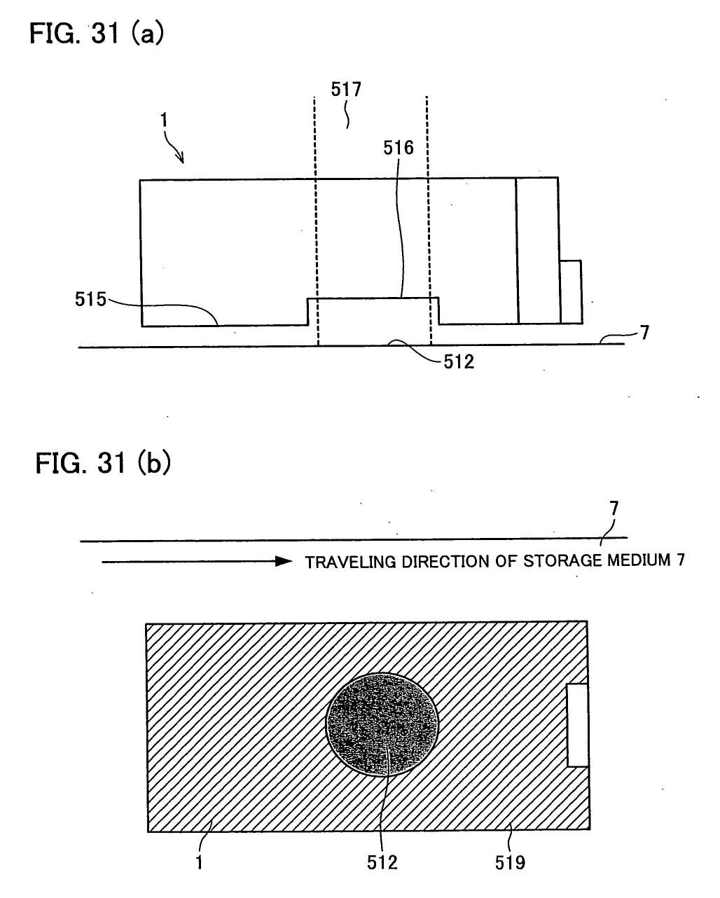

The thermal conductive path of the semiconductor laser 2, provided in the elevated slider 1, for transmitting heat to the storage medium 7 lies along the bottom face of the elevated slider 1. Accordingly, the temperature of the elevated slider 1 decreases as the temperature of storage medium 7 in the portion under the elevated slider 1 decreases. On this account, the structure with the auxiliary semiconductor laser 504 can be made in the form shown in FIGS. 31(a) and 31(b). FIG. 31(a) is a cross-sectional view illustrating one example of the structure having the auxiliary semiconductor laser 504, while FIG. 31(b) shows a plan view for the same structure. In FIGS. 31(a) and 31(b), the storage medium 7 moves (travels) from left to right.

As shown therein, even though they are part of the portion under the elevated slider 1, in the region 515 which is more upstream in the moving direction than the spot pattern 512 of auxiliary semiconductor laser 504, and in the region (not shown) not irradiated with the emission light of auxiliary semiconductor laser 504, the temperature of storage medium 7 hardly increase by the emission light from the auxiliary semiconductor laser 504. If a low temperature area is thus ensured in the storage medium 7, the temperature will decrease in the elevated slider 1, and in the semiconductor laser 2 provided in the elevated slider 1.

Note that, as shown in FIG. 31(a), the region 516 in the elevated slider 1 right above the spot pattern 512 is preferably made to increase the spacing between the surface of the region 516 and the storage medium 7. On this account, it is possible to prevent the heat from the spot pattern 512 on the storage medium 7 from flowing into the elevated slider 1. The depth of the region 516 is desired to be at least not less than 0.5 μm. In FIG. 31(a), the portion indicated by the reference numeral 517 is the laser beam from the auxiliary semiconductor laser 504. The region 519 in FIG. 31(b) represents the region on the storage medium 7 heated by the heat from the elevated slider 1.

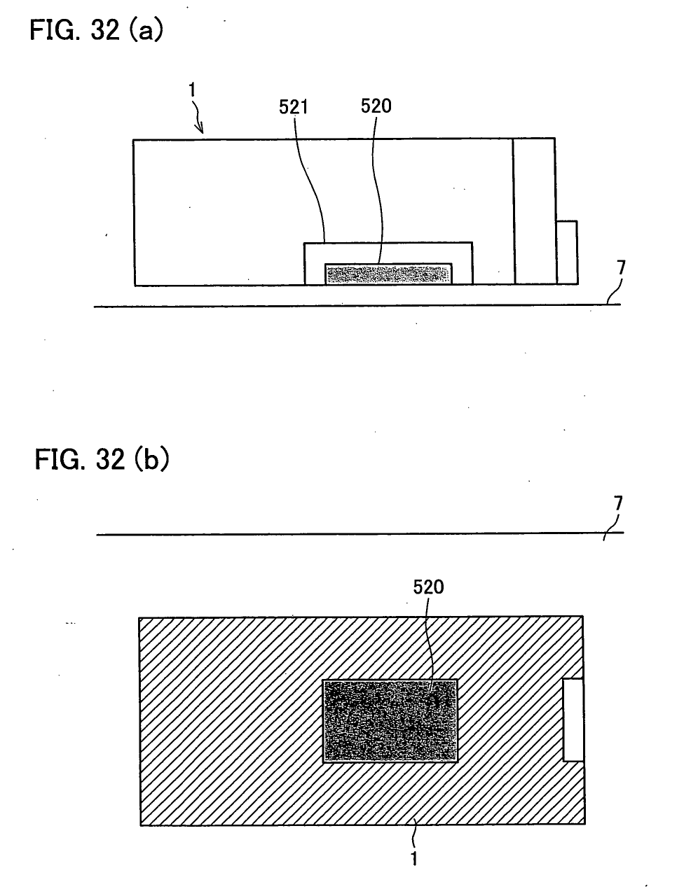

However, the auxiliary heat source may be realized by means other than the auxiliary semiconductor laser 504. For example, as shown in FIGS. 32(a) and 32(b), a heat source 520 may be provided in the elevated slider 1. FIG. 32(a) is a schematic cross-sectional view of the storage medium 7 and the elevated slider 1 when the elevated slider 1 includes the heat source 520. FIG. 32(b) is a schematic plan view of the storage medium 7 and the elevated slider 1 when the elevated slider 1 includes the heat source 520.

However, when the heat source 520 is provided in the elevated slider 1, it is preferable to provide a heat blocking layer 521 low in thermal conductivity between the heat source 520 and the elevated slider 1.

As described, in addition to the semiconductor laser 2 for recording/writing, the read/write device according to the present embodiment includes an auxiliary heat source for heating the storage medium, thereby further increasing the temperature in the periphery of the recording region, having been heated by the semiconductor laser 2, to a temperature substantially the same as the magnetic compensation temperature T2. By thus increasing the temperature in the periphery area, which is not involved in recording, to the magnetic compensation temperature T2, the residual magnetization becomes nearly 0 in this area. As a result, the S/N ratio increases.

Note that, as mentioned above, the auxiliary heat source may be realized by an auxiliary semiconductor laser or other means. Further, it is both allowable for the auxiliary heat source mounted to the elevated slider 1 or separated from the elevated slider 1. It is preferable that the auxiliary heat source increases the temperature of storage medium 7 before the semiconductor laser 2 increases the temperature of the recording region.

In the micro disk 702, there is a mode for causing total reflection in the border of a circular disc, called a whispering gallery mode. In this mode, evanescent light generates in the periphery of the micro disk. The evanescent light is an electromagnetic field whose intensity exponentially decreases at about the wavelength described earlier. In the structure, as described herein, where the distance between the bottom point (bottom surface of the slider) and the storage medium is 100 nm or smaller, the evanescent light causes optical tunneling effect of the mode generated in the micro disk with respect to the storage medium. The storage medium is heated by this light, allowing the heat assisted magnetic recording.

Meanwhile, the device may also be arranged so that metal fine particles, or discontinuities of circle ratio of the micro disk are provided in the vicinity of the bottom point. In the structure with the metal fine particles, the evanescent light excites the localized plasmon in the metal fine particles. The localized plasmon is expected to produce a high intensity near-field. The structure with discontinuities of circle ratio encourages scattering of the mode at the discontinuities, thereby increasing efficiency of optical tunneling.

Further, in the structure having the auxiliary semiconductor laser 504, it is preferable that the lasing wavelength of the auxiliary semiconductor laser 504 is transparent with respect to the elevated slider 1. Further, it is also preferable that the auxiliary semiconductor laser 504 is not in contact with the elevated slider 1, and therefore the emission light from the auxiliary semiconductor laser 504 passes through the elevated slider 1 before entering the storage medium 7. On this account, it is possible to prevent temperature rise in the elevated slider 1 by a laser beam from the auxiliary semiconductor laser 504. Further, the elevated slider 1 may include a mechanism for altering the shape of the auxiliary semiconductor laser 504 (spot-shape altering section).

For example, when the elevated slider 1 is made of a nitride semiconductor mainly containing Ga, it is preferable that the oscillation wavelength of the auxiliary semiconductor laser 504 is not less than 380 nm. Further, a wavelength of 600 nm or greater is more preferable as it prevents absorption by the deep impurity level of the nitride semiconductor which mainly contains Ga. Further, this auxiliary semiconductor laser 504 preferably adopts a laser beam lead-in mode which is connected to the suspension 5 connected to the elevated slider 1, for ease of alignment of a laser beam from the auxiliary semiconductor laser 504.

Heat conduction from the storage medium 7, which is heated by the auxiliary semiconductor laser 504, to the elevated slider 1 can be reduced by excavating the lower surface of elevated slider 1 above the laser spot of the storage medium 7 resulting from emission of the auxiliary semiconductor laser 504. On this account, the thermal resistivity of the storage medium 7 and the excavated lower surface of elevated slider 1 increases, thereby reducing the thermal movement from the storage medium 7, having been heated by the auxiliary semiconductor laser 504, to the elevated slider 1.

Further, the temperature distribution outside the recoding region can be reduced by providing in the elevated slider 1 a mechanism for altering the spot shape of the auxiliary semiconductor laser 504 (spot-shape altering section). For example, the intensity of light spot on the storage medium created by the auxiliary semiconductor laser becomes even by providing a high-reflection film by which the center of the light spot has a high transparency, while the other portion reflects light.

Further, by raising a temperature of the area outside the recording region (or including the recording region) in advance in consideration of the temperature distribution of the storage medium 7 caused by heat (heat conduction) from elevated slider 1, the temperature in the vicinity of the recording region becomes equal to the magnetic compensation temperature T2 which is higher than the maximum temperature of the storage medium 7. On this account, noise is suppressed outside the recording region, thereby increasing the S/N ratio upon reproduction.

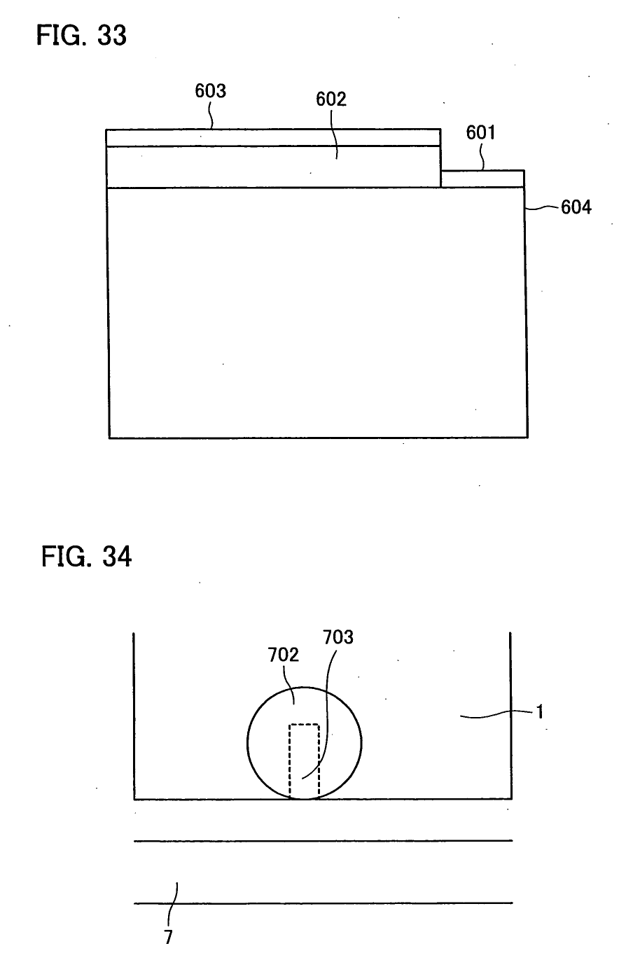

Though the semiconductor laser 2 in the present embodiment is realized by one of edge-emitting types with a ridge stripe structure, the semiconductor laser 2 may be other type of semiconductor laser. For example, as shown in FIG. 33, it may have a structure having a different ridge shape in the vicinity of the emitting surface.

The semiconductor laser shown in FIG. 33 includes a ridge 602 made of a nitride semiconductor, a p-electrode 603 provided thereon, and a region 601 made of material having a low refractive index, such as SiO2. The semiconductor laser emits light from a light-emit edge face 604. Note that, the magnetic write head or the magnetic read head may be provided on the region 601. With this account, no current is injected to the region 601, so that the internal loss increases. However, the NFP (near-field pattern) is compressed in the vertical direction on the light-emit face, and the gap between the laser spot and the magnetic write head or the magnetic read head is reduced, thereby improving efficiency of the heat assisted magnetic recording/reproduction scheme.

Further, as shown in FIG. 34, a micro-disk-type semiconductor laser may be used. In the structure shown in FIG. 34, the elevated slider 1 includes a micro disk 702 and a magnetic head 703.

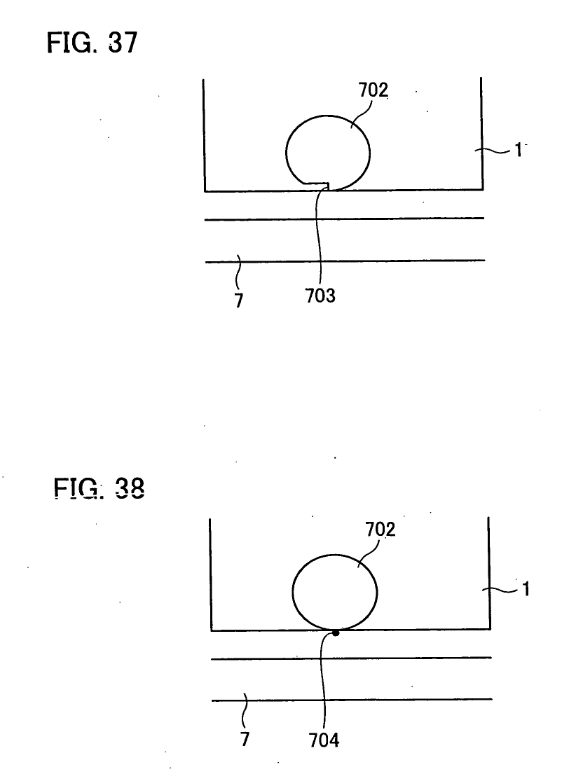

Since the radiation loss of the micro-disk-type semiconductor laser is small, it creates a resonator with a high Q value. As described above, the elevated slider 1 operates at a height of 100 nm or below from the storage medium 7, optical tunneling effect occurs from the micro disk 702 to the storage medium 7, enabling the heat assisted magnetic recording and reproduction. However, since the micro disk 702 causes a greater diffusion into the storage medium 7, the micro disk 702 may have a cut-out portion (a portion having a different curvature) 703 as shown in FIG. 37. Alternately, metal fine particles 704 may be provided on the surface of the micro disk 703 as shown in FIG. 38.

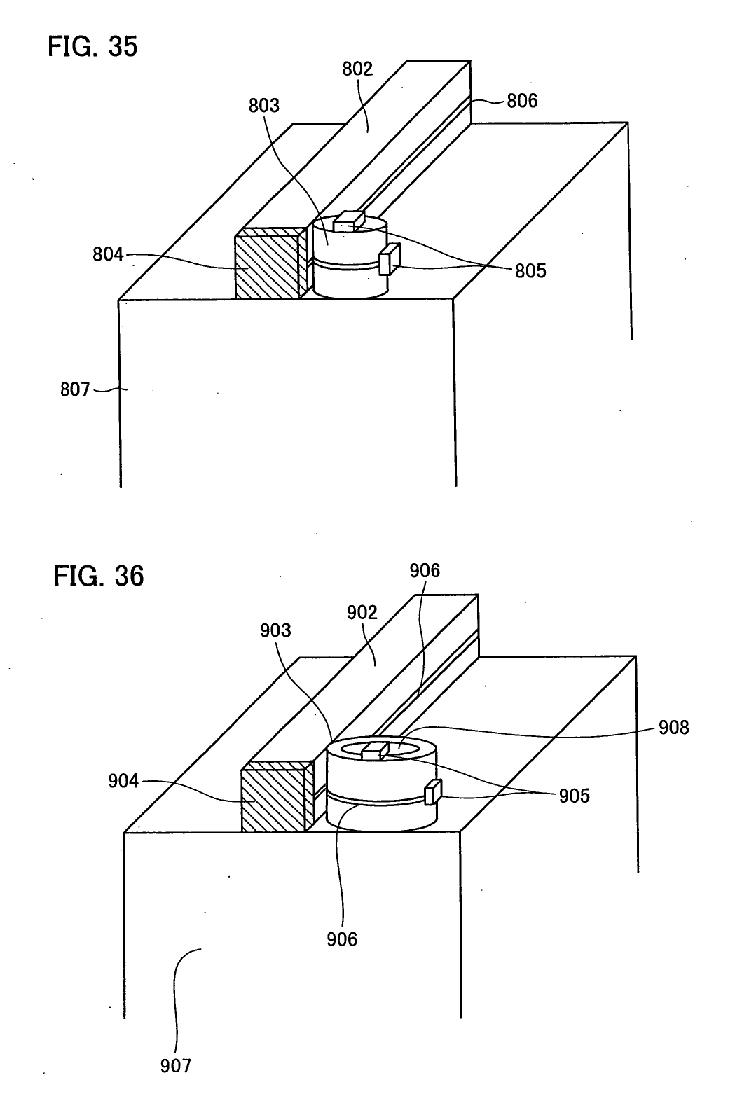

Further, FIG. 35 shows a structure example in the case of using a micro-disk-type semiconductor laser. FIG. 35 is a perspective view of a semiconductor laser viewed obliquely from above. As shown therein, with the combination of the edge-emitting stripe waveguide (Fabry-Perot resonator structure) 802 and the cylindrical waveguide 803, a part of the stimulated emission of radiation generated in the active layer 806 is lead into the cylindrical waveguide 803, and is coupled with the whispering gallery mode in the cylindrical waveguide 803. Here, the semiconductor laser is combined with the elevated slider 1 so that its edge face 807 comes to the bottom, or is joined to the elevated slider 1, so that a part of the cylindrical waveguide 803 comes close to the storage medium 7. As a result, as with the micro disk used in the structure of FIG. 34, optical tunneling effect occurs from the cylindrical waveguide 803 into the storage medium 7, enabling the heat assisted magnetic recording/reproduction.

In the structure of FIG. 35, the high reflection film 804 is provided on the edge face of the stripe waveguide 802. This prevents leakage of optical output from the stripe waveguide 802 which may enter into the storage medium 7. Further, since the cylindrical waveguide 803 causes a greater diffusion into the storage medium 7, a portion having a different curvature or metal fine particles may be provided as with the structure of FIGS. 37 or 38. Moreover, the magnetic head 805 may be disposed in other suitable portion than that shown in the structure of FIG. 35 in consideration of the heating region of the storage medium.

Further, in the structure of FIG. 35, each of the stripe waveguide 802 and the cylindrical waveguide 803 includes an active layer, but the cylindrical waveguide 803 may be passive. Further, the high reflection film 804 may include a plurality of dielectrics, otherwise, is a metal film or a mixture film of metal and dielectric.

The cylindrical waveguide 803 may be made as a ring resonator in which the central portion is cut out or filled with a material lower in refractive index than the cylindrical waveguide 803, which resonator ensures the same effect as above. The perspective view of FIG. 36 shows an example of this type of semiconductor laser.

In this semiconductor laser, since the edge-emitting stripe waveguide (Fabry-Perot resonator structure) 902 is combined with the ring waveguide 903, a part of the stimulated emission of radiation generated in the active layer 906 is lead into the ring waveguide 903, and is coupled with the whispering gallery mode in the ring waveguide 903. In FIG. 36, the central portion of the ring waveguide 903, i.e. the cut-out portion or portion filled with the material lower in refractive index than the ring waveguide 903, is denoted by the reference numeral 908.

Here, the semiconductor laser is combined with the elevated slider 1 so that its edge face 907 comes to the bottom, or is joined to the elevated slider 1, so that a part of the ring waveguide 903 comes close to the storage medium 7. As a result, as with the micro disk used in the structure of FIG. 35 or 36, optical tunneling effect occurs from the ring waveguide 903 into the storage medium 7, enabling the heat assisted magnetic recording/reproduction.

In the structure of FIG. 36, the high reflection film 904 is provided on the edge face of the stripe waveguide 902. This prevents leakage of optical output from the stripe waveguide 902 which may enter the storage medium 7. Further, since the ring waveguide 903 causes a greater diffusion into the storage medium 7, a portion having a different curvature or metal fine particles may be provided as with the structure of FIG. 37 or 38. Moreover, the magnetic head 905 may be disposed in other suitable portion than that shown in the structure of FIG. 36 in consideration of the heating region of the storage medium.

Further, in the structure of FIG. 36, each of the stripe waveguide 902 and the ring waveguide 903 includes an active layer, but the ring waveguide 903 may be passive. Further, the high reflection film 904 may include a plurality of dielectrics, otherwise, is a metal film or a mixture film of metal and dielectric.

In the foregoing read/write devices according to the respective embodiments, the elevated slider 1 may include an elevation mechanism which elevates the elevated slider 1 above an elevated position the elevated slider takes during writing or reading operation, when the elevated slider 1 is not in operation. In this case, it is preferable that the semiconductor laser 2 is driven only when the elevated slider 1 provided with the semiconductor laser 2 is in the elevation height the elevated slider takes during writing or reading operation. The heat generated from the semiconductor laser 2 is dissipated through the storage medium 7, therefore, the heat dissipation characteristic of the semiconductor laser 2 decreases when the elevated slider 1 is at the out-of-operation position. In this view, it is preferable the semiconductor laser 2 is not driven when the elevated slider 1 is at the out-of-operation position, or, even when driven, the driving is preferably performed by a pulse driving at a duty ratio of 10% or less, or by a low current of 10 mA or lower.

Further, when the elevated slider 1 is moved to the elevated position during operation at the time of shift from out-of-operation state to operation state, a small amount of current may be supplied in advance to an electronic device, such as the semiconductor laser 2, provided in the elevated slider so that the electronic device is preheated. After the driving is started, it takes some time to stabilize the temperature of the semiconductor laser 2 provided in the elevated slider 1 at the elevated position. The heat assisted magnetic recording/reproduction during this period causes a falling of the S/N ratio. To solve this problem, the writing/reading may be suspended for a certain time until the temperature becomes stable; however, the foregoing arrangement in which the elevated slider 1 includes an elevation mechanism which elevates the elevated slider 1 above an elevated position the elevated slider 1 takes during writing or reading operation; and a small amount of current is passed in advance through an electronic device, such as the semiconductor laser 2, provided in the elevated slider 1, when moved to the elevated position during operation at the time of a shift from out-of-operation state to operation state, so that the electronic device is preheated, it is possible to reduce access time to the electronic device. On this account, the generation of heat from an electronic device, such as the semiconductor laser 2, is reduced, thereby suppressing temperature rises in the elevated slider 1 and the storage medium 7.

Further, according to the respective embodiments above, the control section 10 controls all the processing steps in the read/write devices; however, those processing steps may be written in a program stored in a storage medium, and the control section 10 may instead be an information processing device for reading out the program. More specifically, the function of the control section 10 and the respective processing steps can be realized by executing a program stored in the storing means, such as a ROM (Read Only Memory), or a RAM, by a computing means such as a CPU. Therefore, the respective functions of the control section 10 and the processings in the read/write device according to the foregoing Embodiments may be realized only by causing a computer having such means to read out the storage medium storing the program and execute the program. Further, by storing the program in a removable storage medium, the functions and processings may be realized in an arbitrary computer. Note that, the program here refers to a program code (a series of data signals, such as an execution-type program, a medium code program, a source program etc.), which is used alone or being combined with other program (OS etc.). The program may be stored in a memory (RAM etc.) inside the device after read out from the storage medium, before it is read out again to be executed.

In view of execution by a micro computer, the storage medium may be a memory (not shown), such a program medium, for example, a ROM etc. Otherwise, the read/write device may be connected to an external storage device to which the storage medium storing a program media is inserted and read out for execution.

In either case, the stored program is preferably realized by access of microprocessor, or may be realized in such a manner that the program is read out and is downloaded in a program storage area of a microcomputer for execution. This program for downloading should be previously stored in the device body.

Further, the program media may be a built-in media of the read/write device, or may be a removable storage medium. Examples of the program medium include one fixedly holds the program code, which can be (a) a tape system such as a magnetic tape, a cassette tape or the like, (b) a disk system which includes a magnetic disk such as a floppy disk®, a hard disk or the like and an optical disk such as a CD-ROM, an MO, an MD, a DVD or the like, (c) a card system such as an IC card (inclusive of a memory card), an optical card or the like, and (d) a semiconductor memory such as a mask ROM, an EPROM, an EEPROM, a flash ROM. Otherwise, it may be a storage medium for the heat assisted magnetic recording/reproduction scheme.

Further, since the present invention can be made as a structure accessible to a communications network including the Internet, the media may be one fluidly carries the program code so that the program can be downloaded via the communications network. More specifically, the program may be obtained through a transmission medium (the medium fluidly carrying the program), such as a network (a network connected to a wired/wireless line).

Further, in the case of thus downloading a program from the communication network, the program to be downloaded may be either previously stored in the main body or installed from a different storage medium.

The present invention may be characterized in that the storage medium is used as a heatsink of the semiconductor laser and the electronic device provided in the elevated slider. Further, the present invention may be characterized by realizing (i) a driving method of the semiconductor laser ensuring sufficient heat dissipation from the elevated slider to the storage medium, and (ii) a read/write device adopting a heat assisted magnetic recording/reproduction scheme.

Further, the present invention may be characterized by its appropriate heat conductivity of the storage medium in the radial direction, and by comprising a heat dissipation mechanism for ensuring heat dissipation from the storage medium to outside the housing. Further, the present invention provides a driving method of compensating for thermal distribution of the storage medium in the radial direction, and the method is preferably combined with the foregoing respective arrangements.

A read/write device of the present invention, in order to solve the above problem, is a read/write device for writing and reading a storage medium by way of a heat assisted magnetic recording/reproduction scheme, the read/write device including an elevated slider provided with a semiconductor laser, the read/write device including: a heat dissipation mechanism for dissipating heat generated in the elevated slider to an outside of a housing of the read/write device.

According to the above arrangement, heat generated from the semiconductor laser provided to the elevated slider can be effectively dissipated to the outside of the housing of the read/write device. This arrangement limits temperature rises in the elevated slider and the storage medium. Thus, the occurrence of malfunction due to these temperature rises is prevented.

A read/write device of the present invention may be such that the elevated slider has a convex section, as the heat dissipation mechanism, for restricting air flow caused between the storage medium and the elevated slider, on a storage medium facing surface of the elevated slider.

According to the above arrangement, it is possible to encourage heat movement between the storage medium and the elevated slider, so that heat generated in the elevated slider can be effectively dissipated to the outside of the housing of the read/write device through the storage medium. This arrangement limits temperature rises in the elevated slider and the storage medium. Thus, the occurrence of malfunction due to these temperature rises is prevented.

Further, it is preferable that an area of the convex section is 3.5×10⁻⁸ m² or more. This allows for effective heat movement between the storage medium and the elevated slider.

Still further, it is preferable that when the elevated slider is fabricated out of a substrate of the semiconductor laser, the following equation is satisfied:

$${\int }_{S} \frac{1}{L} ⅆ s \geq 0.4 [ m ]$$

where ds is an area of a small region of a storage-medium facing surface of the elevated slider, L(s) is a distance between the small region and the storage medium, and S is a sum area of the storage-medium facing surface of the elevated slider.

Yet further, when the semiconductor laser is joined to the elevated slider with solder, the following equation is satisfied:

$${\int }_{S} \frac{1}{L} ⅆ s \geq 0.5 [ m ]$$

where ds is an area of a small region of a storage-medium facing surface of the elevated slider, L(s) is a distance between the small region and the storage medium, and S is a sum area of the storage-medium facing surface of the elevated slider.

Any of the above arrangements allows for effective heat movement between the storage medium and the elevated slider.

A read/write device of the present invention may be arranged so as to include: a pivot, in thermal contact with the storage medium, for driving the storage medium so that it rotates; and the pivot comprises a heat dissipation mechanism for dissipating heat conducted from the storage medium, to the outside of the housing of the read/write device.

According to the above arrangement, heat generated from the elevated slider can be effectively dissipated to the outside of the housing of the read/write device through the storage medium and the pivot. This arrangement limits temperature rises in the elevated slider and the storage medium. Thus, the occurrence of malfunction due to these temperature rises is prevented.

Further, a read/write device of the present invention may be arranged such that the pivot has a structure like a cylinder with a hollow site, and the hollow site is open to an external air of an outside of the housing of the read/write device.

According to the above arrangement, heat generated from the elevated slider can be dissipated to an external air of the hollow site through the storage medium and the pivot. This arrangement limits temperature rises in the elevated slider and the storage medium. Thus, the occurrence of malfunction due to these temperature rises is prevented.

Still further, a read/write device of the present invention may be such that as the heat dissipation mechanism, a flow restriction mechanism for restricting air flow in the hollow site is provided on an internal surface of the pivot. Alternatively, a read/write device of the present invention may be such that as the heat dissipation mechanism, a flow restriction mechanism for restricting air flow in the hollow site is provided in the hollow site or to an aperture for the external air of the hollow site.

According to these arrangements, heat generated from the elevated slider can be dissipated to an external air of the hollow site through the storage medium and the pivot. This arrangement limits temperature rises in the elevated slider and the storage medium. Thus, the occurrence of malfunction due to these temperature rises is prevented.

Yet further, a read/write device of the present invention may be such that the pivot is provided in the housing and rotatably supported by a fluid axis support, and the fluid axis support functions as the heat dissipation mechanism.

According to the above arrangement, heat generated from the elevated slider can be conducted to the housing and dissipated to the outside of the housing through the storage medium and the pivot. This arrangement limits temperature rises in the elevated slider and the storage medium. Thus, the occurrence of malfunction due to these temperature rises is prevented.

Further, a read/write device of the present invention may be such that as the heat dissipation mechanism, a heatsink, which is provided substantially parallel to the storage medium, is thermally connected to the housing or is partially protruded outside the housing.

According to the above arrangement, heat generated from the elevated slider can be dissipated to the outside of the housing through the storage medium and the heatsink. This arrangement limits temperature rises in the elevated slider and the storage medium. Thus, the occurrence of malfunction due to these temperature rises is prevented.

Note that, in the above arrangement, it is preferable that a distance between the storage medium and the heatsink is 5 mm or less.

According to the above arrangement, a 5 mm or less distance between the storage medium and the heatsink allows heat generated from the elevated slider to be effectively conducted to the heatsink through the storage medium, thus effectively dissipating the heat to the outside of the housing.

Further, in the above arrangement, it is preferable that the heatsink is provided in such a shape so as to decrease a temperature distribution in the storage medium.

According to the above arrangement, it is possible to reduce the temperature distribution in the storage. This enables writing and reading without falling of the S/N ratio.

Still further, a read/write device of the present invention may be such that as the heat dissipation mechanism provided are (i) a convection mechanism which generates convection in an internal space of the housing and (ii) a cooling mechanism which dissipates heat in the internal space of the housing to the outside of the housing.

According to the above arrangement, the convection mechanism and the cooling mechanism can effectively dissipate heat generated from the elevated slider to the outside of the housing. This arrangement limits temperature rises in the elevated slider and the storage medium. Thus, the occurrence of malfunction due to these temperature rises is prevented.

Yet further, a read/write device of the present invention may be such that the housing is provided with a tiny hole for air pressure control, and the internal space of the housing, except for the tiny hole of the housing, is disconnected from the external air outside the housing.

According to the above arrangement, it is possible to suitably dissipate heat in the internal space of the housing to the outside of the housing although the internal space of the housing is substantially avoided exposure to the external air. This limits temperature rises in the elevated slider and the storage medium and allows for a stable drive.

A read/write device of the present invention may be include: a magnetic head, provided in the elevated slider, for writing and reading information with respect to the storage medium; and an auxiliary heat source for heating, to a magnetic compensation temperature, a region on the storage medium which overlaps the magnetic head when viewed from a perpendicular direction with respect to a recording surface of the storage medium, and which does not include a region heated by a laser beam emitted from the semiconductor laser.

According to the above arrangement, a region around the recording region in the storage medium can be in a magnetic compensation temperature, and residual magnetization in this region can be approximately zero. This enables writing and reading with an improved S/N ratio.

A read/write device of the present invention may be arranged such that the auxiliary heat source comprises an auxiliary semiconductor laser, and the storage medium is irradiated with a laser beam of the auxiliary semiconductor laser, passing through the elevated slider.

According to the above arrangement, it is possible to prevent a laser beam emitted from the auxiliary semiconductor laser from raising the temperature of the elevated slider. That is, this arrangement limits temperature rises in the elevated slider and the storage medium. Thus, the occurrence of malfunction due to these temperature rises is prevented.

In the above arrangement, the elevated slider may be provided with a spot-shape altering section for altering a spot shape, on the storage medium, of the laser beam of the auxiliary semiconductor laser.

With this arrangement, it is possible to suitably heat, to a magnetic compensation temperature, a region on the storage medium which overlaps the magnetic head when viewed from a perpendicular direction with respect to a recording surface of the storage medium, and which does not include a region heated by a laser beam emitted from the semiconductor laser.

Further, a read/write device of the present invention may be such that in a storage medium facing surface of the elevated slider, a part facing a spot region, on the storage medium, which is irradiated with a laser beam emitted from the auxiliary semiconductor is separated from the storage medium at a distance more than a distance between the other part of the storage medium facing surface and the storage medium.

According to the above arrangement, heat in the spot region on the storage medium can be prevented from flowing to the elevated slider. This limits temperature rise in the elevated slider. Thus, the occurrence of malfunction due to this temperature rise is prevented.

Still further, a read/write device of the present invention may be arranged such that the auxiliary heat source is provided to the elevated slider through a heat block layer.

According to the above arrangement, heat from the auxiliary heat source can be prevented from being conducted to the elevated slider. This limits temperature rise in the elevated slider. Thus, the occurrence of malfunction due to this temperature rise is prevented.

The semiconductor laser may be a Fabry-Perot resonator structure. Further, the semiconductor laser may be a nitride semiconductor laser including a light-emitting layer containing Ga and In as chef components. Still further, the semiconductor laser is a nitride semiconductor laser including a substrate containing Ga as a chief component.

Further, the read/write device of the present invention may be such that the semiconductor laser, which is an edge-emitting semiconductor laser, is provided with a near-field light emitting mechanism on its edge. Still further, the read/write device of the present invention may be such that the semiconductor laser, which is an edge-emitting semiconductor laser, is provided with a metal containing film on its edge, and the metal containing film is provided with a tiny aperture smaller than a near-field pattern of the semiconductor laser.

According to the above arrangements, a threshold current can be reduced by decreasing scattering of light which is not involved in the heating of any recording regions, which hence reduces power consumption by the semiconductor laser. This arrangement limits temperature rises in the elevated slider and the storage medium. Thus, the occurrence of malfunction due to these temperature rises is prevented.

A read/write device of the present invention may be such that the semiconductor laser, which is an edge-emitting semiconductor laser, is provided with a high reflection film on its edge.

According to the above arrangement, an edge loss on the edge can be lowered. This reduces the threshold current of the semiconductor laser, thus reducing power consumption. This limits temperature rises in the elevated slider and the storage medium. Thus, the occurrence of malfunction due to these temperature rises is prevented.

Further, the semiconductor laser may be a combined structure of a Fabry-Perot resonator structure and a ring waveguide. Alternatively, the semiconductor laser may be a combined structure of a Fabry-Perot resonator structure and a cylindrical waveguide.

According to the above arrangement, there occurs optical tunneling effect from the ring waveguide or the cylindrical waveguide to the storage medium. This allows for heat assisted magnetic recording and reproduction.

Yet further, the semiconductor laser may be realized by a microdisc resonator.

A read/write device of the present invention, in order to solve the above problem, is a read/write device for writing and reading a storage medium by way of a heat assisted magnetic recording/reproduction scheme, the read/write device including an elevated slider provided with a semiconductor laser, the read/write device comprising: an elevation mechanism which elevates the elevated slider above an elevated position the elevated slider takes during writing or reading operation, wherein: only when the elevated slider is in the elevated position the elevated slider takes during writing or reading operation, current is injected to the semiconductor laser.

According to the above arrangement, heat from the semiconductor laser can be reduced. This limits temperature rises in the elevated slider and the storage medium. Thus, the occurrence of malfunction due to these temperature rises is prevented.

A read/write device of the present invention, in order to solve the above problem, is a read/write device for writing and reading a storage medium by way of a heat assisted magnetic recording/reproduction scheme, the read/write device including an elevated slider provided with a semiconductor laser, the read/write device comprising: a control section for controlling an operational power for the semiconductor laser in accordance with a writing/reading position on the storage medium.

According to the above arrangement, the operational power for the semiconductor laser is controlled in accordance with a writing/reading position on the storage medium, which allows for reduction of the operational power for the semiconductor laser. This lowers temperature rises in the elevated slider and the storage medium. Thus, the elevated slider and the storage medium are prevented from malfunctioning due to temperature rises.

Further, according to the above arrangement, the operational power for the semiconductor laser is controlled in accordance with a writing/reading position on the storage medium, which allows for decrease of heat distribution in the storage medium. This enables writing and reading without falling of the S/N ratio.

The control section may control an operational power for the semiconductor laser so that a temperature in a region, on the storage medium, which is irradiated with a laser beam of the semiconductor laser during writing or reading operation is held constant regardless of a position on the storage medium.

According to the above arrangement, the operational power for the semiconductor laser can be reduced. The temperature in the region, on the storage medium, which is irradiated with a laser beam of the semiconductor laser during writing or reading operation is held constant regardless of a position on the storage medium, so that it is possible to write and read without falling of the S/N ratio.

Further, in the above arrangement, the read/write device of the present invention may include temperature measurement means for measuring a temperature of the writing/reading position on the storage medium. Note that, in this case, the read/write device of the present invention may be arranged such that a drive current for the semiconductor laser during writing and reading operation is a pulse current, and a temperature of the storage medium is measured by injection of a pulse current that is different from the drive current into the semiconductor laser.

According to the above arrangement, a temperature of the writing/reading position on the storage medium is measured, and according to this measurement result, the operational power for the semiconductor laser can be controlled. Therefore, it is possible to control the operational power for the semiconductor laser in a suitable manner.

Still further, the control section may control an operational power for the semiconductor laser in accordance with temperature variation of the storage medium that occurs with a seek during operation of the elevated slider.

According to the above arrangement, the operational power for the semiconductor laser can be controlled in accordance with temperature variation of the storage medium that occurs with a seek during operation of the elevated slider, so that it is possible to control the operational power for the semiconductor laser in a suitable manner.

Yet further, the control section may control an operational power for the semiconductor laser in accordance with temperature variation of the storage medium that occurs with change in ambient temperature.

According to the above arrangement, an operational power for the semiconductor laser can be controlled in accordance with temperature variation of the storage medium that occurs with change in ambient temperature, so that it is possible to control the operational power for the semiconductor laser in a suitable manner.

The control section may control an operational power for the semiconductor laser by compensating for an increased amount of heat due to deterioration of the semiconductor laser.

It is known that the semiconductor laser decreases in performance and increases in threshold with its use. According to the above arrangement, an operational power for the semiconductor laser can be controlled suitably by compensating for an increased amount of heat due to deterioration of the semiconductor laser.

A read/write device of the present invention, in order to the solve the above problem, is a read/write device for writing and reading a storage medium by way of a heat assisted magnetic recording/reproduction scheme, the read/write device including an elevated slider provided with a semiconductor laser, the read/write device comprising: a control section which obtains a temperature of the elevated slider; creates time-series data on temperature of the elevated slider from obtained temperature data; extracts, from the created time-series data on temperature of the elevated slider, temperature variation that occurs with a seek during operation of the elevated slider and temperature variation that occurs with change in ambient temperature so as to create time-series data on increased amount of heat due to deterioration of the semiconductor laser; and estimates life of the semiconductor laser in accordance with the time-series data on increased amount of heat.

According to the above arrangement, life of the semiconductor laser can be obtained properly, so that a stable drive is possible.

Further, the control section may automatically writes information having been stored in the storage medium on another storage medium before the semiconductor laser becomes unable to read. Still further, the control section may present a deterioration condition of the semiconductor laser to a user.

According to the above arrangement, life of the semiconductor laser can be obtained properly, so that it is possible to prevent loss of information written by the read/write device.

A read/write device of the present invention, in order to solve the problem, is a read/write device for writing and reading a storage medium by way of a heat assisted magnetic recording/reproduction scheme, the read/write device including an elevated slider provided with a semiconductor laser, the read/write device comprising: an elevation mechanism which elevates the elevated slider above an elevated position the elevated slider takes during writing or reading operation; and a control section which, in order to move the elevated slider to the elevated position, controls to pass a small amount of current in advance through an electronic device provided in the elevated slider so that the electronic device is preheated.

According to the above arrangement, in order to move the elevated slider to the elevated position, a small amount of current is passed in advance through an electronic device provided in the elevated slider so that the electronic device is preheated. This reduces access time to the electronic device and allows for a stable drive.

A storage medium of the present invention, in order to solve the above problem, is a storage medium which is written or read by way of a heat assisted magnetic recording/reproduction scheme, the storage medium comprising: a plurality of layers including a substrate, wherein: a sum of a thermal conductivity times thickness of each layer is 5×10⁻³ W/° C. or more. The storage medium is more preferably arranged such that a sum of a thermal conductivity times thickness of each layer is 20×10⁻³ W/° C. or more.

According to the above arrangement, for example, the storage medium is in thermal connection with the read/write device for writing or reading, so that it is possible to encourage heat dissipation to the read/write device. This decreases temperature rise in the storage medium during writing or reading operation, and prevents the occurrence of malfunctions due to this temperature rise. Further, heat distribution in the storage medium can be decreased. This enables writing and reading without falling of the S/N ratio.

The storage medium of the invention may be arranged so as to include: a plurality of layers including a glass substrate, a recording layer, and a heatsink layer, wherein: the thermal conductivity times thickness of the heatsink layer is greater than the thermal conductivity times thickness of the glass substrate.

According to the above arrangement, the thermal conductivity in the storage medium increases. Therefore, for example, the storage medium is in thermal connection with the read/write device for writing or reading, so that it is possible to encourage heat dissipation to the read/write device. This decreases temperature rise in the storage medium during writing or reading operation, and prevents the occurrence of malfunctions due to this temperature rise. Further, heat distribution in the storage medium can be decreased. This enables writing and reading without falling of the S/N ratio.

The heatsink layer may be provided between the glass substrate and the recording layer. This arrangement limits temperature rise in the storage medium. Thus, the occurrence of malfunction due to this temperature rise is prevented.

The storage medium of the present invention may be such that between the recording layer and the heatsink layer provided is a heat barrier layer having a thermal conductivity lower than the heatsink layer.

Provision of the heat barrier layer allows for a suitable adjustment of the rate of temperature changes in the recording region. That is, too much increase in the temperature change rate may not raise the temperature of the recording region to a temperature necessary for writing. However, provision of the heat barrier layer allows the temperature of the recording region to be adjusted to a temperature necessary for writing in a suitable manner.

The heatsink layer may be provided on the other side of the glass substrate from the recording layer. This arrangement also limits temperature rise in the storage medium. Thus, the occurrence of malfunction due to this temperature rise is prevented.

Further, the storage medium may be include: a plurality of layers including a glass substrate, two recording layers, and a heatsink layer, wherein: the heatsink layer is provided between the glass substrate and one of the recording layers, with a heat barrier layer being provided between the heatsink layer and the glass substrate, and the other recording layer being provided on the other side of the glass substrate from the one of the recording layers, the heat barrier layer having a thermal conductivity lower than the heatsink layer.

According to the above arrangement, in a storage medium including recording layers provided on both sides of the substrate, temperature rise in the storage medium is limited and the occurrence of malfunction due to this temperature rise is prevented.

Still further, the heatsink layer preferably has a thermal conductivity of 100 W/m/° C. or more and a thickness of 10 μm or more. Yet further, the heatsink layer may contain any of Al, Ag, Au, and Cu.

The storage medium may be arranged such that the substrate is formed of Al or sapphire. By using the substrate formed of a high thermal conductivity material, such as sapphire and Al, a steady heat response can be achieved with respect to a heat flow from the read/write device for writing or reading the storage medium to the storage medium. This allows for a stable drive.

The storage medium is a storage medium used in a read/write device for writing and reading a storage medium by way of a heat assisted magnetic recording/reproduction scheme using a semiconductor laser and a magnetic head, wherein: a magnetic compensation temperature, when the semiconductor laser is driven with a maximum operational power for writing or reading of the storage medium, is set higher than a maximum temperature in a region on the storage medium which overlaps the magnetic head when viewed from a perpendicular direction with respect to a recording surface of the storage medium, and which does not include a region heated by a laser beam emitted from the semiconductor laser.

A driving method of a read/write device of the present invention, in order to solve the above problem, is a driving method of a read/write device for writing and reading a storage medium by way of a heat assisted magnetic recording/reproduction scheme, the read/write device including an elevated slider provided with a semiconductor laser, the method comprising the step of: obtaining a temperature of the elevated slider in a writing/reading position, wherein: an operational power for the semiconductor laser is controlled so that a temperature in a region, on the storage medium, which is irradiated with a laser beam of the semiconductor laser is held constant regardless of a position on the storage medium.

According to the above driving method, the operational power for the semiconductor laser can be reduced, which limits temperature rises in the elevated slider and the storage medium and hence prevents the occurrence of malfunction due to these temperature rises.

Moreover, a temperature in a region which is irradiated with a laser beam of the semiconductor laser is held constant regardless of a position on the storage medium, which allows for decrease of heat distribution in the storage medium. This enables writing and reading without falling of the S/N ratio.

The driving method of a read/write device may be arranged so as to include the step of: obtaining temperature variation that occurs with a seek during operation of the elevated slider, wherein: an operational power for the semiconductor laser is controlled in accordance with the temperature variation that occurs with a seek during operation of the elevated slider.

According to the above driving method, an operational power for the semiconductor laser is controlled in accordance with the temperature variation that occurs with a seek during operation of the elevated slider, so that it is possible to control the operational power for the semiconductor laser in a suitable manner.

The driving method of a read/write device may be arranged so as to include the step of: obtaining temperature variation of the elevated slider that occurs with the change in ambient temperature, wherein: an operational power for the semiconductor laser is controlled in accordance with the temperature variation that occurs with the change in ambient temperature.

According to the above driving method, an operational power for the semiconductor laser is controlled in accordance with the temperature variation that occurs with the change in ambient temperature, so that it is possible to control the operational power for the semiconductor laser in a suitable manner.

The driving method of a read/write device may be arranged so as to include the step of: obtaining temperature variation of the elevated slider that occurs with heat increase due to deterioration of the semiconductor laser provided to the elevated slider, wherein: an operational power for the semiconductor laser is controlled by compensation for an increased amount of heat due to deterioration of the semiconductor laser.

It is known that the semiconductor laser decreases in performance and increases in threshold with its use. According to the above arrangement, an operational power for the semiconductor laser can be controlled suitably by compensating for such an increased amount of heat due to deterioration of the semiconductor laser.

A driving method of a read/write device according to the present invention, in order to solve the above problem, is a driving method of a read/write device for writing and reading a storage medium by way of a heat assisted magnetic recording/reproduction scheme, the read/write device including (i) an elevated slider provided with a semiconductor laser and (ii) an elevation mechanism which elevates the elevated slider above an elevated position the elevated slider takes during writing or reading of the storage medium, wherein: in order to move the elevated slider to the elevated position for writing or reading, a small amount of current is passed in advance through an electronic device provided in the elevated slider so that the electronic device is preheated.

According to the above driving method, in order to move the elevated slider to the elevated position, a small amount of current is passed in advance through an electronic device, such as a semiconductor laser, provided in the elevated slider so that the electronic device is preheated. This reduces access time to the electronic device and allows for a stable drive.

A life estimation method of a semiconductor laser according to the present invention, in order to solve the above problem, is a life estimation method of a semiconductor laser in a read/write device for writing and reading a storage medium by way of a heat assisted magnetic recording/reproduction scheme, the read/write device including an elevated slider provided with a semiconductor laser, the method comprising the steps of: obtaining a temperature of the elevated slider; generating time-series data on temperature of the elevated slider from the obtained temperature data; extracting, from the created time-series data on temperature of the elevated slider, temperature variation that occurs with a seek during operation of the elevated slider and temperature variation that occurs with change in ambient temperature so as to create time-series data on increased amount of heat due to deterioration of the semiconductor laser; and estimating life of the semiconductor laser in accordance with the time-series data on increased amount of heat. According to this method, life of the semiconductor laser can be obtained properly, and a stable drive based on a obtained result is possible.

Further, a program of the present invention is one for causing a computer provided in a read/write device to function as a control section of the read/write device. By causing such a computer to read the program, it is possible to realize processing of the control section in the read/write device of the present invention with the computer.

Moreover, storage of the program in a computer-readable storage medium facilitates storage and distribution of programs. By causing a computer provided in the read/write device to read the program stored in the above storage medium, it is possible to realize processing of the control section in the read/write device of the present invention with the computer.

A series of data signals according to the present invention is a series of data signals of the above program. For example, by receiving the series of data signals transmitted with embodied in a carrier wave, and causing a computer provided in a read/write device to execute the program, it is possible to cause this computer to execute processing of the control section in the read/write device of the present invention.

A semiconductor laser of the present invention is a combined structure of (i) a Fabry-Perot resonator structure which generates stimulated emission of radiation and (ii) a ring waveguide which generates a whispering gallery mode. Further, a semiconductor laser of the present invention is a combined structure of (i) a Fabry-Perot resonator structure which generates stimulated emission of radiation and (ii) a cylindrical waveguide which generates a whispering gallery mode.

According to the above arrangement, a stimulated emission of radiation generated by the Fabry-Perot resonator structure is partially guided to a ring waveguide or a cylindrical waveguide and then coupled with a whispering gallery mode in the ring waveguide or the cylindrical waveguide. Therefore, part of the ring waveguide or the cylindrical waveguide can be come close to the storage medium. This causes an optical tunneling effect from the ring waveguide or the cylindrical waveguide to the storage medium, which allows for a stable heat assisted magnetic recording and reproduction.

Note that, the present invention is applicable to a read/write device which writes and reads information by way of a heat assisted magnetic recording/reproduction scheme using a semiconductor laser.

Specific embodiments or examples implemented in the description of the embodiments only show technical features of the present invention and are not intended to limit the scope of the invention. Variations can be effected within the spirit of the present invention and the scope of the following claims.

1. A read/write device for writing and reading a storage medium by way of a heat assisted magnetic recording/reproduction scheme, the read/write device including an elevated slider provided with a semiconductor laser,
the read/write device comprising:
a heat dissipation mechanism for dissipating heat generated in the elevated slider to an outside of a housing of the read/write device.

2. The read/write device according to claim 1, wherein:
the elevated slider has a convex section, as the heat dissipation mechanism, for restricting air flow caused between the storage medium and the elevated slider, on a storage medium facing surface of the elevated slider.

3. The read/write device according to claim 1, wherein:
an area of the convex section is 3.5×10⁻⁸ m² or more.

4. The read/write device according to claim 1, wherein:
the elevated slider is fabricated out of a substrate of the semiconductor laser, and
the following equation is satisfied:
$${\int }_{S} \frac{1}{L} ⅆ s \geq 0.4 [ m ]$$
where ds is an area of a small region of a storage-medium facing surface of the elevated slider, L(s) is a distance between the small region and the storage medium, and S is a sum area of the storage-medium facing surface of the elevated slider.

5. The read/write device according to claim 1, wherein:
the semiconductor laser is joined to the elevated slider with solder, and
the following equation is satisfied:
$${\int }_{S} \frac{1}{L} ⅆ s \geq 0.5 [ m ]$$
where ds is an area of a small region of a storage-medium facing surface of the elevated slider, L(s) is a distance between the small region and the storage medium, and S is a sum area of the storage-medium facing surface of the elevated slider.

6. The read/write device according to claim 1, further comprising:
a pivot, in thermal contact with the storage medium, for driving the storage medium so that it rotates, and
the pivot comprises a heat dissipation mechanism for dissipating heat conducted from the storage medium, to the outside of the housing of the read/write device.

7. The read/write device according to claim 6, wherein:
the pivot has a structure like a cylinder with a hollow site, and
the hollow site is open to an external air of an outside of the housing of the read/write device.

8. The read/write device according to claim 7, wherein:
as the heat dissipation mechanism, a flow restriction mechanism for restricting air flow in the hollow site is provided on an internal surface of the pivot.

9. The read/write device according to claim 7, wherein:
as the heat dissipation mechanism, a flow restriction mechanism for restricting air flow in the hollow site is provided in the hollow site or to an aperture for the external air of the hollow site.

10. The read/write device according to claim 6, wherein:
the pivot is provided in the housing and rotatably supported by a fluid axis support, and
the fluid axis support functions as the heat dissipation mechanism.

11. The read/write device according to claim 1, wherein:
as the heat dissipation mechanism, a heatsink, which is provided substantially parallel to the storage medium, is thermally connected to the housing or is partially protruded outside the housing.

12. The read/write device according to claim 11, wherein:
a distance between the storage medium and the heatsink is 5 mm or less.

13. The read/write device according to claim 11, wherein:
the heatsink is provided in such a shape so as to decrease a temperature distribution in the storage medium.

14. The read/write device according to claim 1, wherein:
as the heat dissipation mechanism provided are (i) a convection mechanism which generates convection in an internal space of the housing and (ii) a cooling mechanism which dissipates heat in the internal space of the housing to the outside of the housing.

15. The read/write device according to claim 14, wherein:
the housing is provided with a tiny hole for air pressure control, and the internal space of the housing, except for the tiny hole of the housing, is disconnected from the external air outside the housing.

16. The read/write device according to claim 1, further comprising:
a magnetic head, provided in the elevated slider, for writing and reading information with respect to the storage medium; and
an auxiliary heat source for heating, to a magnetic compensation temperature, a region on the storage medium which overlaps the magnetic head when viewed from a perpendicular direction with respect to a recording surface of the storage medium, and which does not include a region heated by a laser beam emitted from the semiconductor laser.

17. The read/write device according to claim 16, wherein:
the auxiliary heat source comprises an auxiliary semiconductor laser, and
the storage medium is irradiated with a laser beam of the auxiliary semiconductor laser, passing through the elevated slider.

18. The read/write device according to claim 17, wherein:
the elevated slider is provided with a spot-shape altering section for altering a spot shape, on the storage medium, of the laser beam of the auxiliary semiconductor laser.

19. The read/write device according to claim 17, wherein:
in a storage medium facing surface of the elevated slider,
a part facing a spot region, on the storage medium, which is irradiated with a laser beam emitted from the auxiliary semiconductor is separated from the storage medium at a distance more than a distance between the other part of the storage medium facing surface and the storage medium.

20. The read/write device according to claim 16, wherein:
the auxiliary heat source is provided to the elevated slider through a heat block layer.

21. The read/write device according to claim 1, wherein:
the semiconductor laser is a Fabry-Perot resonator structure.

22. The read/write device according to claim 1, wherein:
the semiconductor laser is a nitride semiconductor laser including a light-emitting layer containing Ga and In as chef components.

23. The read/write device according to claim 1, wherein:
the semiconductor laser is a nitride semiconductor laser including a substrate containing Ga as a chief component.

24. The read/write device according to claim 1, wherein:
the semiconductor laser, which is an edge-emitting semiconductor laser, is provided with a metal containing film on its edge, and
the metal containing film is provided with a tiny aperture smaller than a near-field pattern of the semiconductor laser.

25. The read/write device according to claim 1, wherein:
the semiconductor laser, which is an edge-emitting semiconductor laser, is provided with a high reflection film on its edge.

26. The read/write device according to claim 1, wherein:
the semiconductor laser is a combined structure of a Fabry-Perot resonator structure and a ring waveguide.

27. The read/write device according to claim 1, wherein:
the semiconductor laser is a combined structure of a Fabry-Perot resonator structure and a cylindrical waveguide.

28. The read/write device according to claim 1, wherein:
the semiconductor laser is realized by a microdisc resonator.

29. A read/write device for writing and reading a storage medium by way of a heat assisted magnetic recording/reproduction scheme, the read/write device including an elevated slider provided with a semiconductor laser,
the read/write device comprising:
an elevation mechanism which elevates the elevated slider above an elevated position the elevated slider takes during writing or reading operation,
wherein:
only when the elevated slider is in the elevated position the elevated slider takes during writing or reading operation, current is injected to the semiconductor laser.

30. A read/write device for writing and reading a storage medium by way of a heat assisted magnetic recording/reproduction scheme, the read/write device including an elevated slider provided with a semiconductor laser,
the read/write device comprising:
a control section for controlling an operational power for the semiconductor laser in accordance with a writing/reading position on the storage medium.

31. The read/write device according to claim 30, wherein:
the control section controls an operational power for the semiconductor laser so that a temperature in a region, on the storage medium, which is irradiated with a laser beam of the semiconductor laser during writing or reading operation is held constant regardless of a position on the storage medium.

32. The read/write device according to claim 31, further comprising:
temperature measurement means for measuring a temperature of the writing/reading position on the storage medium.

33. The read/write device according to claim 32, wherein:
a drive current for the semiconductor laser during writing and reading operation is a pulse current, and
a temperature of the storage medium is measured by injection of a pulse current that is different from the drive current into the semiconductor laser.

34. The read/write device according to claim 30, wherein:
the control section controls an operational power for the semiconductor laser in accordance with temperature variation of the storage medium that occurs with a seek during operation of the elevated slider.

35. The read/write device according to claim 30, wherein:
the control section controls an operational power for the semiconductor laser in accordance with temperature variation of the storage medium that occurs with change in ambient temperature.

36. The read/write device according to claim 30, wherein:
the control section controls an operational power for the semiconductor laser by compensating for an increased amount of heat due to deterioration of the semiconductor laser.

37. A read/write device for writing and reading a storage medium by way of a heat assisted magnetic recording/reproduction scheme, the read/write device including an elevated slider provided with a semiconductor laser,
the read/write device comprising:
a control section which obtains a temperature of the elevated slider; creates time-series data on temperature of the elevated slider from obtained temperature data; extracts, from the created time-series data on temperature of the elevated slider, temperature variation that occurs with a seek during operation of the elevated slider and temperature variation that occurs with change in ambient temperature so as to create time-series data on increased amount of heat due to deterioration of the semiconductor laser; and estimates life of the semiconductor laser in accordance with the time-series data on increased amount of heat.

38. The read/write device according to claim 37, wherein:
the control section automatically writes information having been stored in the storage medium on another storage medium before the semiconductor laser becomes unable to read.

39. The read/write device according to claim 37, wherein:
the control section presents a deterioration condition of the semiconductor laser to a user.

40. A read/write device for writing and reading a storage medium by way of a heat assisted magnetic recording/reproduction scheme, the read/write device including an elevated slider provided with a semiconductor laser,
the read/write device comprising:
an elevation mechanism which elevates the elevated slider above an elevated position the elevated slider takes during writing or reading operation; and
a control section which, in order to move the elevated slider to the elevated position, controls to pass a small amount of current in advance through an electronic device provided in the elevated slider so that the electronic device is preheated.

41. A storage medium which is written or read by way of a heat assisted magnetic recording/reproduction scheme, the storage medium comprising:
a plurality of layers including a substrate,
wherein:
a sum of a thermal conductivity times thickness of each layer is 5×10⁻³ W/° C. or more.

42. The storage medium according to claim 41, wherein:
a sum of a thermal conductivity times thickness of each layer is 20×10⁻³ W/° C. or more.

43. The storage medium according to claim 41, comprising:
a plurality of layers including a glass substrate, a recording layer, and a heatsink layer,
wherein:
the thermal conductivity times thickness of the heatsink layer is greater than the thermal conductivity times thickness of the glass substrate.

44. The storage medium according to claim 43, wherein:
the heatsink layer is provided between the glass substrate and the recording layer.

45. The storage medium according to claim 44, wherein:
between the recording layer and the heatsink layer provided is a heat barrier layer having a thermal conductivity lower than the heatsink layer.

46. The storage medium according to claim 45, wherein:
the heatsink layer is provided on the other side of the glass substrate from the recording layer.

47. The storage medium according to claim 43, comprising:
a plurality of layers including a glass substrate, two recording layers, and a heatsink layer,
wherein:
the heatsink layer is provided between the glass substrate and one of the recording layers, with a heat barrier layer being provided between the heatsink layer and the glass substrate, and the other recording layer being provided on the other side of the glass substrate from the one of the recording layers, the heat barrier layer having a thermal conductivity lower than the heatsink layer.

48. The storage medium according to claim 43, wherein:
the heatsink layer has a thermal conductivity of 100 W/m/° C. or more and a thickness of 10 μm or more.

49. The storage medium according to claim 43, wherein:
the heatsink layer contains any of Al, Ag, Au, and Cu.

50. The storage medium according to claim 41, wherein:
the substrate is formed of Al or sapphire.

51. The storage medium according to claim 41, which is written or read by a read/write device for writing and reading a storage medium by way of a heat assisted magnetic recording/reproduction scheme using a semiconductor laser and a magnetic head,
wherein:
a magnetic compensation temperature, when the semiconductor laser is driven with a maximum operational power for writing or reading of the storage medium, is set higher than a maximum temperature in a region on the storage medium which overlaps the magnetic head when viewed from a perpendicular direction with respect to a recording surface of the storage medium, and which does not include a region heated by a laser beam emitted from the semiconductor laser.

52. A driving method of a read/write device for writing and reading a storage medium by way of a heat assisted magnetic recording/reproduction scheme, the read/write device including an elevated slider provided with a semiconductor laser,
the method comprising the step of:
obtaining a temperature of the elevated slider in a writing/reading position,
wherein:
an operational power for the semiconductor laser is controlled so that a temperature in a region, on the storage medium, which is irradiated with a laser beam of the semiconductor laser is held constant regardless of a position on the storage medium.

53. The method according to claim 52, further comprising the step of:
obtaining temperature variation that occurs with a seek during operation of the elevated slider,
wherein:
an operational power for the semiconductor laser is controlled in accordance with the temperature variation that occurs with a seek during operation of the elevated slider.

54. The method according to claim 52, further comprising the step of:
obtaining temperature variation of the elevated slider that occurs with the change in ambient temperature,
wherein:
an operational power for the semiconductor laser is controlled in accordance with the temperature variation that occurs with the change in ambient temperature.

55. The method according to claim 52, further comprising the step of:
obtaining temperature variation of the elevated slider that occurs with heat increase due to deterioration of the semiconductor laser provided to the elevated slider,
wherein:
an operational power for the semiconductor laser is controlled by compensation for an increased amount of heat due to deterioration of the semiconductor laser.

56. A driving method of a read/write device for writing and reading a storage medium by way of a heat assisted magnetic recording/reproduction scheme, the read/write device including (i) an elevated slider provided with a semiconductor laser and (ii) an elevation mechanism which elevates the elevated slider above an elevated position the elevated slider takes during writing or reading of the storage medium,
wherein:
in order to move the elevated slider to the elevated position for writing or reading, a small amount of current is passed in advance through an electronic device provided in the elevated slider so that the electronic device is preheated.

57. A life estimation method of a semiconductor laser in a read/write device for writing and reading a storage medium by way of a heat assisted magnetic recording/reproduction scheme, the read/write device including an elevated slider provided with a semiconductor laser,
the method comprising the steps of:
obtaining a temperature of the elevated slider;
generating time-series data on temperature of the elevated slider from obtained temperature data;
extracting, from the created time-series data on temperature of the elevated slider, temperature variation that occurs with a seek during operation of the elevated slider and temperature variation that occurs with change in ambient temperature so as to create time-series data on increased amount of heat due to deterioration of the semiconductor laser; and
estimating life of the semiconductor laser in accordance with the time-series data on increased amount of heat.

58. A program for causing a computer, provided in a read/write device for writing and reading a storage medium by way of a heat assisted magnetic recording/reproduction scheme, the read/write device including an elevated slider provided with a semiconductor laser, to function as a control section which controls an operational power for the semiconductor laser in accordance with a writing/reading position on the storage medium.

59. A storage medium storing a program for causing a computer, provided in a read/write device for writing and reading a storage medium by way of a heat assisted magnetic recording/reproduction scheme, the read/write device including an elevated slider provided with a semiconductor laser, to function as a control section which controls an operational power for the semiconductor laser in accordance with a writing/reading position on the storage medium.

60. A series of data signals including a program for causing a computer, provided in a read/write device for writing and reading a storage medium by way of a heat assisted magnetic recording/reproduction scheme, the read/write device including an elevated slider provided with a semiconductor laser, to function as a control section which controls an operational power for the semiconductor laser in accordance with a writing/reading position on the storage medium.

61. A semiconductor laser which is a combined structure of (i) a Fabry-Perot resonator structure which generates stimulated emission of radiation and (ii) a ring waveguide which generates a whispering gallery mode.

62. A semiconductor laser which is a combined structure of (i) a Fabry-Perot resonator structure which generates stimulated emission of radiation and (ii) a cylindrical waveguide which generates a whispering gallery mode.
